(19) United States
(12) Patent Application Publication
(10) Pub. No.: US 2019/0304102 A1
(43) Pub. Date: Oct. 3, 2019

(54) MEMORY EFFICIENT BLOB BASED OBJECT CLASSIFICATION IN VIDEO ANALYTICS

(71) Applicant: QUALCOMM Incorporated, San Diego, CA (US)

(72) Inventors: Ying CHEN, San Diego, CA (US); Songan MAO, San Diego, CA (US); Yang ZHOU, San Jose, CA (US); Karthik NAGARAJAN, Poway, CA (US)

(21) Appl. No.: 16/290,790

(22) Filed: Mar. 1, 2019

Related U.S. Application Data
(60) Provisional application No. 62/650,881, filed on Mar. 30, 2018.

(51) Int. Cl. G06T 7/246; G06T 7/73; G06K 9/62; G06T 7/11; G06N 20/00; G06N 3/08

(52) U.S. Cl. CPC G06T 7/248; G06T 7/74; G06K 9/6272; G06T 2207/10016; G06N 20/00; G06N 3/08; G06T 2207/20132; G06T 7/11

(57) ABSTRACT

Techniques and systems are provided for classifying objects in one or more video frames. An object tracker associated with an object in a current video frame can be selected for object classification. Object classification can be determined to be performed in a next video frame (instead of the current video frame) for the object associated with the selected tracker. An image patch to use for the object classification can be obtained from the next video frame. The image patch can be based on a first bounding region associated with the object tracker in the current video frame, can be based on a second bounding region associated with the tracker in the next video frame, or can be based on both the first and second bounding regions. The object classification can be performed for the object associated with the selected object tracker using the image patch from the next video frame.

### CROSS-REFERENCE TO RELATED APPLICATIONS

This application claims the benefit of U.S. Provisional Application No. 62/650,881, filed Mar. 30, 2018, which is hereby incorporated by reference, in its entirety and for all purposes.

### FIELD

The present disclosure generally relates to video analytics for detecting and tracking objects, and more specifically to performing memory efficient, blob based object classification in a video analytics system.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption. In some cases, the video data can also be processed by the devices and systems themselves.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. The system with the video analytics can be on a camera device and/or on a server. In some cases, video analytics can send alerts or alarms for certain events of interest. More advanced video analytics is needed to provide efficient and robust video sequence processing.

### BRIEF SUMMARY

In some examples, techniques are described for performing memory efficient object classification in a video analytics system based on detected blobs. The video analytics system combines blob detection and neural network-based classification to more accurately detect and track objects in one or more images. For example, a blob detection component of a video analytics system can use image data from one or more video frames to generate or identify blobs for the one or more video frames. A blob represents at least a portion of one or more objects in a video frame (also referred to as a “picture”). Blob detection can utilize background subtraction to determine a background portion of a scene and a foreground portion of scene. Blobs can then be detected based on the foreground portion of the scene. Blob bounding regions (e.g., bounding boxes or other bounding region) can be associated with the blobs, in which case a blob and a blob bounding region can be used interchangeably. A blob bounding region is a shape surrounding a blob, and can be used to represent the blob.

The video analytics system can apply object classification based on the results from blob detection and blob tracking. For example, a classification system can apply a trained neural network-based detector (e.g., using a trained classification network) to classify the objects represented by the blobs detected in the one or more video frames. To achieve lower complexity, yet relatively high accuracy, the object classification functions can be invoked seamlessly with the video analytics system based on the context from the video analytics processes (e.g., events generated by blob tracking, intermediate states of the blobs, sizes of the blobs, one or more durations of the blobs, and/or other suitable context). For example, instead of applying the classification system for each blob of each frame, or otherwise with a very high frequency, the object classification functions can be integrated into the video analytics functions and, based on the context from video analytics, the object classification functions can be invoked for less than all blobs detected in the one or more video frames. A classification task management system can determine which one or more blobs from each from will be processed using object classification by generating classification requests for blobs that are eligible for classification. The eligible blobs that have classification requests can be prioritized to determine which blob will be processed for a given video frame.

Regardless of which type of classification task management system is used, when one or more classification requests are determined to be done immediately in a current video frame (e.g., based on the context from the video analytics processes), instead of performing the classification task in the current frame for the one or more blobs associated with the one or more classification requests (in which case the entire picture of the current frame would need to be accessed), the classification task can be performed for the one or more blobs in a next video frame using an image patch from the next video frame instead of the entire video frame. The image patch can be determined using bounding region information associated with the one or more blobs.

According to at least one example, a method of classifying objects in one or more video frames is provided. The method includes selecting an object tracker for object classification. The object tracker is associated with an object in a current video frame. The method further includes determining to perform the object classification in a next video frame for the object associated with the selected object tracker. The method further includes obtaining an image patch from the next video frame to use for the object classification. The image patch is based on at least one or more of a first bounding region associated with the object tracker in the current video frame and a second bounding region associated with the object tracker in the next video frame. The method further includes performing the object classification for the object associated with the selected object tracker using the image patch from the next video frame.

In another example, an apparatus for classifying objects in one or more video frames is provided that includes a memory configured to store the one or more video frames and a processor. The processor is configured to and can select an object tracker for object classification. The object tracker is associated with an object in a current video frame. The processor is further configured to and can determine to perform the object classification in a next video frame for the object associated with the selected object tracker. The processor is further configured to and can obtain an image patch from the next video frame to use for the object classification. The image patch is based on at least one or more of a first bounding region associated with the object tracker in the current video frame and a second bounding region associated with the object tracker in the next video frame. The processor is further configured to and can perform the object classification for the object associated with the selected object tracker using the image patch from the next video frame.

In another example, a non-transitory computer-readable medium is provided that has stored thereon instructions that, when executed by one or more processors, cause the one or more processor to: select an object tracker for object classification, the object tracker being associated with an object in a current video frame; determine to perform the object classification in a next video frame for the object associated with the selected object tracker; obtain an image patch from the next video frame to use for the object classification, the image patch being based on at least one or more of a first bounding region associated with the object tracker in the current video frame and a second bounding region associated with the object tracker in the next video frame; and perform the object classification for the object associated with the selected object tracker using the image patch from the next video frame.

In another example, an apparatus for classifying objects in one or more video frames is provided. The apparatus includes means for selecting an object tracker for object classification. The object tracker is associated with an object in a current video frame. The apparatus further includes means for determining to perform the object classification in a next video frame for the object associated with the selected object tracker. The apparatus further includes means for obtaining an image patch from the next video frame to use for the object classification. The image patch is based on at least one or more of a first bounding region associated with the object tracker in the current video frame and a second bounding region associated with the object tracker in the next video frame. The apparatus further includes means for performing the object classification for the object associated with the selected object tracker using the image patch from the next video frame.

In some aspects, obtaining the image patch from the next video frame includes cropping the image patch from the next video frame. In some cases, the next video frame is removed from a memory in response to obtaining the image patch from the next video frame. For example, the next video frame can be removed from the memory in response to cropping of the image patch from the next video frame.

In some aspects, the method, apparatuses, and computer-readable medium described above can further comprise determining a reference image patch from the next video frame to use for generating the image patch. In such aspects, determining the reference image patch can include determining a location within the next video frame, the determined location corresponding to a location of the first bounding region in the current video frame. Determining the reference image patch can include can further include generating the reference image patch from the next video frame by obtaining image data within a region of the next video frame, A point (e.g., a center point, a top-left corner point, a top-right corner point, and/or other point) of the reference image patch can be aligned with a point (e.g., a center point, a top-left corner point, a top-right corner point, and/or other point) associated with the determined location within the next video frame.

In some cases, the region of the next video frame includes a pre-determined size. The pre-determined size can include a size used by the object classification. In some cases, the pre-determined size can include a size used by the object classification scaled by a pre-determined amount.

In some aspects, the method, apparatuses, and computer-readable medium described above can further comprise determining a reference image patch from the next video frame to use for generating the image patch. In such aspects, determining the reference image patch can include determining a location within the next video frame, the determined location corresponding to a location of the first bounding region in the current video frame. Determining the reference image patch can further include generating an initial image patch from the next video frame by obtaining image data within a region of the next video frame. A point (e.g., a center point, a top-left corner point, a top-right corner point, and/or other point) of the region of the next video frame can be aligned with a point (e.g., a center point, a top-left corner point, a top-right corner point, and/or other point) associated with the determined location within the next video frame. A size of the initial image patch can be based on a size of the first bounding region. Determining the reference image patch can further include generating the reference image patch by scaling a size of the initial image patch by a pre-determined amount.

In some aspects, the method, apparatuses, and computer-readable medium described above can further comprise: determining a location within the reference image patch of the second bounding region associated with the object tracker in the next video frame; and generating the image patch from the next video frame to use for the object classification by obtaining image data within a region of the reference image patch, a point (e.g., a center point, a top-left corner point, a top-right corner point, and/or other point) of the image patch being aligned with a point (e.g., a center point, a top-left corner point, a top-right corner point, and/or other point) of the second bounding region located within the reference image patch. In some cases, the region of the reference image patch includes a pre-determined size. The pre-determined size can include a size used by the object classification.

In some aspects, the method, apparatuses, and computer-readable medium described above can further comprise determining whether to perform the object classification for one or more object trackers in the next video frame based on a comparison between one or more bounding regions associated with the one or more object trackers in the current video frame and one or more bounding regions associated with the one or more object trackers in the next video frame.

In some aspects, the method, apparatuses, and computer-readable medium described above can further comprise: determining an amount of overlap between at least one bounding region associated with at least one object tracker in the current video frame and at least one bounding region associated with the at least one object tracker in the next video frame is greater than an overlap threshold; and determining to perform the object classification in the next video frame for at least one object associated with the at least one object tracker based on the amount of overlap being greater than the overlap threshold.

In some aspects, the method, apparatuses, and computer-readable medium described above can further comprise: determining an amount of overlap between at least one bounding region associated with at least one object tracker in the current video frame and at least one bounding region associated with the at least one object tracker in the next video frame is less than an overlap threshold; and determining not to perform the object classification in the next video frame for at least one object associated with the at least one object tracker based on the amount of overlap being less than the overlap threshold.

In some aspects, the method, apparatuses, and computer-readable medium described above can further comprise: determining a size of at least one bounding region associated with at least one object tracker in the current video frame is greater than a threshold percentage of a size of at least one bounding region associated with the at least one object tracker in the next video frame; and determining to perform the object classification in the next video frame for at least one object associated with the at least one object tracker based on the size of the at least one bounding region associated with at least one object tracker in the current video frame being greater than the threshold percentage of the size of the at least one bounding region associated with the at least one object tracker in the next video frame.

In some aspects, the method, apparatuses, and computer-readable medium described above can further comprise: determining a size of at least one bounding region associated with at least one object tracker in the current video frame is less than a threshold percentage of a size of at least one bounding region associated with the at least one object tracker in the next video frame; and determining not to perform the object classification in the next video frame for at least one object associated with the at least one object tracker based on the size of the at least one bounding region associated with at least one object tracker in the current video frame being less than the threshold percentage of the size of the at least one bounding region associated with the at least one object tracker in the next video frame.

In some aspects, object detection and object tracking are performed on a low resolution version of the current video frame to generate the object tracker, and the object classification is performed on a high resolution version of the next video frame. In some examples, the method, apparatuses, and computer-readable medium described above can further comprise detecting, using the low resolution version of the current video frame, a plurality of blobs for the current video frame, wherein a blob includes pixels of at least a portion of one or more objects in the current video frame; obtaining a plurality of object trackers maintained for the current video frame; and associating, using the low resolution version of the current video frame, the plurality of blobs with the plurality of object trackers maintained for the current video frame. In such examples, performing the object classification for the object associated with the selected object tracker can include performing the object classification for a blob associated with the object tracker using the high resolution version of the next video frame.

In some aspects, the method, apparatuses, and computer-readable medium described above can further comprise: obtaining a plurality of object trackers maintained for the current video frame; and obtaining a plurality of classification requests associated with a subset of object trackers from the plurality of object trackers, the plurality of classification requests being generated based on one or more characteristics associated with the subset of object trackers. In such aspects, the object tracker can be selected for object classification from the subset of object trackers based on the obtained plurality of classification requests.

In some aspects, the one or more characteristics associated with an object tracker from the subset of object trackers include a state change of the object tracker from a first state to a second state. In such aspects, a classification request can be generated for the object tracker when a state of the object tracker is changed from the first state to the second state in the current video frame.

In some aspects, the one or more characteristics associated with an object tracker from the subset of object trackers include an idle duration of the object tracker. The idle duration indicates a number of frames between the current video frame and a last video frame at which a classification request was generated for the object tracker. In such aspects, a classification request can be generated for the object tracker when the idle duration is greater than an idle duration threshold.

In some aspects, the one or more characteristics associated with an object tracker from the subset of object trackers include a size comparison of the object tracker. In such aspects, generating a classification request for the object tracker can include determining the size comparison of the object tracker by comparing a size of the object tracker in the current video frame to a size of the object tracker in a last video frame at which object classification was performed for the object tracker. In such aspects, a classification request can be generated for the object tracker when the size comparison is greater than a size comparison threshold.

In some aspects, the object classification can be performed using a trained classification network.

In some aspects, the apparatus further includes a camera for capturing the one or more video frames. In some aspects, the apparatus includes a mobile device with a camera for capturing the one or more video frames. In some aspects, the apparatus includes a display for displaying video data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example of a system including a video source and a video analytics system, in accordance with some examples.

FIG. 2 is an example of a video analytics system processing video frames, in accordance with some examples.

FIG. 3 is a block diagram illustrating an example of a blob detection system, in accordance with some examples.

FIG. 4 is a block diagram illustrating an example of an object tracking system, in accordance with some examples.

FIG. 5 is a state diagram showing various state transitions of an object tracker, in accordance with some examples.

FIG. 6 is a diagram illustrating an example of blob based classification, in accordance with some examples.

FIG. 7 is an example of a video analytics system, in accordance with some examples.

FIG. 8 is a diagram illustrating details of a classification system of a video analytics system, in accordance with some examples.

FIG. 9 is a flowchart illustrating an example of a process for performing a classification invocation check, in accordance with some examples.

FIG. 10 is a flowchart illustrating an example of a process for performing classification task management, in accordance with some examples.

FIG. 11 is a flowchart illustrating an example of functions performed during an object classification process, in accordance with some examples.

FIG. 12 is a diagram illustrating an example of pre-processing performed on an input bounding box, in accordance with some examples.

FIG. 13A-FIG. 13E are diagrams illustrating an example of determining an image patch of a next frame for classification, in accordance with some examples.

FIG. 14 is a diagram illustrating an example of an intersection and union of two bounding boxes, in accordance with some examples.

FIG. 15 is a flowchart illustrating an example of an update request process, in accordance with some examples.

FIG. 16 is a diagram illustrating an example of multiple confidence intervals that can be used by an object class update engine, in accordance with some examples.

FIG. 17 is a flowchart illustrating an example of an object class update process, in accordance with some examples.

FIG. 18 is a diagram illustrating an example of a process of adaptively setting confidence thresholds for different confidence intervals, in accordance with some examples.

FIG. 19 is a block diagram illustrating an example of a deep learning network, in accordance with some examples.

FIG. 20 is a block diagram illustrating an example of a convolutional neural network, in accordance with some examples.

FIG. 21 is a diagram illustrating an example of the Cifar-10 neural network, in accordance with some examples.

FIG. 22A-FIG. 22C are diagrams illustrating an example of a single-shot object detector, in accordance with some examples.

FIG. 23A-FIG. 23C are diagrams illustrating an example of a you only look once (YOLO) detector, in accordance with some examples.

FIG. 24-FIG. 38B are video frames of environments with objects that are detected and classified, in accordance with some examples.

FIG. 39 is a flowchart illustrating an example of a process for classifying objects in one or more video frames, in accordance with some embodiments.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a sequence of video frames from a video source and can process the video sequence to perform a variety of tasks. One example of a video source can include an Internet protocol camera (IP camera) or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and can send an alert or alarm to a central control room to alert a user of the event of interest.

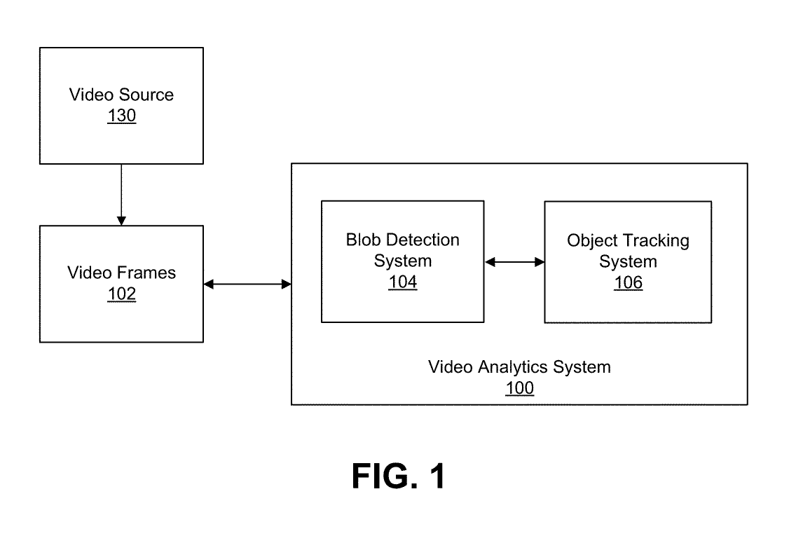

As described in more detail herein, a video analytics system can generate and detect foreground blobs that can be used to perform various operations, such as object tracking (also called blob tracking) and/or the other operations described above. A blob tracker (also referred to as an object tracker) can be used to track one or more blobs in a video sequence using one or more bounding boxes. Details of an example video analytics system with blob detection and object tracking are described below with respect to FIG. 1-FIG. 4.

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection system 104 and an object tracking system 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection system 104 can detect one or more blobs in video frames (e.g., video frames 102) of a video sequence, and the object tracking system 106 can track the one or more blobs across the frames of the video sequence. As used herein, a blob refers to foreground pixels of at least a portion of an object (e.g., a portion of an object or an entire object) in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob. In some examples, a tracker can also be represented by a tracker bounding region. A bounding region of a blob or tracker can include a bounding box, a bounding circle, a bounding ellipse, or any other suitably-shaped region representing a tracker and/or a blob. While examples are described herein using bounding boxes for illustrative purposes, the techniques and systems described herein can also apply using other suitably shaped bounding regions. A bounding box associated with a tracker and/or a blob can have a rectangular shape, a square shape, or other suitable shape. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated. Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

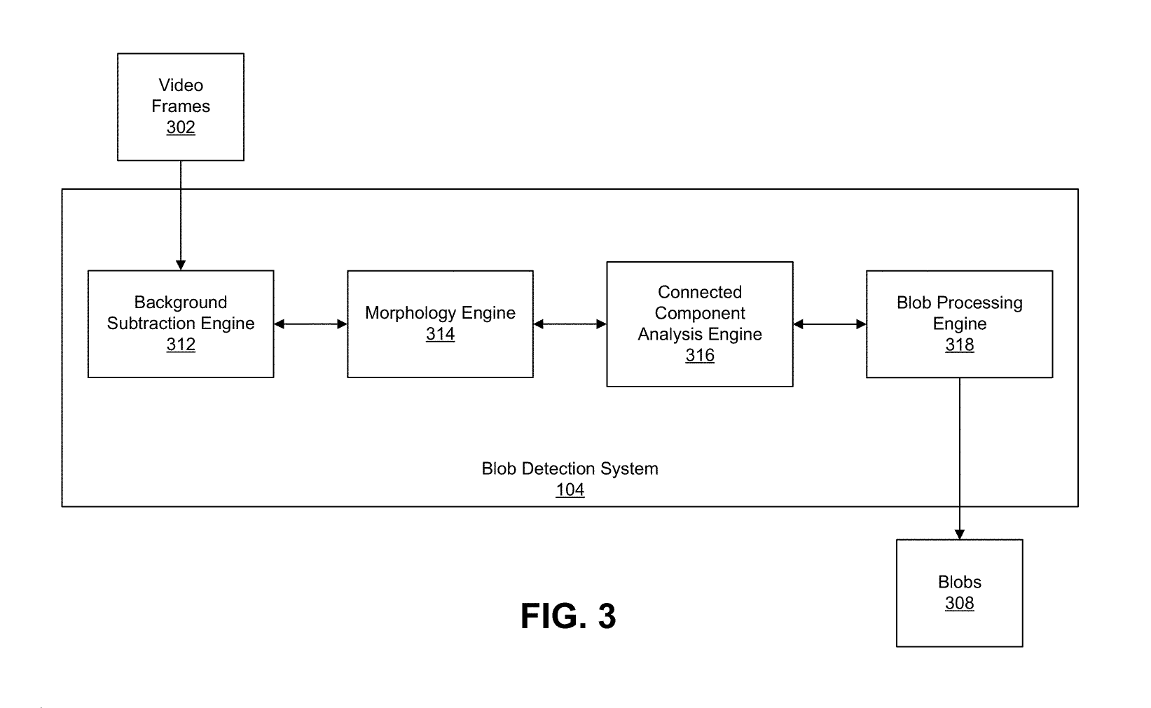

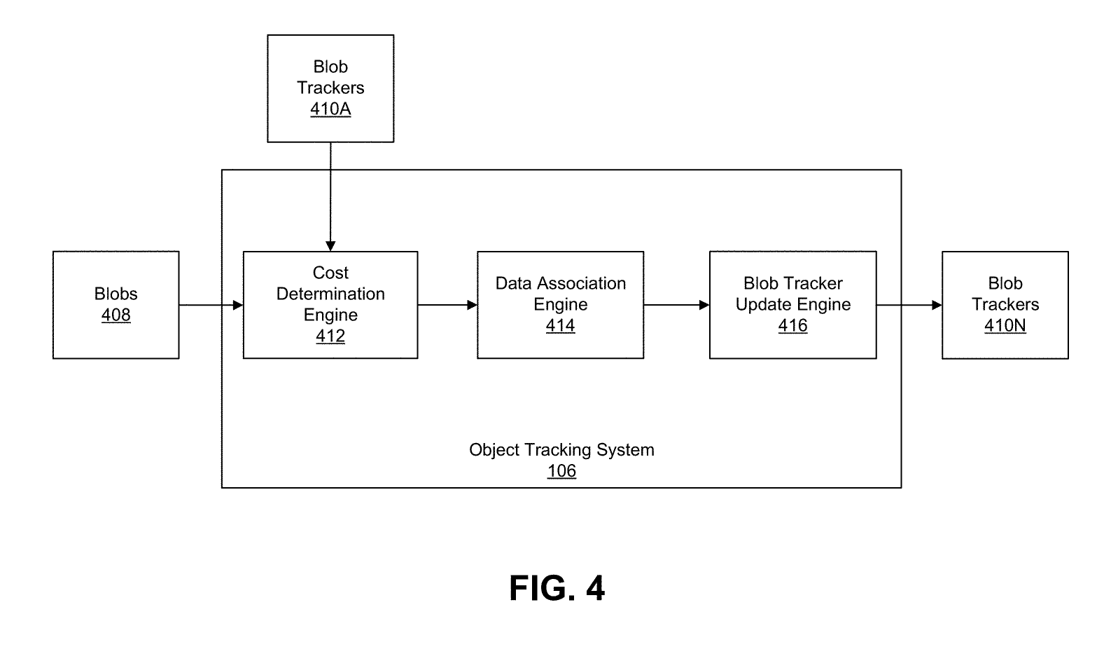

Using the blob detection system 104 and the object tracking system 106, the video analytics system 100 can perform blob generation and detection for each frame or picture of a video sequence. For example, the blob detection system 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection system 104 and the object tracking system 106 are described with respect to FIGS. 3-4.

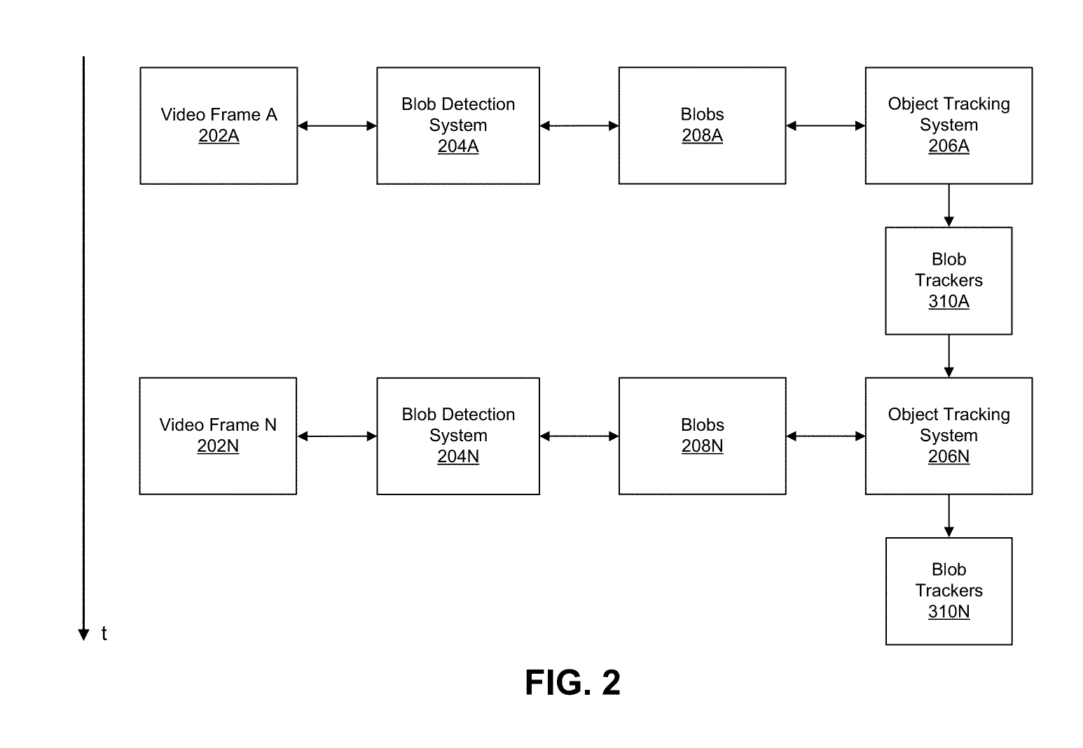

FIG. 2 is an example of the video analytics system (e.g., video analytics system 100) processing video frames across time t. As shown in FIG. 2, a video frame A 202A is received by a blob detection system 204A. The blob detection system 204A generates foreground blobs 208A for the current frame A 202A. After blob detection is performed, the foreground blobs 208A can be used for temporal tracking by the object tracking system 206A. Costs (e.g., a cost including a distance, a weighted distance, or other cost) between blob trackers and blobs can be calculated by the object tracking system 206A. The object tracking system 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection system 204N generates foreground blobs 208N for the frame N 202N. The object tracking system 206N can then perform temporal tracking of the blobs 208N. For example, the object tracking system 206N obtains the blob trackers 310A that were updated based on the prior video frame A 202A. The object tracking system 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection system 104. Blob detection is used to segment moving objects from the global background in a scene. The blob detection system 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (also referred to as a Gaussian mixture model (GMM)). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

$$P ( {X}_{t} ) = {\sum }_{i = 1}^{K} {ω}_{i , t} N ( {X}_{t} \vert {μ}_{i , t} , {Σ}_{i , t} ) \qquad Equation ( 1 )$$

An equation of the GMM model is shown in equation (1), wherein there are K Gaussian models. Each Guassian model has a distribution with a mean of μ and variance of Σ, and has a weight a). Here, i is the index to the Gaussian model and t is the time instance. As shown by the equation, the parameters of the GMM change over time after one frame (at time t) is processed. In GMM or any other learning based background subtraction, the current pixel impacts the whole model of the pixel location based on a learning rate, which could be constant or typically at least the same for each pixel location. A background subtraction method based on GMM (or other learning based background subtraction) adapts to local changes for each pixel. Thus, once a moving object stops, for each pixel location of the object, the same pixel value keeps on contributing to its associated background model heavily, and the region associated with the object becomes background.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with 3×3 window size is called first, and three function calls of dilation of 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. In some implementation of connected component analysis, a set of bounding boxes are returned in a way that each bounding box contains one component of connected pixels. One example of the connected component analysis performed by the connected component analysis engine 316 is implemented as follows:

for each pixel of the foreground mask {
if it is a foreground pixel and has not been processed, the following steps apply:
   Apply FloodFill function to connect this pixel to other foreground and generate a connected component
   Insert the connected component in a list of connected components.
   Mark the pixels in the connected component as being processed}

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection system 104. In some examples, there may be a filtering process for the connected components (bounding boxes). For instance, the blob processing engine 318 can perform content-based filtering of certain blobs. In some cases, a machine learning method can determine that a current blob contains noise (e.g., foliage in a scene). Using the machine learning information, the blob processing engine 318 can determine the current blob is a noisy blob and can remove it from the resulting blobs that are provided to the object tracking system 106. In some cases, the blob processing engine 318 can filter out one or more small blobs that are below a certain size threshold (e.g., an area of a bounding box surrounding a blob is below an area threshold). In some examples, there may be a merging process to merge some connected components (represented as bounding boxes) into bigger bounding boxes. For instance, the blob processing engine 318 can merge close blobs into one big blob to remove the risk of having too many small blobs that could belong to one object. In some cases, two or more bounding boxes may be merged together based on certain rules even when the foreground pixels of the two bounding boxes are totally disconnected. In some embodiments, the blob detection system 104 does not include the blob processing engine 318, or does not use the blob processing engine 318 in some instances. For example, the blobs generated by the connected component analysis engine 316, without further processing, can be input to the object tracking system 106 to perform blob and/or object tracking.

In some implementations, density based blob area trimming may be performed by the blob processing engine 318. For example, when all blobs have been formulated after post-filtering and before the blobs are input into the tracking layer, the density based blob area trimming can be applied. A similar process is applied vertically and horizontally. For example, the density based blob area trimming can first be performed vertically and then horizontally, or vice versa. The purpose of density based blob area trimming is to filter out the columns (in the vertical process) and/or the rows (in the horizontal process) of a bounding box if the columns or rows only contain a small number of foreground pixels.

The vertical process includes calculating the number of foreground pixels of each column of a bounding box, and denoting the number of foreground pixels as the column density. Then, from the left-most column, columns are processed one by one. The column density of each current column (the column currently being processed) is compared with the maximum column density (the column density of all columns). If the column density of the current column is smaller than a threshold (e.g., a percentage of the maximum column density, such as 10%, 20%, 30%, 50%, or other suitable percentage), the column is removed from the bounding box and the next column is processed. However, once a current column has a column density that is not smaller than the threshold, such a process terminates and the remaining columns are not processed anymore. A similar process can then be applied from the right-most column. One of ordinary skill will appreciate that the vertical process can process the columns beginning with a different column than the left-most column, such as the right-most column or other suitable column in the bounding box.

The horizontal density based blob area trimming process is similar to the vertical process, except the rows of a bounding box are processed instead of columns. For example, the number of foreground pixels of each row of a bounding box is calculated, and is denoted as row density. From the top-most row, the rows are then processed one by one. For each current row (the row currently being processed), the row density is compared with the maximum row density (the row density of all the rows). If the row density of the current row is smaller than a threshold (e.g., a percentage of the maximum row density, such as 10%, 20%, 30%, 50%, or other suitable percentage), the row is removed from the bounding box and the next row is processed. However, once a current row has a row density that is not smaller than the threshold, such a process terminates and the remaining rows are not processed anymore. A similar process can then be applied from the bottom-most row. One of ordinary skill will appreciate that the horizontal process can process the rows beginning with a different row than the top-most row, such as the bottom-most row or other suitable row in the bounding box.

One purpose of the density based blob area trimming is for shadow removal. For example, the density based blob area trimming can be applied when one person is detected together with his or her long and thin shadow in one blob (bounding box). Such a shadow area can be removed after applying density based blob area trimming, since the column density in the shadow area is relatively small. Unlike morphology, which changes the thickness of a blob (besides filtering some isolated foreground pixels from formulating blobs) but roughly preserves the shape of a bounding box, such a density based blob area trimming method can dramatically change the shape of a bounding box.

Once the blobs are detected and processed, object tracking (also referred to as blob tracking) can be performed to track the detected blobs. FIG. 4 is a block diagram illustrating an example of an object tracking system 106. The input to the blob/object tracking is a list of the blobs 408 (e.g., the bounding boxes of the blobs) generated by the blob detection system 104. In some cases, a tracker is assigned with a unique ID, and a history of bounding boxes is kept. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking system 106 can obtain the blobs 408 of a current video frame from the blob detection system 104. The cost determination engine 412 can also obtain the blob trackers 410A updated from the previous video frame (e.g., video frame A 202A). A cost function can then be used to calculate costs between the blob trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker (or tracker bounding box) with a corresponding blob (or blob bounding box) and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible. Regardless of the association technique that is used, the data association engine 414 can rely on the distance between the blobs and trackers.

Once the association between the blob trackers 410A and blobs 408 has been completed, the blob tracker update engine 416 can use the information of the associated blobs, as well as the trackers' temporal statuses, to update the status (or states) of the trackers 410A for the current frame. Upon updating the trackers 410A, the blob tracker update engine 416 can perform object tracking using the updated trackers 410N, and can also provide the updated trackers 410N for use in processing a next frame.

The status or state of a blob tracker can include the tracker's identified location (or actual location) in a current frame and its predicted location in the next frame. The location of the foreground blobs are identified by the blob detection system 104. However, as described in more detail below, the location of a blob tracker in a current frame may need to be predicted based on information from a previous frame (e.g., using a location of a blob associated with the blob tracker in the previous frame). After the data association is performed for the current frame, the tracker location in the current frame can be identified as the location of its associated blob(s) in the current frame. The tracker's location can be further used to update the tracker's motion model and predict its location in the next frame. Further, in some cases, there may be trackers that are temporarily lost (e.g., when a blob the tracker was tracking is no longer detected), in which case the locations of such trackers also need to be predicted (e.g., by a Kalman filter). Such trackers are temporarily not shown to the system. Prediction of the bounding box location helps not only to maintain certain level of tracking for lost and/or merged bounding boxes, but also to give more accurate estimation of the initial position of the trackers so that the association of the bounding boxes and trackers can be made more precise.

As noted above, the location of a blob tracker in a current frame may be predicted based on information from a previous frame. One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) (e.g., the blob(s) bounding box(es)) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, the state or status of a tracker can also, or alternatively, include a tracker's temporal state or status. The temporal state of a tracker can include whether the tracker is a new tracker that was not present before the current frame, a normal state for a tracker that has been alive for a certain duration and that is to be output as an identified tracker-blob pair to the video analytics system, a lost state for a tracker that is not associated or matched with any foreground blob in the current frame, a dead state for a tracker that fails to associate with any blobs for a certain number of consecutive frames (e.g., two or more frames, a threshold duration, or the like), and/or other suitable temporal status. Another temporal state that can be maintained for a blob tracker is a duration of the tracker. The duration of a blob tracker includes the number of frames (or other temporal measurement, such as time) the tracker has been associated with one or more blobs.

There may be other state or status information needed for updating the tracker, which may require a state machine for object tracking. Given the information of the associated blob(s) and the tracker's own status history table, the status also needs to be updated. The state machine collects all the necessary information and updates the status accordingly. Various statuses of trackers can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration (a threshold duration) has passed, the tracker may be promoted to be a normal tracker. A normal tracker is output as an identified tracker-blob pair. For example, a tracker-blob pair is output at the system level as an event (e.g., presented as a tracked object on a display, output as an alert, and/or other suitable event) when the tracker is promoted to be a normal tracker. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by a rule interpreter). A tracker that is not promoted as a normal tracker can be removed (or killed), after which the tracker can be considered as dead.

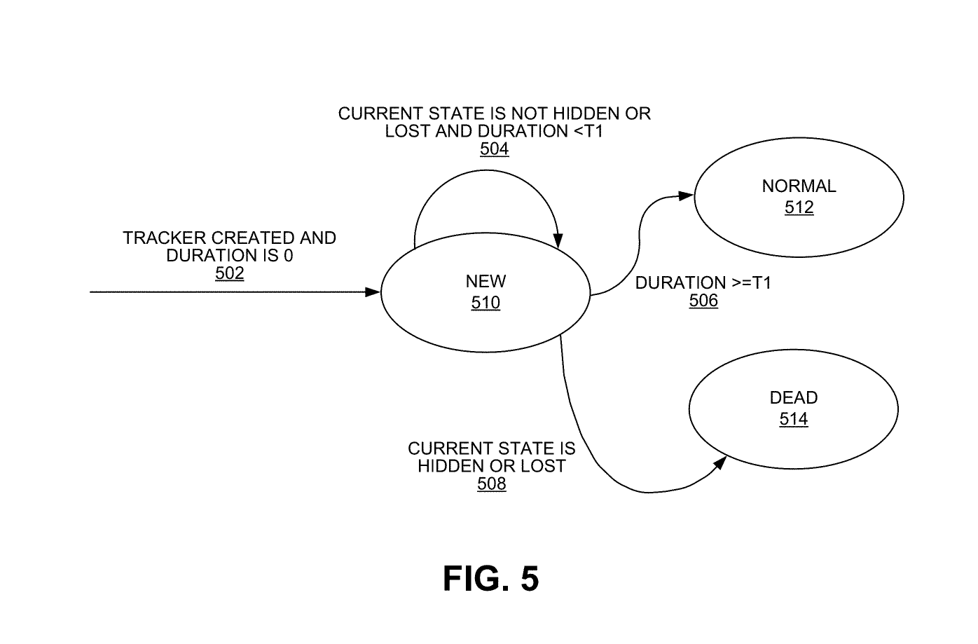

FIG. 5 is a state diagram illustrating an example of a new tracker transition process. A tracker is given a new state 510 when the tracker is created and its duration of being associated with any blobs is set to 0 (shown at step 502). The duration of the blob tracker can be monitored as well as its temporal state (e.g., new, lost, hidden, or the like). As shown at step 504, as long as the current state is not hidden or lost, and as long as the duration is less than a threshold duration T1, the state of the new tracker is kept as a new state 510. A hidden tracker may refer to a tracker that was previously normal (thus independent), but later merged into another tracker C (based on two objects merging). In order to enable the hidden tracker to be identified later due to the anticipation that the merged object associated with the tracker may be split later from the object associated with the other tracker C, the hidden tracker is kept as being associated with the other tracker C which is containing it.

The threshold duration T1 is a duration that a new blob tracker must be continuously associated with one or more blobs before it is converted to a normal tracker (transitioned to a normal state 512). The threshold duration can be a number of frames (e.g., at least N frames) or an amount of time. In one illustrative example, a blob tracker can be in a new state for 30 frames (with T1=30), or any other suitable number of frames or amount of time, before being converted to a normal tracker. If the blob tracker has been continuously associated with a blob for the threshold duration (duration T1), as shown at step 506, and does not become hidden or lost, the blob tracker is converted to a normal tracker by being transitioned from a new status to a normal status, as shown at step 512.

If, during the threshold duration T1, the new tracker becomes hidden or lost (e.g., not associated or matched with any foreground blob), as shown at step 508, the state of the tracker can be transitioned from the new state 510 to the dead state 514, and the blob tracker can be removed from blob trackers maintained for a video sequence.

In some examples, objects may intersect or group together, in which case the blob detection system 104 can detect one blob (a merged blob) that contains more than one object of interest (e.g., multiple objects that are being tracked). For example, as a person walks near another person in a scene, the bounding boxes for the two persons can become a merged bounding box (corresponding to a merged blob). The merged bounding box can be tracked with a single blob tracker (referred to as a container tracker), which can include one of the blob trackers that was associated with one of the blobs making up the merged blob, with the other blob(s)′ trackers being referred to as merge-contained trackers. For example, a merge-contained tracker is a tracker (new or normal) that was merged with another tracker when two blobs for the respective trackers are merged, and thus became hidden and carried by the container tracker.

A tracker that is split from an existing tracker is referred to as a split-new tracker. A split-new state is slightly different from a new tracker, and is treated similarly as a new tracker, but with different parameters. The tracker from which the split-new tracker is split is referred to as a parent tracker or a split-from tracker. In some examples, a split-new tracker can result from the association (or matching or mapping) of multiple blobs to one active tracker. For instance, one active tracker can only be mapped to one blob. All the other blobs (the blobs remaining from the multiple blobs that are not mapped to the tracker) cannot be mapped to any existing trackers. In such examples, new trackers will be created for the other blobs, and these new trackers are assigned the “split-new” state. Such a split-new tracker can be referred to as the child tracker of the original tracker its associated blob is mapped to. The corresponding original tracker can be referred to as the parent tracker (or the split-from tracker) of the child tracker. In some examples, a split-new tracker can also result from a merge-contained tracker. As noted above, a merge-contained tracker is a tracker that was merged with another tracker (when two blobs for the respective trackers are merged) and thus became hidden and carried by the container tracker. A merge-contained tracker can be split from the container tracker if the container tracker is active and the container tracker has a mapped blob in the current frame.

As previously described, the threshold duration T1 is a duration that a new blob tracker must be continuously associated with one or more blobs before it is converted to a normal tracker. A threshold duration T2 is defined for a split-new tracker, and is the duration that a split-new tracker must be continuously associated with one or more blobs before it is converted to a normal tracker. In some examples, the threshold duration T2 used for split-new trackers can be the same as the threshold duration T1 used for new trackers (e.g., 20 frames, 30 frames, 32 frames, 60 frames, 1 second, 2 seconds, or other suitable duration or number of frames). In some examples, the threshold duration T2 for split-new trackers can be a shorter duration than the threshold duration T1 used for new trackers. For example, T2 can be set to a smaller value than T1. In some examples, the duration T2 can be proportional to T1. In one illustrative example, T1 may indicate one second of duration, in which case the duration is equal to the (average) frame rate of the input video (e.g., 30 frames at 30 frames per second (fps), 60 frames at 60 fps, or other suitable duration and frame rate). In such an example, the duration T2 can be set to half of T1.

In some implementations, classification systems can be used to classify objects in one or more video frames of a video sequence. Different types of object classification applications can be used. In a first example classification application, a relatively low resolution input image is used to provide a classification for the whole input image, with a class and a confidence level. In such applications, the classification is performed for the whole image. In a second example classification system, a relatively high resolution input image is used, and multiple objects within the image are output, with each object having its own bounding box (or ROI) and a classified object type. The first example classification application is referred to herein as “image based classification” and the second example classification application is referred to herein as “blob based classification.” The classification accuracy of both applications can be high when neural network (e.g., deep learning) based solutions are utilized.

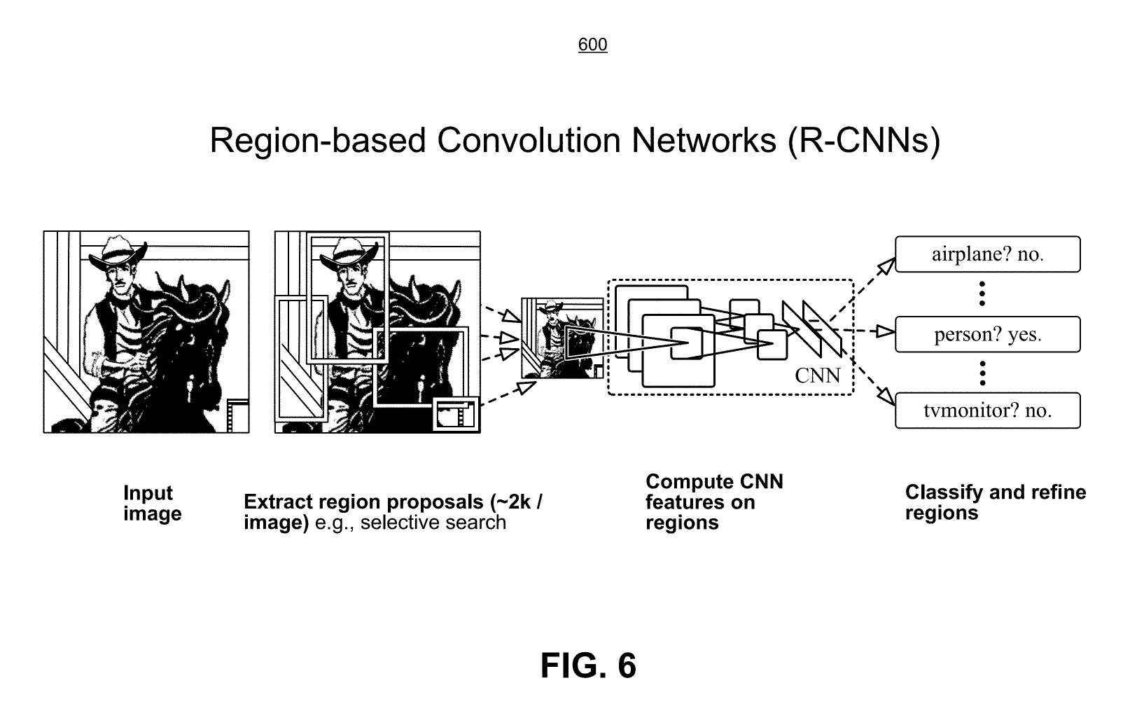

FIG. 6 is a diagram 600 illustrating an example of a blob based classification. As shown, blob based classification (which can also be referred to as region-based classification) first extracts region proposals (e.g., blobs) from the image. The extracted region proposals, which can include blobs, are fed to a deep learning network for classification. A deep learning classification network generally starts with an input layer (image or blob) followed by a sequence of convolutional layers and pooling layers (among other layers), and ends with fully connected layers. The convolutional layers can be followed by one layer of rectified linear unit (ReLU) activation functions. The convolutional, pooling, and ReLU layers act as learnable feature extractors, while fully connected layers act as a classifier.

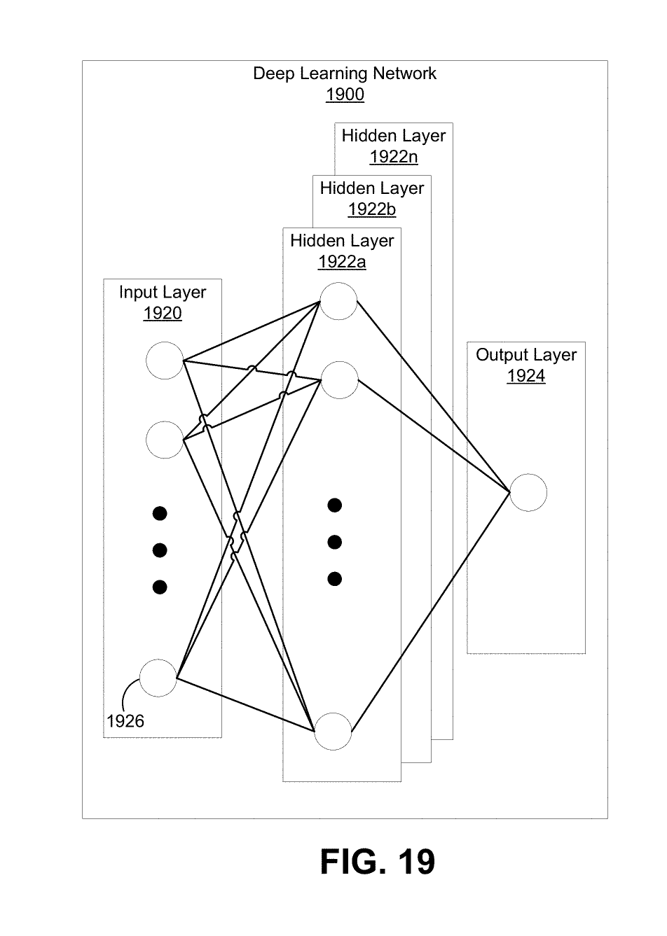

In some cases, when a blob is fed to a deep learning classification network, one or more shallow layers in the network might learn simple geometrical objects, such as lines and/or other objects, that signify the object to be classified. The deeper layers will learn much more abstract, detailed features about the objects, such as sets of lines that define shapes or other detailed features, and then eventually sets of the shapes from the earlier layers that make up the shape of the object that is being classified (e.g., a person, a car, an animal, or any other object). Further details of the structure and function of neural networks are described below with respect to FIG. 19-FIG. 23C.

As blob based classification requires much less computational complexity as well as less memory bandwidth (e.g., memory required to maintain the network structure), it may be directly used.

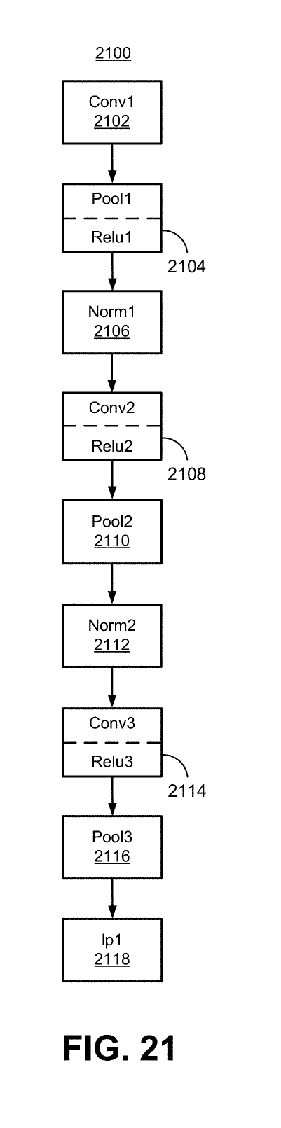

Various deep learning-based detectors can be used to classify or detect objects in video frames. For example, a Cifar-10 network based detector can be used to perform blob based classification to classify blobs. In some cases, the Cifar-10 detector can be trained to classify persons and cars only. The Cifar-10 network based detector can take a blob as input, and can classify the blob as one of a number of predefined classes with a confidence score. Further details of the Cifar-10 detector are described below with respect to FIG. 21.

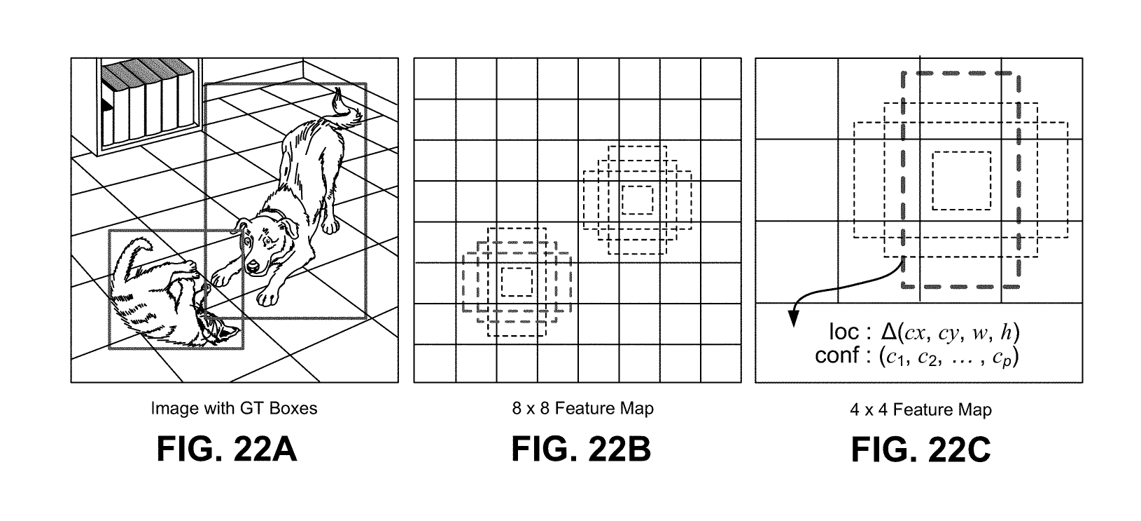

Another deep learning based detector is single-shot detector (SSD), which is a fast single-shot object detector that can be applied for multiple object categories. A feature of the SSD model is the use of multi-scale convolutional bounding box outputs attached to multiple feature maps at the top of the neural network. Such a representation allows the SSD to efficiently model diverse box shapes. It has been demonstrated that, given the same VGG-16 base architecture, SSD compares favorably to its state-of-the-art object detector counterparts in terms of both accuracy and speed. An SSD deep learning detector is described in more detail in K. Simonyan and A. Zisserman, “Very deep convolutional networks for large-scale image recognition,” CoRR, abs/1409.1556, 2014, which is hereby incorporated by reference in its entirety for all purposes. Further details of the SSD detector are described below with respect to FIG. 22A-FIG. 22C.

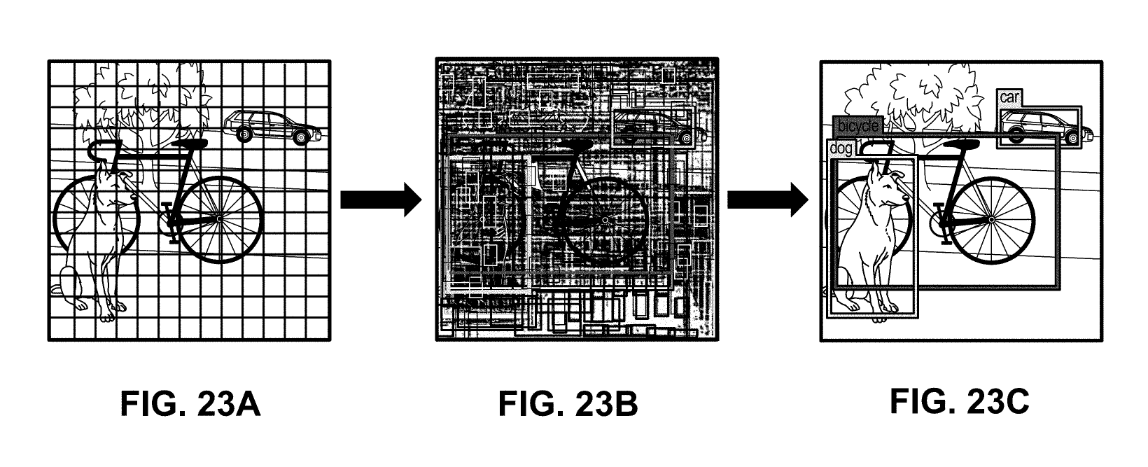

Another example of a deep learning-based detector that can be used to detect or classify objects in video frames includes the You Only Look Once (YOLO) detector. The YOLO detector, when run on a Titan X, processes images at 40-90 fps with a mAP of 78.6% (based on VOC 2007). The SSD300 model runs at 59 FPS on the Nvidia Titan X, and can typically execute faster than the current YOLO 1. YOLO 1 has also been recently replaced by its successor YOLO 2. A YOLO deep learning detector is described in more detail in J. Redmon, S. Divvala, R. Girshick, and A. Farhadi, “You only look once: Unified, real-time object detection,” arXiv preprint arXiv:1506.02640, 2015, which is hereby incorporated by reference in its entirety for all purposes. Further details of the YOLO detector are described below with respect to FIG. 23A-FIG. 23C. While the SSD and YOLO detectors are described to provide illustrative examples of deep learning-based object detectors, one of ordinary skill will appreciate that any other suitable neural network can be used by the classification system 716.

Applying blob classification for each blob in each frame may provide, on average, high accuracy results for objects in a scene. However, blob classification can introduce problems when used in a video analytics system. For example, deep learning networks can have issues when being used to classify and/or localize objects in a video sequence. One problem is that deep learning based detectors are quite slow and the classification results cannot be generated real-time on camera devices (e.g., at 30 fps), such as an IP camera device or other suitable device used to capture video sequences of a scene. Deep learning-based detectors can only achieve real-time performance on certain graphic cards (e.g., an Nvidia graphics card). Experiments even suggest that it could take many seconds to finish object detection for one frame.

There are further optimizations in terms of deep learning algorithms, including using GoogLeNet v2 to replace VGG in SSD. In low-tier chipsets, such as the SD625, the CPUs are much slower and the absence of a high-performance vector-DSP, such as the HVX (Hexagon Vector eXtensions), prevents efficient parallel processing. In addition, the GPU in a SD625 chipset has performance capabilities that are far inferior to the Nvidia Titan X. So, the fastest deep learning-based detector (even by using the GPU) is still expected to consume 0.5-1 second for one frame. The above execution latency is many-fold (15-30×) inferior to that offered by a conventional video analytics solution for processing one frame, wherein 30 ms of latency is sufficient for the latter case.

In some cases, blob classification can introduce potential temporal inconsistency in determining the classified type of a given object. For example, blob classification can take different amounts of time to classify different types of objects. Blob classification can also introduce large complexity to a video analytics system, as described above. For example, the complexity in applying the classification becomes very large for a scene with a large number of objects (e.g., dozens of objects).

Applying tracking methods for objects may resolve, to a large extent, the problem of high complexity. For example, tracking can be performed to track detected objects in one or more video frames, instead of detecting the objects in every video frame. However, there are cases when objects become merged, split apart, and/or get lost. In such cases, very unreliable results may be shown if the situations are not well resolved by the system. For example, when two objects include a car and a person that are separated in one instance, and are merged together in another instance, it is likely that a classifier cannot determine that an input blob containing both of the objects is a person, is a car, or is both a person and a car. Moreover, the different events (e.g., split, merge, new objects, or the like) may present different challenges for object classification, in which case it may not be possible to use the same set of thresholds to control whether a classification result with a certain confidence will be accepted.

While the purpose of blob classification is to assign a class type for a blob, there are cases in which false classification results are given. When such false classification results are given, the tracking system may not be able to determine if an event has been changed, in which case the tracking system has no chance to update the class type of the object (with a wrong type). Further, when a blob associated with a tracker has a small size, the classification results are not reliable. In such cases, false classification labels can be assigned to the trackers.

Systems and methods are described herein for improving video analytics by introducing the classification functionality into a video analytics system based on conventional motion object (blob) detection and tracking. For example, the blob detection and object tracking of the video analytics system 100 has the capability of outputting bounding boxes (or other suitable bounding regions) as detection and tracking results for each video frame. Based on a bounding box from the video analytics system 100, a blob classification system (e.g., based on a trained neural network) can be applied to determine whether the object within the bounding box should be classified as a certain type (e.g., a car, a person, an unknown object, or other suitable classification type).

A combined video analytics and classification system that combines conventional video analytics with blob-based object classification system can apply object classification (e.g., blob classification) based on conventional video analytics by utilizing the blobs (also referred to as regions of interest (ROIs) or events of interest (EOIs)) identified by blob detection and blob tracking systems. To achieve lower complexity yet relatively high accuracy, the object classification can be invoked seamlessly with blob detection and tracking systems (which can be included in a video analytics engine) to leverage contextual information (e.g., events generated by blob tracking, intermediate states of the blobs, sizes of the blobs, one or more durations of the blobs, and/or other suitable context) provided by the blob detection and tracking systems.

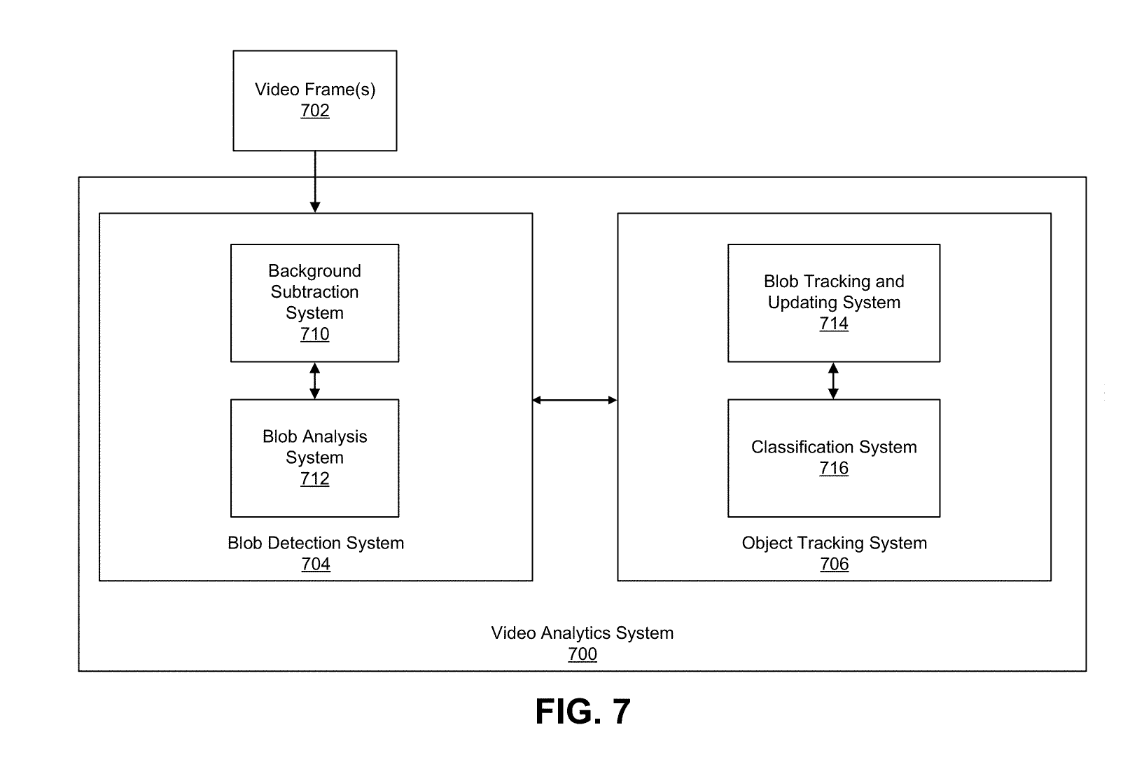

The object classification system of the combined video analytics and classification system can manage object classification requests and can apply the classification requests to the blob detection and tracking results of a current video frame after the blob detection and tracking are finished. As described in more detail below with respect to FIG. 7, the object classification system can ensure that the complexity required for classification will not be concentrated in singular frames. For example, in some cases, classification can be designed in a way that, at most, N classification requests (e.g., N can be equal to 1, 2, or any other suitable and configurable value) can be invoked in M frames (e.g., M can be equal to 1, 2, or any other suitable and configurable value). As described in more detail below, a context-based classification request generation technique can be used, where the need to invoke classification for blobs in a video frame is reduced to a low frequency. In one illustrative example, classification can be invoked on average, once per second, corresponding to once per 30 frames in a 30 frame per second video sequence, once per 60 frames in a 60 frame per second video sequence, and so on. Furthermore, as described in detail below, advanced and content-adaptive confidence intervals can be used to determine whether a current confidence, a current tracking status, and a current class would lead to a new type for a current object or not.

Various issues can arise using a combined video analytics and classification system. For example, conventional video analytics systems (e.g., video analytics system 100) can and oftentimes do operate on a low resolution version of a video sequence (e.g., a downscaled version of a high resolution video sequence, such as downscaled from a 1080p resolution to a 360p resolution) from an image signal processor (ISP). Using a low resolution video sequence, a video analytics system can still offer sufficient detection range. However, object classification systems (e.g., deep-learning based object classifiers) typically need to access the high resolution video frames (e.g., 1080p resolution, 4K resolution, 8K resolution, and/or other high resolution) in order to be able to detect certain objects (e.g., objects that are small in size, occluded objects, objects captured with poor lighting conditions, and/or other objects). One advantage of such a combined video analytics and classification system is that, regardless of the resolution of the frames or images that are processed by the conventional video analytics processes (blob detection and object tracking), the video analytics system can access a high resolution (e.g., 1080p, 4K, or other suitable resolution) frame for blob classification, which can allow potentially higher classification accuracy for certain objects (e.g., small objects, occluded objects, objects captured with poor lighting conditions, and/or other objects).

However, such a solution can lead to disadvantages, including, for example, potentially more memory bandwidth consumption, and high per-frame latency. For instance, the object bounding box (or ROI) will not be available to be input into the classification system until the execution of the conventional video analytics functions (e.g., blob detection and object tracking) for a current frame are complete. In one illustrative example, the combined video analytics and classification system can be performed in a sequential manner, in which case the system can finish the object detection and tracking processes and can then apply the object classification. Such a sequential process can lead to higher end-to-end accuracy because the object classification process can be applied to the most relevant blob(s) (based on the bounding boxes generated from object detection and tracking) and the classification results can be applied to a current tracked object immediately (e.g., a class type can be shown along with a tracked object). However, if the conventional video analytics and object classification functions are handled in a sequential manner, the maximum latency for each frame can become higher than in a stand-alone video analytics system.

Further, if the conventional video analytics functions and the object classification system are executed in a sequential manner for a video frame, there would be a need to hold (e.g., queue, buffer, make a copy of, or the like) both the high resolution version of the video frame (e.g., the full resolution frame) and the downscaled version of the video frame. Both the high and low resolution versions of the video frame would be needed because the latency of the entire processing pipeline may be longer than the input frame rate. For instance, the processing time involved with object detection and tracking and that involved with classification can take longer than the frame rate associated with one frame (e.g., 1/30 seconds in a 30 fps video), causing the system to have to store a current high resolution video frame when a next frame is received for processing so that the processing can finish for the current frame. Using a 1080P full resolution frame (having width×height dimensions of 1920×1080) of a 30 fps video sequence as one illustrative example, the addition of the object classification process to the conventional video analytics system can cause a net memory bandwidth increase of 1920×1080×30×1.5×8 bits per second (bps), which is approximately 750 mbps (assuming 1080P YUV processing).

As noted above, the need to buffer the additional high resolution frame arises because the video analytics (with classification) processing latency may be longer than the frame rate. In some cases, the latency can be reduced and an end-to-end video analytics plus object classification system having a certain frame rate (e.g., 30 fps) can be designed by pipelining the video analytics (blob detection and object tracking) and object classification systems using multiple processing threads that can run in parallel. For instance, at any time T, certain initial parts of the conventional video analytics system can operate on a current video frame in one processing thread, while the later parts of the video analytics and object classification can operate on the previous video frame in a second processing thread. Although this type of optimization can reduce the overall latency of the combined video analytics and classification processing on a video frame, the need to hold both the downscaled and high resolution versions of the frame still exists. For example, at any time T, the low resolution image (e.g., a downscaled image) for the current frame and the high resolution image from the previous video frame would need to be held. In this case, similar to the example described above, the addition of the object classification system to the video analytics system causes a net memory bandwidth increase of approximately 750 mbps (assuming a 30 fps video stream and 1080p YUV processing).

An efficient blob classification framework is provided for use by a combined video analytics and classification system, which can reduce both the memory bandwidth and per-frame latency associated with such a combined video analytics and classification system. For example, object classification can be applied to a patch produced from a high resolution frame by utilizing the object detection and tracked bounding box information. In some cases, the patch can have a pre-determined size denoted as W×W. For instance, the predetermined size W×W can be a pre-determined size that is used as input by the classification system.

Any suitable combined video analytics and classification system can be used to generate and prioritize classification requests. FIG. 7 is an example of a video analytics system 700 that combines conventional video analytics (blob detection and object tracking) and object classification. The video analytics system 700 can be used to perform object detection and tracking in real-time. The video analytics system 700 can also selectively perform object classification of one or more blobs in a video frame based on characteristics associated with the one or more blobs and the associated object trackers. A frame currently being processed by the video analytics system 700 is referred to herein as a current frame, and a tracker currently being processed by the video analytics system 700 is referred to herein as a current tracker.

The video analytics system 700 includes a blob detection system 704 and an object tracking system 706. The blob detection system 704 can obtain video frames 702 of a video sequence provided by a video source (not shown), and can perform object detection to detect one or more blobs (representing one or more objects) for the video frames 702. The blob detection system 704 includes a background subtraction system 710 that is similar to and that can perform the same operations as the background subtraction system 312 described above with respect to FIG. 3. For example, the background subtraction system 710 can perform background subtraction to detect foreground pixels in one or more of the video frames 702. By using background subtraction, moving objects can be segmented from the global background of the video sequence. In some cases, a foreground mask can be generated by the background subtraction system 710. An indication of the foreground pixels (e.g., the foreground mask) can be provided to the blob analysis system 712 for further analysis. The blob analysis system 712 is similar to and can perform the same operations as the morphology engine 314, the connected component analysis engine 316, and the blob processing engine 318 described above with respect to FIG. 3. For example, the blob analysis system 712 can determine or generate blobs based on the foreground pixels provided from the background subtraction system 710. Blob bounding boxes associated with the blobs can also be generated by the blob analysis system 712. In some cases, the blobs and/or the blob bounding boxes can be further processed by the blob detection system 704, as described above. While examples are described herein using bounding boxes as examples of bounding regions, one of ordinary skill will appreciate that any other suitable bounding region could be used instead of bounding boxes, such as bounding circles, bounding ellipses, or any other suitably-shaped regions representing trackers, blobs, and/or objects.

The object tracking system 706 includes a blob tracking and updating system 714 that is similar to and can perform the same operations as the cost determination engine 412, the data association engine 414, and the blob tracker update engine 416 of the object tracking system 106 described above with respect to FIG. 4. For example, as described above, the blob tracking and updating system 714 can associate trackers and their bounding boxes with the one or more blobs (using the blob bounding boxes) detected by the blob detection system 704. A tracker bounding box can then be displayed as tracking a tracked object/blob when certain conditions are met (e.g., the blob has been tracked for a certain number of frames, a certain period of time, and/or other suitable conditions). The blob tracking and updating system 714 can also include a video analytics manager that can record object detection and tracking events. For example, a state machine run by the blob tracking and updating system 714 can update the states (or statuses) of the various trackers, and can provide the states to the video analytics manager. The video analytics manager can maintain metadata for each of the trackers and their bounding boxes. The blob tracking and updating system 714 can also predict the tracker positions for a next frame based on the positions of the blob for which the trackers are associated, as described above with respect to FIG. 1-FIG. 4. In one illustrative example, the blob tracking and updating system 714 can implement a Kalman filter to predict the tracker positions. However, other tracking methods can also be performed, including optical flow, template matching, meanshift, camshift, and/or other suitable tracking methods.

The object tracking system 706 also includes a classification system 716 that can perform classification for certain blobs. The classification system 716 can be used in a way that provides a very low complexity, yet high accuracy classification for the video analytics system 700. As described in more detail below, the classification system 716 can perform blob based classification based on any suitable blob classification technique (e.g., Cifar-10, SSD, YOLO, or other suitable detector). For example, the classification system 716 can apply a trained neural network-based detector (using a trained classification network) to classify one or more of the blobs detected and/or tracked in the video frames 702. The blob based classification can be performed using the blob bounding boxes identified by the blob detection system 704 and/or the blob tracking and updating system 714.

To achieve low complexity and high accuracy classification results for the video analytics system 700, the classification can be performed seamlessly with the other video analytics processes by utilizing contextual information from the other video analytics processes (performed by the blob tracking and updating system 714). For example, only certain blobs can be selected for classification based on events generated during blob tracking, based on intermediate states of the blobs, based on sizes of the blobs, based on one or more durations associated with the blobs and their associated trackers, and/or other suitable contextual information. Instead of applying the classification system at a high frequency (e.g., for each blob of each frame, for multiple blobs in each frame, or the like), the blob classification can be invoked at a much lower frequency (e.g., for only one blob per video frame, for less than all blobs detected in a video frame, or other frequency).

Furthermore, as described in more detail below, the video analytics system 700 performs a scheme of handling classification invocations so that memory bandwidth consumption is significantly reduced. For example, when a classification request is determined to be invoked immediately in a current video frame (e.g., based on the context from the video analytics processes), instead of performing the classification task in the current frame for the blob associated with the classification request (in which case the entire picture of the current frame would need to be accessed), the classification task can be performed for the blob in a next video frame. The classification task can be performed using the next video frame using an image patch from the next video frame instead of the entire video frame. For example, the image patch can be extracted from a high resolution version of the next video frame (e.g., the full resolution video frame, as opposed to a downsampled version of the video frame). The image patch can be determined using bounding region information associated with the blobs. Further details of such a memory-efficient classification framework are described in more detail below.

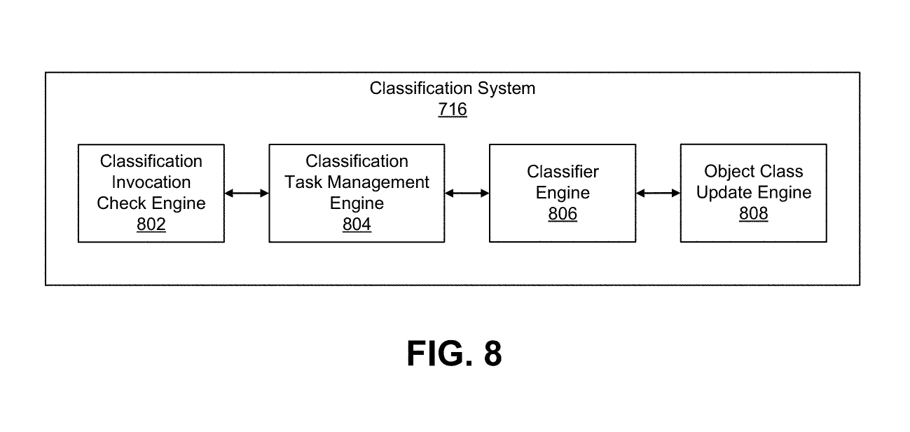

FIG. 8 is a diagram illustrating details of the classification system 716. The classification system 716 includes a classification invocation check engine 802 that checks, for each tracker (and the blob being tracked by the tracker), whether a classification should be invoked. The classification invocation check engine 802 allows classification to be invoked with a much lower frequency (compared with per-frame, per-tracker invocation), yet provides high accuracy by invoking classification according to important events and other contextual changes. The classification invocation check for a tracker can be based on various contextual factors associated with the tracker (and the blob being tracked by the tracker) in a current video frame. For example, at least two mechanisms can be used to invoke classification (e.g., classification requests, as described below). The first mechanism is based on a tracker state change. For example, a classification function can be invoked for a tracker based on a state change event of the tracker in the current video frame. The second mechanism is a passive re-confirmation, can be based on a size change of the blob between a previous video frame and the current video frame and/or based on a duration associated with the tracker and its blob.

In some cases, when classification is determined to be invoked for a given tracker (and the blob being tracked), instead of immediately invoking the blob classification function for the blob, the classification invocation check engine 802 can generate a classification request for the tracker. A classification request can include the tracker with its associated tracker label (e.g., a tracker identifier) and the bounding box of the tracker in the current frame. By generating a classification request for a tracker, the invocation of the blob classification functions can be globally managed by the classification task management engine 804 to reduce worst case complexity. For example, the classification task management engine 804 can prioritize tracker classification requests in order to smooth a potential burst of classification requests over multiple frames. In some cases, a list containing all of the classification requests can be maintained. Such a list can be referred to herein as an object classification list.

The classification task management engine 804 can select one or more classification requests in each frame of the video sequence. For example, the classification task management engine 804 can select one or more of the trackers for classification in a current frame based on the assigned priorities of the various trackers that have outstanding classification requests. If a current tracker is not selected and thus will not be classified in the current frame based on its classification request, the tracker's classification request can be considered for selection in future frames. In such cases, for any old request generated in a previous frame for a tracker, the bounding box of the tracker can be updated in the current frame and used to determine whether to continue to maintain the request and/or for actual classification of the blob being tracked by the tracker.

A selected classification request for a given tracker is provided to the classifier engine 806. The classifier engine 806 invokes blob classification for the blob (and associated object) being tracked by the tracker that is associated with the chosen classification request. As described in further detail below, the memory-efficient classification framework noted above can be applied in order to classify the blobs (and associated objects) associated with the selected one or more trackers in a next frame using a patch of a high resolution version of the next frame. After classification is invoked in a next frame for a given tracker based on a classification request selected in the current frame, the object class update engine 808 may change the class type of the current tracker.

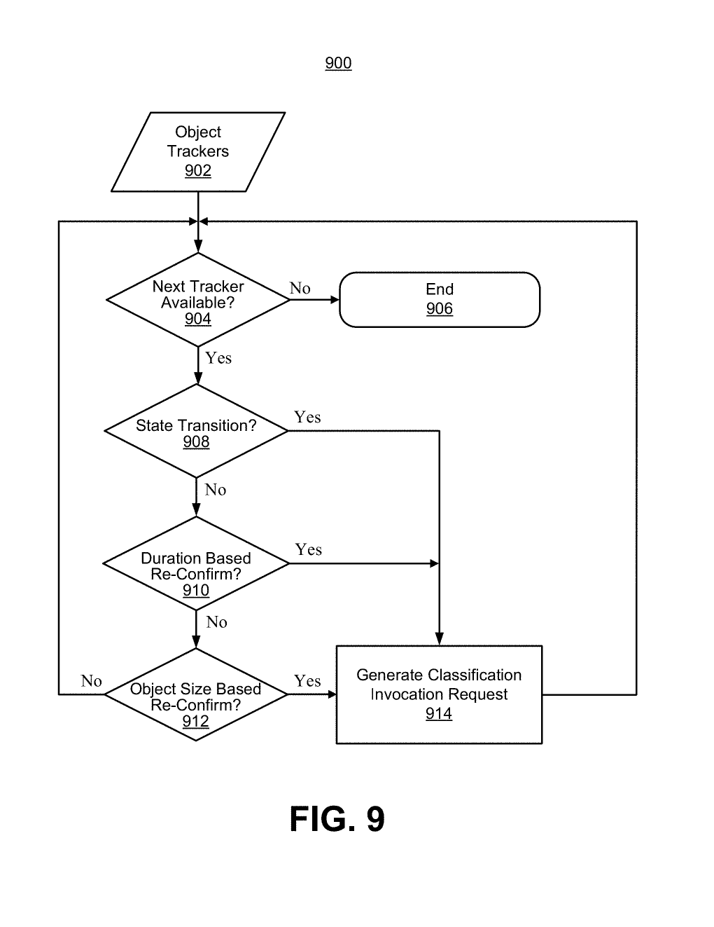

FIG. 9 is a flowchart illustrating an example of a process 900 for performing a classification invocation check. The process 900 can be performed by the classification invocation check engine 802 and can be used to determine whether to invoke classification for a tracker or to generate a classification request for the tracker. The process 900 is performed at each video frame of a sequence of video frames and for each tracker maintained for the sequence of video frames.

The process 900 operates on the object trackers 902. The object trackers 902 can be generated by the blob tracking and updating system 714. In some cases, the process 900 can be performed for a current tracker in a current frame after the tracking process is performed by the blob tracking and updating system 714 and before the current tracker is output for the current frame. In some cases, the classification invocation check engine 802 can check all the trackers that are to be output in a current frame (e.g., normal trackers). In some cases, the classification invocation check engine 802 can check all trackers maintained for a current frame regardless of whether the tracker is to be output. At block 904, the process 900 determines if a next tracker is available. If no further trackers are available for processing, the process 900 ends at block 906.

If a next tracker is available for processing, the process 900 analyzes the tracker (referred to as the current tracker) at block 908. As noted above, the classification invocation check engine 802 determines whether classification should be invoked for a current tracker based on various contextual factors associated with the current tracker (and the blob being tracked by the tracker) in a current video frame. One mechanism that can be used to generate a classification request for a tracker can be based on a tracker state change. For example, at block 908, the process 900 determines whether a state transition has occurred for the tracker in the current frame. If the process 900, at block 908, determines that a state transition has occurred for the current tracker, the process 900 generates a classification invocation request for the current tracker at block 914.

Various state changes can cause the process 900 to generate a classification invocation request for a current tracker. Examples of such state changes include a new state change (denoted as NEWP), a split-new state change (denoted as SPLIT NEWP), a split state change (denoted as SPLIT), a recover state change (denoted as RECOVER), and a merge state change (denoted as MERGE). The NEWP state change is determined when a newly detected tracker has just been transited to the normal status in the current frame and is to be output in the current frame. For example, a new tracker can be generated for a new blob that has just been detected in a frame. After being associated with the blob for a certain threshold duration (e.g., the threshold duration T1 described above), the tracker can be transitioned to the normal status. At the frame at which the tracker is transitioned to the normal status, a classification invocation request can be generated for the tracker.

The SPLIT NEWP state change is determined when a tracker was previously split from an existing tracker, and has just been transited to the normal status in the current frame and is to be output in the current frame. For example, a tracker can be split from another tracker in a first frame. After being associated with a blob for a certain threshold duration (e.g., the threshold duration T2 described above), the split-new tracker can be transitioned to the normal status at a second frame. At the second frame at which the split-new tracker is transitioned to the normal status, a classification invocation request can be generated for the split-new tracker.

The SPLIT state change is determined when a tracker was already output (already had a normal status) and was just split from a tracker in the current frame. For example, a normal tracker may become merged with another tracker at a first frame. The normal tracker may then split from the other tracker at a second frame, at which point the tracker may again be output as a system level event. In such an example, at the second frame, a classification invocation request can be generated for the tracker.

The RECOVER state change is determined when a lost or hidden tracker is detected and output again (with an old tracker label or ID) in the current frame. For example, a blob being tracked by a tracker may not be detected in a first frame, at which point the tracker is transitioned to a lost state. At a second frame, the blob may again be detected, at which point the tracker can be output again with the same tracker ID. In such an example, a classification invocation request can be generated for the tracker at the second frame.

The MERGE state change is determined when a normal tracker is merged into another tracker in the current frame. For example, in a current frame, a blob being tracked by a normal tracker may be merged with another blob being tracked by another tracker (e.g., due to two objects overlapping in the scene being captured by the video frame). In such an example, a classification invocation request can be generated for the normal tracker at the current frame.

Another mechanism that can be used to generate a classification request for a tracker can be based on a passive re-confirmation. Two kinds of re-confirmation can be used to re-confirm a tracker, including a duration based re-confirmation and an object size based re-confirmation. For example, at block 910, the process 900 determines whether a duration based re-confirmation passes for the current tracker in the current frame. The duration based re-confirmation can depend on an idle duration assigned to each tracker. The idle duration of a tracker denotes the duration from the last classification request that was invoked for the tracker until the current frame. For instance, the idle duration can indicate the number of frames (or an amount of time) between the current video frame and a last video frame at which a classification request was generated for the object tracker. In some cases, a tracker's idle duration is incremental on a per-frame basis (e.g. increased by 1 per frame). Only after a tracker's classification request is removed from the object classification list, the idle duration of the tracker is reset to 0. The tracker's idle duration can then be incremented by 1 at each frame until the tracker's classification request is again removed from the object classification list. As noted above, the object classification list is a list containing all of the pending classification requests.

The idle duration of a tracker must be larger than an idle duration threshold (denoted as iDur) to pass duration based re-confirmation. For example, if the process determines, at block 910, that the idle duration of a tracker is larger than iDur (a “yes” decision), the current tracker passes the duration based re-confirmation and the process 900 generates a classification invocation request for the current tracker at block 914. The idle duration threshold IDur can be set to any suitable value, such as 30 frames, 60 frames, 90 frames, an amount of time, or any other suitable value. In one illustrative example, iDur may be set to 90 frames (equal to approximately 3 seconds for a 30 frame per second (fps) input video sequence). In such an example, once a current tracker has been idle (no classification request has been generated for the tracker) for at least 90 frames, the process 900 can determine that the current tracker has passed the duration based re-confirmation, and can generate a classification invocation request for the current tracker at block 914.

At block 912, the process 900 determines whether an object size based re-confirmation passes for the current tracker in the current frame. The object size based re-confirmation can be performed by comparing the size of a current tracker in the current frame to a size of the tracker in a previous frame when the classification was last applied for the current tracker. The size of the tracker can be based on the bounding box of the blob or object being tracked by the tracker. For example, the bounding box of a tracker in a current frame can be the bounding box of the blob the tracker is tracking in the current frame. The size of the tracker's bounding box can be used in the object size based re-confirmation. The size comparison between the tracker's current bounding boxes in the current frame and the tracker's previous bounding box in the previous frame can be based on a size ratio between the current bounding box and the previous bounding box. For example, if the size ratio for a tracker is larger than a size comparison threshold (denoted as TSize), the tracker passes the object size based re-confirmation. The size comparison threshold TSize can be set to any suitable value, such as 2, 3, 4, 5, or any other suitable value. In one illustrative example, TSize can be set to 3, in which case the tracker passes the object size based re-confirmation if the size of the tracker in the current frame is at least 3-times larger than the size of the object tracker in the previous frame (when the classification was last applied for the current tracker).

Such a size based re-confirmation can be useful in various instances. For example, if a person is far from the camera in a first frame, the video analytics system 700 may not be able to recognize the person because the person (and its tracker) may be too small. The size based re-confirmation check can be performed for the tracker at every frame to determine if the size ratio of the tracker exceeds the size comparison threshold TSize. At a later point in time (e.g., at a current frame), the person may move closer to the camera, in which case the size of the tracker tracking the person will become bigger. The size based re-confirmation can pass for the tracker when the size ratio of the tracker becomes larger than the threshold TSize (e.g., the current bounding box of the tracker is at least TSize-times bigger than the previous bounding box of the tracker), at which point a new classification request can be generated for the tracker. In such an example, the classification can be more successful in accurately classifying the person (with a high confidence level) when the person is bigger. In another example, if a person is very close to the camera in a first frame such that only a portion of the person is in the frame (e.g., only the person's nose), the video analytics system 700 may not be able to recognize the full person. At a later point in time (e.g., at a current frame), the person may move away from the camera, at which point the person's entire body or face is captured in the frame. The size based re-confirmation can pass for a tracker when the size ratio of the tracker becomes larger than the threshold TSize (e.g., the current bounding box of the tracker is at least TSize-times smaller than the previous bounding box of the tracker), at which point a new classification request can be generated for the tracker. In such an example, the classification can more accurately classify the person (with a high confidence level) when the full person is visible.

While blocks 908, 910, and 912 are shown in FIG. 9 as being performed serially and in a certain order, one of ordinary skill will appreciate that the functions of blocks 908, 910, and 912 can be performed in parallel or in a serial manner, and that the functions of blocks 908, 910, and 912 can be performed in any suitable order. For example, the object size based re-confirmation check can be performed before (or in parallel with) the duration based re-confirmation check.

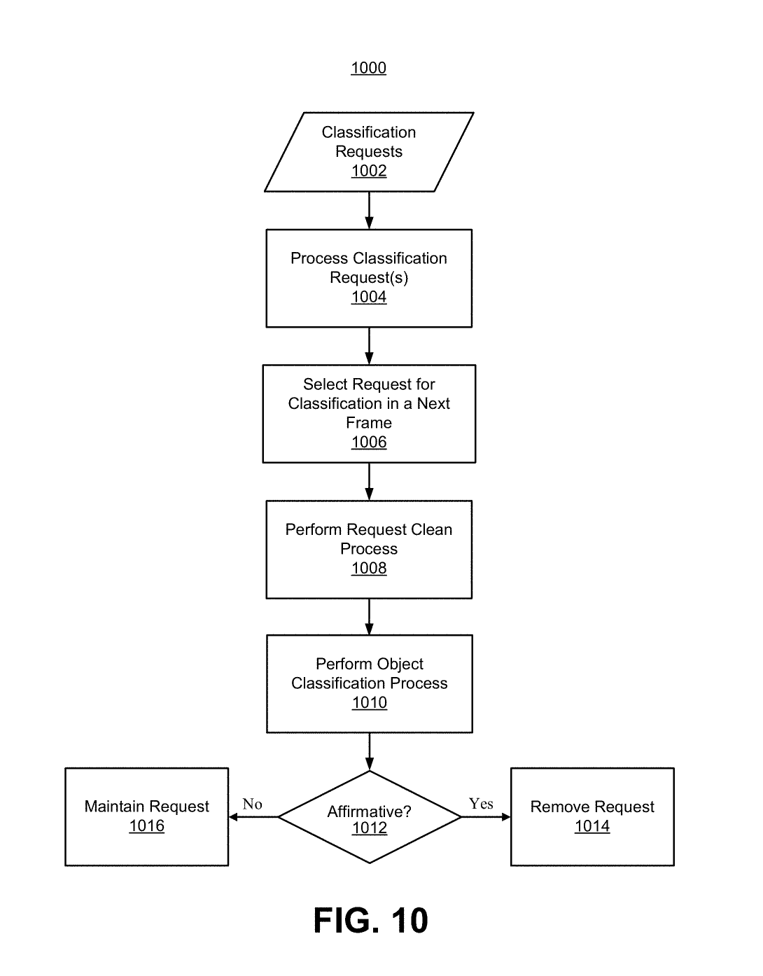

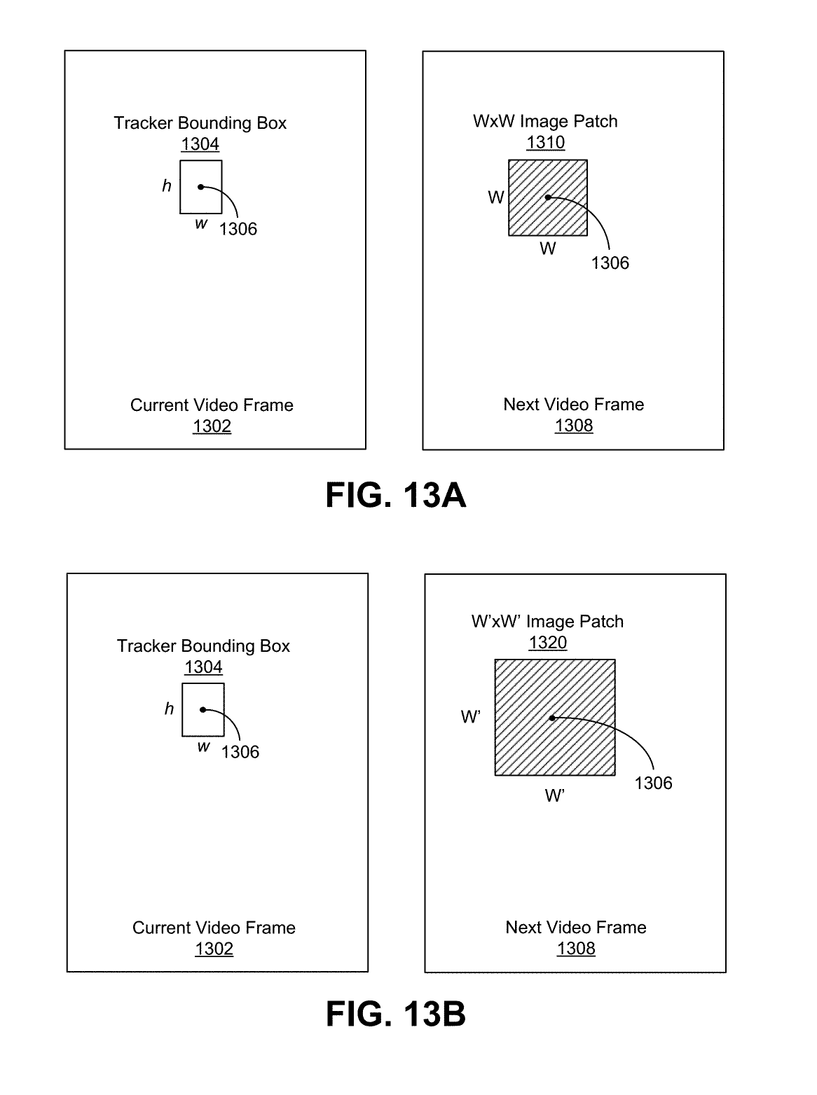

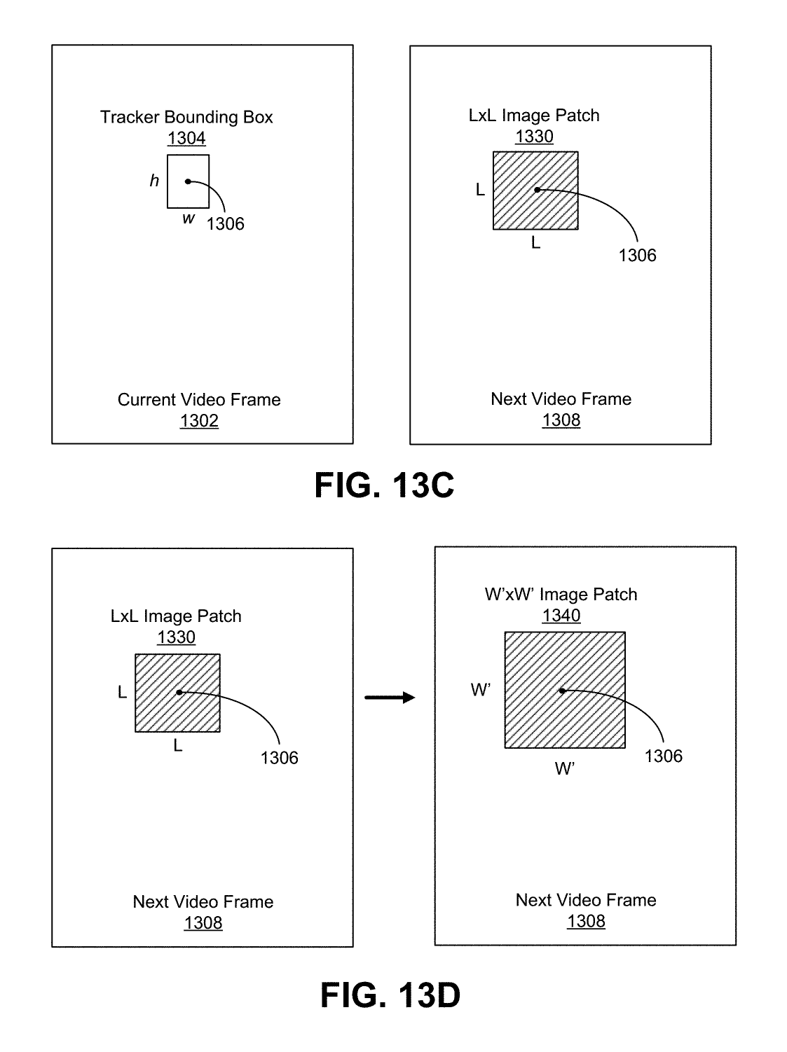

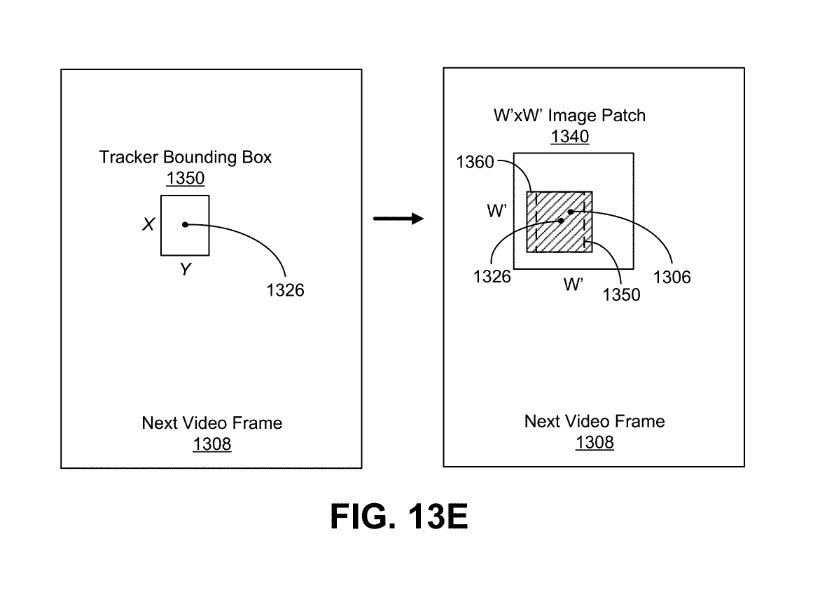

Returning to FIG. 8, the classification task management engine 804 takes the classification requests generated by the classification invocation check engine 802 as input, and selects one or more classification requests for the current frame. The one or more classification requests selected in the current frame can be invoked or applied to a next frame, as described in more detail below with respect to FIG. 13A-FIG. 13DE. An example process 1000 for performing classification task management is described below with respect to FIG. 10. In some examples, the classification task management engine 804 can select just one classification request for current frame. For example, classification task management process 1000 can be applied once per frame. In some examples, the classification task management engine 804 can select more than one request for each frame. In some cases, the classification task management engine 804 can be applied once every M frames, where M is an integer greater than 1. In some cases, the classification task management engine 804 can be applied to select N requests once every M frames, where N is an integer greater than 1.

As noted above, FIG. 10 is a flowchart illustrating an example of a process 1000 for performing classification task management. The process 1000 can be performed by the classification task management engine 804 at each video frame of the video sequence, and can be used to select one or more classification requests of one or more trackers in a current frame based on classification requests 1002 assigned to multiple trackers. Classification can then be invoked in a next frame for the tracker that is associated with the classification request selected in the current frame. The classification requests 1002 can be maintained in an object classification list, as described above. In some cases, the classification requests can be separated into current requests generated in the current frame and old requests generated in previous frames (but that have not been selected or processed).

At block 1004, the process 1000 processes the classification requests 1002. The classification requests can be prioritized, which can be used to determine which request will be selected in the current frame. For example, current requests can have the highest priority, and priorities can be assigned to the old classification requests such that older classification requests are prioritized over newer classification requests. In some cases, the old requests can be prioritized based on a timestamp of when the requests where generated, such that an old request with a highest timestamp value can be selected. In such cases, the old requests can be prioritized based on ascending order of timestamp (in a first-in-first-out (FIFO) manner) according to when the requests are generated.

At block 1006, when processing the classification requests 1002 for the current frame, the process 1000 selects a classification request for classification in a next frame. According to the priorities discussed above, when there is at least one current classification request, one of the current classification requests is selected for classification in the next frame. For example, when a current classification request is present in the object classification list, the current classification request can be selected for classification in the next frame at block 1006. When there are multiple current classification requests, the process 1000 can select k classification requests in the front of classification request list (in a FIFO manner), where k can be an integer value larger than 1. When there is no current request (only old classification requests are present in the object classification list), the old classification request with the largest waiting duration (wDur) can be selected (at block 1006) for classification in the next frame.

In some examples, as noted above, the classification task management process 1000 can select just one classification request to be invoked for next frame. For example, classification task management process 1000 can be applied once per frame to select one classification request for invocation. In some examples, when processing the current frame, the process 1000 can select more than one request for classification in the next frame. In some cases, the process 1000 can be applied once every M frames, where M is an integer greater than 1. In some cases, the process 1000 can be applied to select N requests once every M frames, where N is an integer greater than 1. A waiting duration (wDur) can be maintained for a classification request of a tracker. The waiting duration (wDur) be initialized to be 0, and can be maintained at a 0 value until the classification request is selected. Once the classification request is selected (at block 1006), and the request is still pending after the classification process described below is performed, the waiting duration (wDur) of the classification request can start to increase over time (e.g., based on the update request process described below).

In some cases, a request clean process can be applied to a selected classification request. The request clean process can be used to remove any classification request in the object classification list associated with the same tracker label (or tracker ID) as the selected classification request and/or to update the bounding box of the selected request to the bounding box of the tracker in the current frame. Turning to FIG. 10, at block 1008, the process 1000 can perform the request clean process to a selected request. As noted above, a classification request can include the tracker label and the bounding box (as in the current frame) of the tracker associated with the classification request. Using such information, the classification task management engine 804 can check the classification requests in the object classification list to determine if any of the classification requests are associated with a tracker having the same tracker label as the tracker associated with the selected classification request. For instance, the tracker label associated with each classification request can be compared to the tracker label associated with the selected classification request to determine if there is a matching tracker label. If one or more of the classification requests from the object classification list have a tracker label that matches the tracker label of the selected classification request, the classification task management engine 804 can remove the one or more of the classification requests from the object classification list.

In some cases, the cleaning process also includes updating the bounding box of the selected classification request to the bounding box of the associated tracker in the current frame. For example, the classification task management engine 804 can associate the selected classification request with the current bounding box of the tracker in the current frame before sending the bounding box information and tracker label information to the classifier engine 806. In some cases, if a classification request cannot be associated with any bounding box in the current frame (e.g., due to the fact that it is lost), the classification request can also be removed. Such a removal of a classification request that does not have an associated bounding box in the current frame can be performed only for a selected classification request in some cases, or can be performed for all classification requests in the object classification list in some cases.

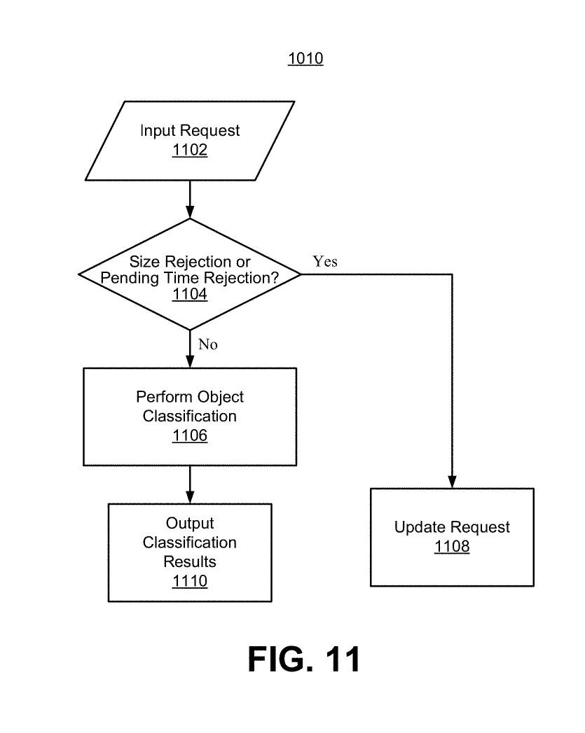

The classifier engine 806 can invoked in a next for a request selected in the current frame (once the request clean process is performed in some cases). Returning to FIG. 10, at block 1010, the process 1000 includes performing the object classification process for the blob being tracked by the tracker associated with the selected classification request. For instance, as described in more detail below, the classifier engine 806 can perform blob classification on an image patch of the next video frame. The image patch can be defined using a bounding box of the tracker in the current frame, a bounding box of the tracker in the next frame, or a combination of both. The bounding boxes in the current frame and the next frame can include a predicted bounding box (at the predicted location described above) or the updated bounding box (at the actual location described above) of the tracker. Other optional functions that can be performed by the classifier engine 806 at block 1010 are described below with respect to FIG. 11.

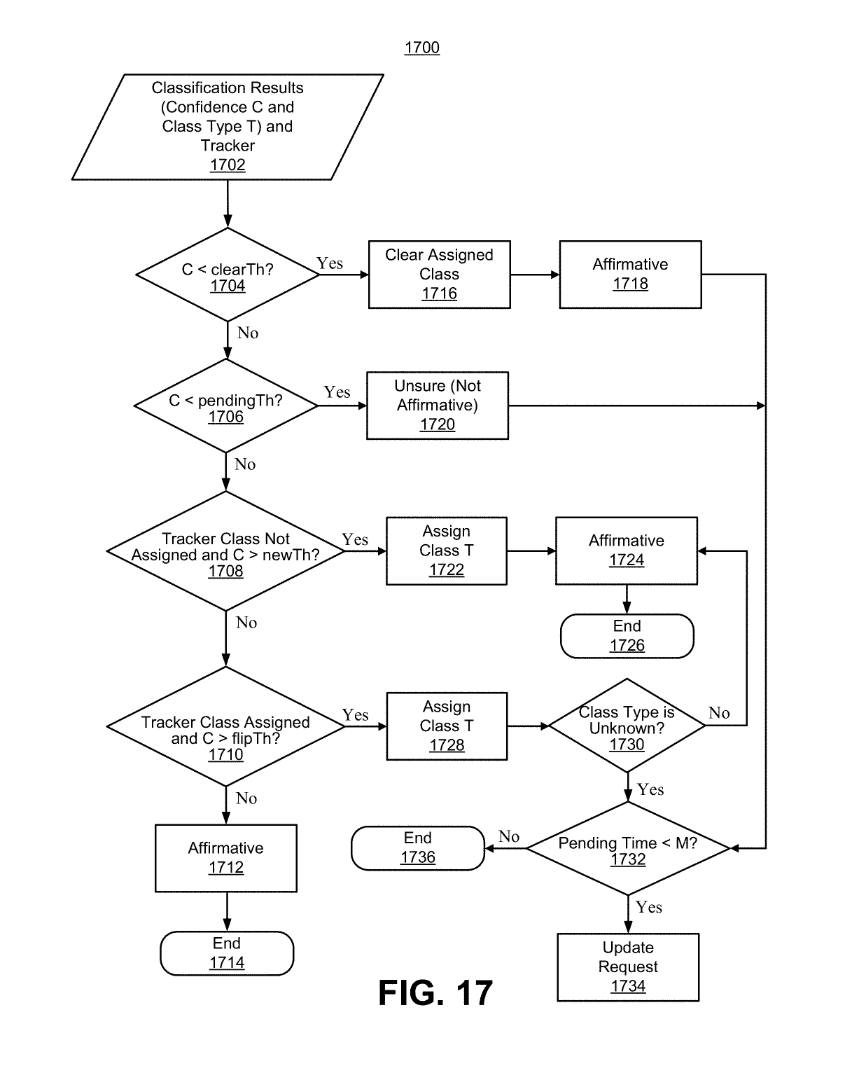

At block 1012, the process 1000 determines whether the classification process generates affirmative results. For example, an affirmative result can be determined based on results from the object class update engine 808 (e.g., as discussed below with respect to FIG. 11 and FIG. 17). Once the classifier engine 806 provides affirmative results (as determined at block 1012), the selected classification request is removed from the object classification list at block 1014. However, if an affirmative result is not determined at block 1012, the classification request is maintained in the object classification list at block 1016. The waiting duration (wDur) of the classification request can be incremented by 1 (e.g., by the update request process described below).

Using the techniques described above, the classification task management engine 804 can greatly reduce the complexity of a video analytics system that utilizes classification in addition to background subtraction based blob detection and tracking. As an illustrative example, the complexity can be reduced from hypothetically 5-20 function calls (e.g., of Cifar-10 per frame) to up to the worst case of 1 function call per frame (when one request is selected per frame) and an average case of once per 10 frames.

FIG. 11 is a flowchart illustrating an example of the functions performed at block 1010 of FIG. 10. As noted above, the functions of block 1010 can be performed by the classifier engine 806 based on a selected classification request. For example, the classifier engine 806 takes as input the selected classification request 1102 (represented as a tracker label and bounding box of the tracker associated with the classification request). The classifier engine 806 can then access the image patch determined from the next frame that will be processed by the classification process.

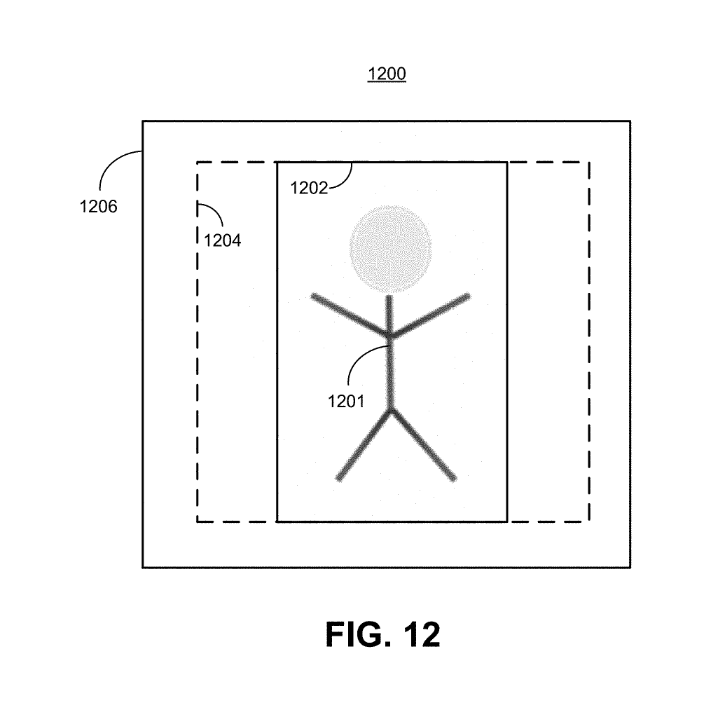

In some cases, the classifier engine 806 can perform pre-processing to generate a fixed size input image patch for the neural network of the classifier engine 806 to process. As described in more detail below, the neural network used by the classifier engine 806 can include any suitable neural network, such as a Cifar-10 network, an SSD based network, a YOLO based network, or other suitable neural network. FIG. 12 is a diagram 1200 illustrating an example of pre-processing performed on an input bounding box 1202 of a tracker to generate a fixed size final bounding box 1206 for the neural network of the classifier engine 806. As described in more detail below, the input bounding box 1202 of the tracker can be based on the bounding box of a blob (represented by person 1201) being tracked by the tracker in the current frame and the bounding box of the blob (not shown) being tracked by the tracker in the next frame. The pre-processing includes expanding the input bounding box 1202 to a square shape (shown as box 1204 with a dotted outline) and then enlarging the bounding box 1204 by a scaling factor to get the final bounding box 1206. The scaling factor can be set to any suitable amount, such as 1.1, 1.125 (36/32), 1.13, 1.2, or other suitable value. The scaling factor can be determined to be a certain value such that all bounding boxes that are processed by the classifier engine 806 have a fixed size. The fixed size can be denoted as W×W (a width of W×a height of W). For example, the input bounding box can be enlarged can be resized to 32×32 (or other suitable value, such as 36×36, 64×64, or other suitable size) and fed to the neural network of the classifier engine 806. The neural network can take the re-sized bounding box and can classify it as one of a number of predefined classes with a confidence level (or confidence score).

As noted above, a memory-efficient scheme of handling classification invocations can be performed so that memory bandwidth consumption is significantly reduced. For example, when a classification request is selected in a current video frame (e.g., based on the context from the video analytics processes), instead of performing the classification task in the current frame for the blob, which would require the entire picture of the current frame to be accessed, the classification task can be performed for the blob in a next video frame. The time instance of the current frame can be denoted as T, and the time instance of the next frame can be denoted as T+1.

The classification task can be performed in the next video frame using an image patch from the next video frame instead of the entire video frame. For example, when a classification task is determined to be performed in the next frame (e.g., at block 1006 of the process 1000), instead of loading the whole picture of the next frame, only an image patch (including less than the entire frame) is maintained. In some cases, the image patch can be extracted from a high resolution version of the next video frame (e.g., the full resolution video frame, as opposed to a downsampled version of the video frame), so that high accuracy object classification results can be obtained. The image patch can be determined using bounding region information associated with the blobs, and can have a size that is comparable to or equal to the input size (W×W) of the object classification function performed by the classifier engine 806.

FIG. 13A is a diagram illustrating an example of a tracker bounding box 1304 in a current video frame 1302 and a W×W image patch 1310 generated for a next video frame 1308. A tracker bounding box 1304 is generated for the current video frame 1302 for tracking an object associated with a detected blob. A center 1306 of the tracker bounding box 1304 is also shown. The tracker bounding box 1304 can include the actual location of the object tracker for the current frame, which, as described above, is the location in the current frame of the blob with which the tracker is associated in the current frame. A predicted location of the object tracker in the next video frame 1308 can be used to determine the region in the next video frame 1308 to use for the W×W image patch 1310. As described above, the predicted location of the object tracker in the next video frame 1308 includes a location in the current frame 1302 of the blob with which the object tracker was associated (and thus the actual location of the tracker bounding box 1304 in the current frame). For example, as shown in FIG. 13A, the center 1306 of the W×W image patch 1310 is aligned in the next video frame 1308 with the center 1306 of the tracker bounding box 1304 from the current video frame 1302. The center 1306 in the current video frame 1302 can have a same (x, y) coordinate as the center 1306 in the next video frame 1308. While a center point (center 1306) is used as an illustrative example, one of ordinary skill will appreciate that any point of the bounding box can be used to align the image patch (e.g., a center point, a top-left corner point, a top-right corner point, a bottom-right corner point, a bottom-left corner point, and/or other point). The tracker bounding box 1304 can be extended in both the vertical and horizontal directions from the h×w size to the W×W size, and image data (e.g., pixels) from the next video frame 1308 within the region corresponding to the extended tracker bounding box 1304 can be extracted as the W×W image patch 1310.

In some cases, it can be assumed that the object movement from a current frame to a next frame is within a limited range. In such causes, instead of obtaining a W×W sized patch in the next frame (using the bounding box information of the tracker from the current frame), a larger patch can be obtained by keeping a point (e.g., the center point or other point) of the bounding box aligned with a corresponding point (e.g., the center point or other point) of the current bounding box from the current frame, and extending the bounding box in both the vertical and horizontal directions. By extracting an enlarged patch, it can be expected that, even after the movement of the object (and the corresponding bounding box tracing the object) from the current frame at time T to the next frame at time T+1, the object is still within the area for which the pixels are extracted within the enlarged patch. In some examples, a pre-determined ratio P and an enlarged width and height of W′=(1+P)W can be applied to determine the size of the patch to be stored in memory. In one illustrative example, P is set equal to 1, but can be set to any suitable value.

FIG. 13B is a diagram illustrating an example of the tracker bounding box 1304 in the current video frame 1302 and a W′×W′ image patch 1320 generated for the next video frame 1308. Similar to the example shown in FIG. 13A, a predicted location of the object tracker in the next video frame 1308 can be used to determine the region in the next video frame 1308 to use for the W′×W′ image patch 1320. For example, as shown in FIG. 13B, the center 1306 (or other suitable point) of the W′×W′ image patch 1310 is aligned in the next video frame 1308 with the center 1306 (or other suitable point) of the tracker bounding box 1304 from the current video frame 1302. The tracker bounding box 1304 is extended in both the vertical and horizontal directions from the h×w size to the W′×W′ size. In one illustrative example, the enlarged region can be determined as W′=(1+P)W. The image data (e.g., pixels) from the next video frame 1308 within the region corresponding to the extended tracker bounding box 1304 can be extracted as the W′×W′ image patch 1320.

Another example is described with respect to FIG. 13C-FIG. 13E. For example, assuming the bounding box size of the object tracker from the current frame (at the actual location of the object tracker corresponding to its associated blob) is w×h, a patch of size L×L can be accessed in the next video frame by aligning the center (or other suitable point) of the L×L image patch with the center (or other suitable point) of the object tracker bounding box. For instance, the L×L image patch can be extracted or cropped from the next video frame. In one illustrative example, the dimension L can be equal to max((L+P)w, (L+P)h). The L×L image patch can be referred to herein as an initial image patch. The initial image patch can then be scaled to the size of W′×W′. The W′×W′ patch can be denoted as the restricted memory location patch (RMLP) or a reference image patch. The RMLP patch can be stored in memory. In some cases, the entire next video frame can then be discarded once the RMLP patch is extracted and/or stored in memory. In some cases, in the event the enlarged L×L initial image patch contains pixels outside the boundaries of the next video frame, the pixel values can be padded by adding boundary pixels to the initial image patch. For example, boundary pixels can be added first vertically and then horizontally.

FIG. 13C is a diagram illustrating an example of extracting an L×L image patch 1330 from the next video frame 1308. The L×L image patch 1330 can be extracted from the next video frame 1308 (e.g., when the next video frame 1308 is first received). The tracker bounding box 1304 is shown in the current video frame 1302 at the actual location of the object tracker (e.g., the location of the object tracker after being associated with a detected blob and being placed at the location of the detected blob). Similar to the example shown in FIG. 13A, a predicted location of the object tracker in the next video frame 1308 can be used to determine the region in the next video frame 1308 to use for the L×L image patch 1330. As previously described, the predicted location of an object tracker bounding box in a next video frame can be the actual location (after being associated with a blob) of the tracker bounding box in the current video frame. For example, a location within the next video frame 1308 corresponding to the predicted location of the object tracker (the location of the tracker bounding box 1304 of the object tracker in the current video frame 1302) can be determined. The L×L image patch 1330 can then be determined by obtaining image data (e.g., pixels) from the next video frame 1308 within an L×L region corresponding to the tracker bounding box 1304 of the object tracker at the predicted location in the next video frame 1308. A center (or other suitable point) of the L×L region is aligned with a center (or other suitable point) of the tracker bounding box 1304 located at the predicted location of the object tracker within the next video frame. For example, as shown in FIG. 13C, the center 1306 (or other suitable point) of the L×L image patch 1330 is aligned in the next video frame 1308 with the center 1306 (or other suitable point) of the tracker bounding box 1304 from the current video frame 1302. As noted above, the center 1306 in the current video frame 1302 can have a same (x, y) coordinate as the center 1306 in the next video frame 1308. The tracker bounding box 1304 is extended in both the vertical and horizontal directions from the h×w size to the L×L size. In one illustrative example, the dimension L can be equal to max((L+P)w, (L+P)h). The image data (e.g., pixels) from the next video frame 1308 within the region corresponding to the extended tracker bounding box 1304 can be extracted as the L×L image patch 1330. FIG. 13D is a diagram illustrating conversion of the L×L image patch 1330 to the scaled W′×W′ image patch 1340 (the RMLP patch).

After the bounding box information of the object associated with (e.g., using the tracker label) the selected classification task is determined for the next video frame (e.g., after the blob detection and object tracking are done for the next video frame), the updated bounding box (e.g., at the actual location described above) of the object tracker can be projected to the W′×W′ RMLP image patch, after which the bounding box of the object tracker can be denoted as a projected bounding box. For example, the four corner locations of the updated bounding box can be projected to the locations of the W′×W′ RMLP image patch. Once the projected bounding box is determined, its center point (or other suitable point) or coordinate can also be determined. The center point (or other suitable point) can be denoted as the projected center (or other projected point). In some cases, it can be assumed that the bounding box size (width and height) is rigid and does not change significantly from frame to frame (e.g., from the current video frame to the next video frame). In such cases, a final W×W image patch can be extracted from the W′×W′ RMLP image patch with the center (or other suitable point) of the final W×W image patch being the projected center. In some cases, if the pixels within the W×W image patch are outside of the boundaries of the W′xW′ RMLP image patch, the pixel values may be padded.

FIG. 13E is a diagram illustrating an example of extracting a final W×W image patch 1360 from the W′×W′ image patch 1340 (the RMLP patch). The actual location of the object tracker in the next video frame 1308 can be used to determine the region in the next video frame 1308 to use for extracting the final W×W image patch 1360. For example, a location of the tracker bounding box 1350 at the actual location of the object tracker in the next video frame 1308 can be determined within the W′×W′ image patch 1340. As noted above, the actual location of an object tracker in a next frame can include a location in the next frame of a blob with which the object tracker is associated in the next frame. The projected tracker bounding box 1350 is shown (at the actual location) with dotted lines in the W′×W′ image patch 1340 of the next video frame 1308. As shown, the center 1326 (or other suitable point) of the projected tracker bounding box 1350 is not aligned with the center 1306 (or other suitable point) of the W′×W′ image patch 1340, due to movement of the object (and corresponding blob) being tracked by the tracker bounding box 1350 from the current video frame 1302 to the next video frame 1308. The final W×W image patch 1360 can then be extracted by obtaining image data (e.g., pixels) from the next video frame 1308 within a W×W region of the W′×W′ image patch 1340. The center (or other suitable point) of the W×W region is aligned with the center 1326 (or other suitable point) of the tracker bounding box 1350 at the actual location in the next video frame 1308.

In some cases, the objects may be non-rigid. For example, the size of the bounding box of a given object tracker can change from frame to frame. In such cases, the projected bounding box can be used to get the texture out of the W′×W′ RMLP image patch. For example, the patch can be defined to be a size of u×v. The u×v patch can then be processed to get the final W×W image patch. For example, a patch may be padded to a square of U′×U′ (where U′=max (u,v)) and scaled to W×W.

In some cases, if the bounding box in the next video frame (at time T+1) and the bounding box in the current video frame (at time T) diverge by a certain amount, the classification process may not apply in the next video frame. In such cases, the classification request for the object tracker can be sent back to the list of classification requests and maintained by the classification task management engine 804. In other cases, the classification request for the object tracker is determined to be done, and the request is removed from the list of classification requests.

The divergence or difference between the bounding box in the next video frame (at time T+1) and the bounding box in the current video frame (at time T) can be determined using any suitable technique. The bounding boxes of the object tracker in the current and next video frames can be denoted as bounding box Bt (for the current frame) and bounding box Bt+1 (for the next frame). In some cases, the divergence can be based on an amount of overlap or intersection between the bounding boxes in the current and next video frames. In one illustrative example, if the size of the intersecting region between the bounding box Bt and the bounding box Bt+1 (denoted as size(Bt∩Bt+1)) is less than an intersection threshold, the classification can be skipped. In some examples, the classification request for the object tracker can be maintained for one or more future video frames. In some cases, the intersection threshold can be defined as a multiplier sr multiplied by the size(Bt+1), denoted as sr*size(Bt+1). The multiplier sr can be any suitable value, such as 0.7, 0.8, 0.9, or other value. In one illustrative example, if size(Bt∩Bt+1)<sr*size(Bt+1), the classification is skipped and is thus not performed at the next video frame. In such an example, the classification request for the object tracker can be maintained for one or more future video frames.

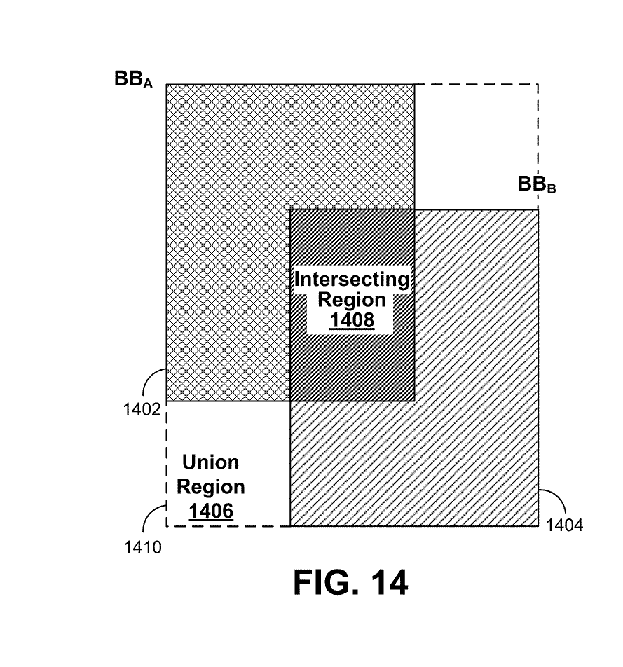

FIG. 14 is a diagram showing an example of an intersection I and union U of two bounding boxes, including bounding box BB_{A} 1402 of the blob tracker in the current frame and bounding box BB_{B} 1404 of the blob tracker in the previous frame. The intersecting region 1408 includes the overlapped region between the bounding box BB_{A} 1402 and the bounding box BB_{B} 1404.

The union region 1406 includes the union of bounding box BB_{A} 1402 and bounding box BB_{B} 1404. The union of bounding box BB_{A} 1402 and bounding box BB_{B} 1404 is defined to use the far corners of the two bounding boxes to create a new bounding box 1410 (shown as dotted line). More specifically, by representing each bounding box with (x, y, w, h), where (x, y) is the upper-left coordinate of a bounding box, w and h are the width and height of the bounding box, respectively, the union of the bounding boxes would be represented as follows:

Union(BB₁,BB₂)=(min(x₁,x₂),min(y₁,y₂),(max(x₁+w₁−1,x₂+w₂−1)−min(x₁,x₂)),(max(y₁+h₁−1,y₂+h₂−1)−min(y₁,y₂)))

In another example, the divergence can be based on a size difference between the bounding boxes. In one illustrative example, if the size of the bounding box Bt is less than a first threshold size, the classification can be skipped (request maintained for future frames). In some cases, the first threshold size can be defined as a multiplier sr′ times the size of the bounding box Bt+1. For instance, if size(Bt)<sr′*size(Bt+1), the classification can be skipped and is not performed at the next video frame. In another illustrative example, if the size of the bounding box Bt+1 is less than a second threshold size, the classification can be skipped. In some cases, the second threshold size can be defined as a multiplier sr′ times the size of the bounding box Bt. For instance, if size(Bt+1)<sr′*size(Bt), the classification can be skipped and is not performed at the next video frame. The multiplier sr′ can be any suitable value, such as 0.7, 0.8, 0.9, or other value.

After the classification is done and a new type or class is assigned to the tracker in frame T+1, the whole process can proceed to a subsequent video frame after the next frame.

In some examples, the object classification can be performed in a processing thread and the conventional video analytics (blob detection and object tracking) can run simultaneously on a different processing thread. In such examples, a more complex neural network based object classification can be used, and can finish relatively quickly. For example, after 10 frames, the class or type derived by a neural network inference can still be associated with the object once the inference finishes.

In some cases, in order to reduce the number of memory fetches from the high resolution picture, the maximum number of classifications to be handled per frame can be limited to a certain number (e.g., 1, 2, or other suitable amount).

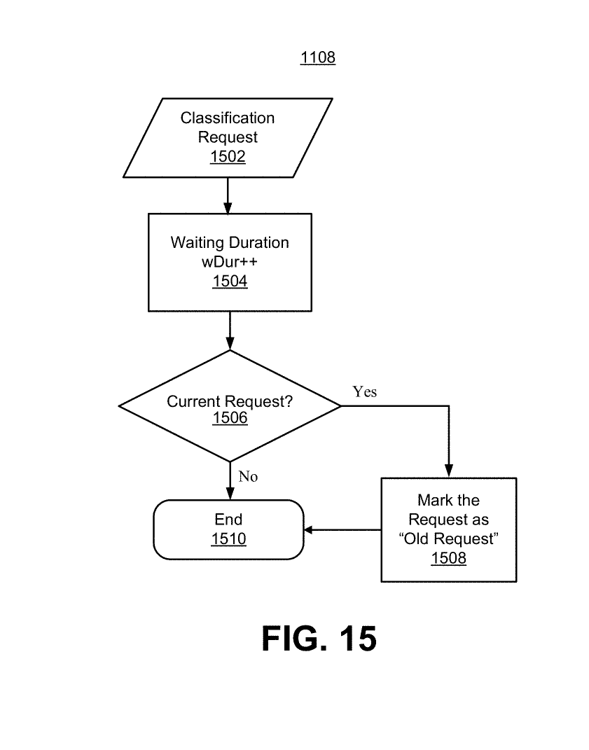

In some instances, there are cases when one or more selected classification requests are no longer valid, in which case the one or more selected classification requests may be filtered or rejected. When a classification request is rejected, it can be updated by an update request process, which is described in more detail below with respect to FIG. 15. Two illustrative examples of rejection mechanisms that can be used to filter out invalid classification requests can include a size based rejection and a pending time based rejection.

The size rejection can be based on a spatial relationship between the bounding box (from the current frame) of the tracker associated with the selected classification request and the fixed-size neural network bounding box input (based on the pre-processing discussed above). For example, for a bounding box of a current selected classification request, if the maximum between the width and height of the bounding box is smaller than the width or height of the neural network input bounding box, the bounding box of the current selected classification request is rejected. In some cases, the fixed-size input bounding box can be a square shape, in which case the width and height of the fixed-size bounding box are equal. In another example, if the minimum between the width and height of the bounding box of the current selected classification request is smaller than half of the width of the neural network input bounding box, the bounding box of the current selected classification request is rejected.

The pending time rejection can be based on the waiting duration (wDur) of a selected classification request. For example, if the waiting duration (wDur) of a current selected classification request is larger than a threshold waiting duration (denoted as TWDur), the current selected classification request is rejected. The threshold waiting duration (TWDur) can be set to any suitable value, such as 8 frames, 9 frames, 10 frames, 11 frames, an amount of time, or other suitable value. In one illustrative example, TWDur may be set to 10 frames. In such an example, a current selected classification request can be rejected if its waiting duration value (wDur) is greater than 10 frames. For instance, a classification request can be rejected when it has been at least 10 frames since the request was generated.

Returning to FIG. 11, the process 1010 determines, at block 1104, whether the current selected classification request should be rejected based on the size based rejection or the pending time based rejection. If the selected classification request is to be rejected, the process performs the update request process at block 1108. However, if the selected classification request is not to be rejected, the process performs the object classification process at block 1106. For example, as described above, the object classification process is applied for the blob being tracked by the tracker associated with the selected classification request. The classifier engine 806 can perform blob classification on a ROI defined by the bounding box of the tracker (e.g., the updated current bounding box of the tracker in the current frame).

At block 1110, the process 1010 outputs the classification results. For example, the classification results can be output so that it can be determined whether an affirmative result is generated, as described above with respect to block 1012 of process 1000.

As noted above, when a classification request is rejected, it can be updated by an update request process at block 1108. FIG. 15 is a flowchart illustrating an example of the update request process performed at block 1108 of FIG. 11. The update request process 1108 can obtain the selected classification request 1502. At block 1504, the update request process 1108 can increase the waiting duration (wDur) of the tracker associated with the selected classification request. For example, the waiting duration (wDur) of the tracker can be incremented by 1.

At block 1506, the process 1108 can determine if the selected classification request is a current request. If the selected classification request is determined to be a current request (in which case the request was generated in the current frame), the selected classification request can be marked as an “old request” at block 1508 after the waiting duration (wDur) is incremented. After the classification request is marked as an old request, the process 1108 ends at block 1510. If the selected classification request is not a current request (it is already an old request), the process 1108 ends at block 1510.

Returning to FIG. 8, the object class update engine 808 can, in some cases, update or change the class type of the current tracker after classification has been invoked for the current tracker based on the tracker's classification request being selected. The object class update engine 808 can update the classification results based on characteristics of the classification results, which can include a confidence level (denoted as C) and a class type (denoted as T). A tracker's (and its blob's) confidence level and class type together can be denoted as (C, T). Instead of applying just one simple threshold to determine whether the type T should apply or not apply for the current tracker, multiple confidence intervals (within 0 and 1) can be used. Based on which interval the confidence level C of the current tracker belongs to, the object class update engine 808 can optionally assign the class type T to the current tracker.

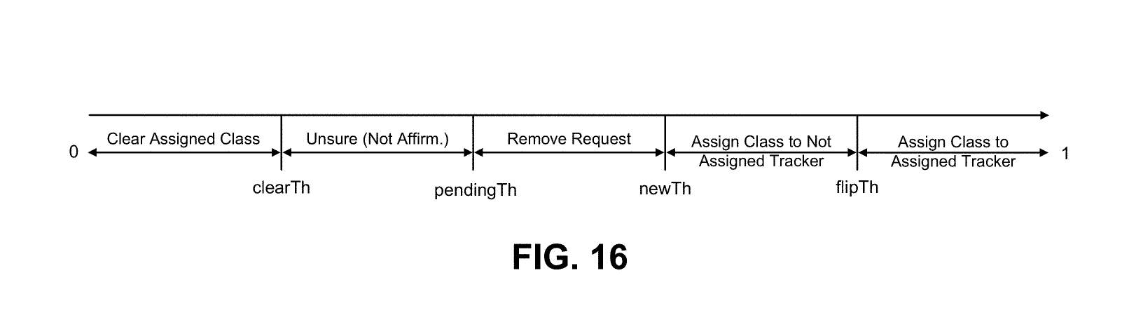

In some cases, when there are M multiple classes, the theoretical minimum boundary of the confidence level C can be set to be 1/M because, in some classification neural networks (e.g., Cifar-10 neural network or other suitable classification network) one probability can be determined for each class, with the probabilities of all of the M classes adding up to one, and the confidence level C can be set to be the maximum probability. For example, if there are three pre-defined classes (e.g., person, car, others/unknown, or other suitable classes), the theoretical minimum boundary of the confidence level C can be set to ⅓, since one probability of each class is assigned and the probabilities of the three classes add up to be 1, and C was set to be the one with the maximum probability. In such cases, the number of intervals can be more than two, with one gray area type of interval requiring a pending classification request for this object without assigning a class type. In some examples, there might be even more confidence intervals, as shown in the example of FIG. 16, which is described below.

FIG. 16 is a diagram illustrating an illustrative example of multiple confidence intervals that can be used by the object class update engine 808 when determining whether to update the class type of a current tracker. A first interval from 0 to a clear threshold (clearTh) can cause the object class update engine 808 to erase any given class type (thus the class type of the blob/object should be unknown). The first interval can be denoted as (0 clearTh]. For example, if the tracker that has just been classified has a confidence level C that is between 0 and the clear threshold (clearTh), the given class type T of the tracker determined by the classifier engine 806 can be cleared, and the class type associated with the tracker (corresponding to the blob or object being tracked) can be set to unknown.

A second interval from clear threshold (clearTh) to a pending threshold (pendingTh) can cause the classification request to be processed again (such that classification of the corresponding tracker is performed) in a relatively short time period (e.g., at a future frame based on the waiting duration wDur of the classification request), without making any decision in the current frame according to the current class type T. For example, the classification system 716 can determine when the classification request will be processed again based on a threshold wDur (e.g., TWDur). The threshold waiting duration (TWDur) can be set to any suitable value (e.g., 6, 7, 8, 9, 10, 12, or other suitable value). In one illustrative example, if wDur<10 for a classification request, classification will not be applied for the classification request. However, once the classification request is selected, and wDur>=10, the classification can be applied to the blob being tracked by the tracker that is associated with the chosen classification request. The second interval can be denoted as (clearTh pendingTh]. For example, if the tracker that has just been classified has a confidence level C that is between the clear threshold (clearTh) and the pending threshold (pendingTh), the selected classification request can be kept in the object classification list and can be processed again at a future frame. For example, the update request process (described with respect to FIG. 15) can be applied to the classification request to update the waiting duration (wDur) of the classification request. The class type is also not determined (the system is unsure, and thus an affirmative decision is not made) when the confidence level falls within the second interval.

A third interval from the pending threshold (pendingTh) to a new threshold (newTh) can cause the object class update engine 808 to remove the request from the object classification list. The third interval can be denoted as (pendingTh newTh]. For example, if the tracker that has just been classified has a confidence level C that is between the pending threshold (pendingTh) and the new threshold (newTh), the classification request can be removed from the object classification list.

A fourth interval from the new threshold (newTh) to a flip threshold (flipTh) can cause the object class update engine 808 to assign the tracker with a class type T only if the tracker has not previously been assigned a class. The term “flip” refers to when an object's class is flipped from one class to another (e.g., when an object is flipped from a person to a car, or flipped from a car to a person). The fourth interval can be denoted as (newTh flipTh]. For example, if the tracker that has just been classified has a confidence level C that is between the new threshold (newTh) and the flip threshold (flipTh), the tracker associated with the classification request can be assigned the class type of T if it has not been assigned before.

A fifth and last interval from the flip threshold (flipTh) to 1 can cause the object class update engine 808 to assign the tracker with a class type T without any condition. The fifth interval can be denoted as (flipth 1]. For example, if the tracker that has just been classified has a confidence level C that is between the flip threshold (flipTh) and 1, the tracker associated with the classification request can be assigned the class type T regardless of whether the tracker has been previously assigned to a class.

FIG. 17 is a flowchart illustrating an example of a process 1700 that can be performed by the object class update engine 808. The pending time is the waiting duration (wDur) and the pending time threshold M may be set to a value of 10 or other suitable value. The process 1700 can begin by the object class update engine 808 obtaining the classification results and the tracker 1702 associated with the selected classification request. The classification results include the confidence level C and the class type T. At block 1704, the process 1700 determines whether the confidence level C is less than the clear threshold (clearTh) (and thus within the first interval described above). If the confidence level C is less than the clear threshold (clearTh), the process 1700 clears the class assigned to the tracker (and the blob or object it is tracking) at block 1716, and provides an “affirmative” result at block 1718. As noted above with respect to block 1012 of FIG. 10, an affirmative result can cause the process 1000 to remove a classification request from the object classification list. However, when the confidence level C is less than the clear threshold (clearTh) (as determined at block 1704), the selected classification request is not removed, but rather is set to be pending in the list of classification requests. As described below, the process 1700 proceeds to block 1732 to determine whether to perform the update request process at block 1734.

If the confidence level C is not less than the clear threshold (clearTh), the process 1700 determines, at block 1706, whether the confidence level C is less than the pending threshold (pending Th) (and thus within the second interval described above). If the confidence level C is less than the pending threshold (pendingTh), but greater than the clear threshold (clearTh), the process 1700 determines at block 1720 that the result is unsure and provides a “not affirmative” result. As noted above with respect to block 1012 of FIG. 10, a “not affirmative” result can cause the process 1000 to maintain the classification request in the object classification list.

If the confidence level C is not less than the pending threshold (pendingTh), or is determined to be greater than the pending threshold, the process 1700 determines, at block 1708, whether the tracker class has or has not been assigned before and whether the confidence level C is greater than the new threshold (new Th) (and thus within the fourth interval described above). If the confidence level C is greater than the new threshold (newTh), and the tracker has not previously been assigned a class type, the process 1700 assigns the class T (the class determined by the classification process) to the tracker at block 1722. The process 1700 can then determine an “affirmative” result at block 1724, and can end at block 1726. Based on the affirmative result, the classification request can be removed from the object classification list.

If the confidence level C is not greater than the new threshold (newTh) (or is determined to be less than the new threshold), or the tracker has already been assigned a class, the process 1700 determines, at block 1710, whether the confidence level C is greater than the flip threshold (flipTh) (and thus within the fifth interval described above). If the confidence level C is greater than the flip threshold (flipTh), the process 1700 assigns the class T to the tracker at block 1728 regardless of whether the tracker has previously been assigned a class type. The process 1700 can then determine whether a class type for the tracker is unknown at block 1730. For example, a tracker can be initialized with a class type of “unknown”, and if the tracker is not assigned, it will remain an “unknown” tracker. If the class type is not unknown, the process 1700 generates an “affirmative” result at block 1724, and can end at block 1726. Based on the affirmative result, the classification request can be removed from the object classification list.

If the process 1700 determines that the class type for the object is unknown at block 1730, or if an affirmative decision is determined at block 1718, or if an unsure decision is determined at block 1720, the process 1700 proceeds to step 1732 to determine whether the pending time (equal to the waiting duration wdur) is less than the pending time threshold M. If the pending time (wDur) is less than the pending time threshold M, the process 1700 performs the update request process (e.g., the update request process 1108) at block 1734. However, if the pending time (wDur) is not less than the pending time threshold M (or if it is determined that the pending time is greater than the pending time threshold M), the process 1700 ends at block 1736. For example, if the pending time (wDur) is too long (e.g., wDur>M), the request is removed from the classification list and the process 1700 ends. In some cases, the pending time threshold can be equal to the threshold waiting duration (TWDur).

If the process 1700 determines, at block 1710, that the confidence level C is not greater than the flip threshold (flipTh), the process generates an “affirmative” result at block 1712, and can end at block 1714. Based on the affirmative result, the classification request can be removed from the object classification list.

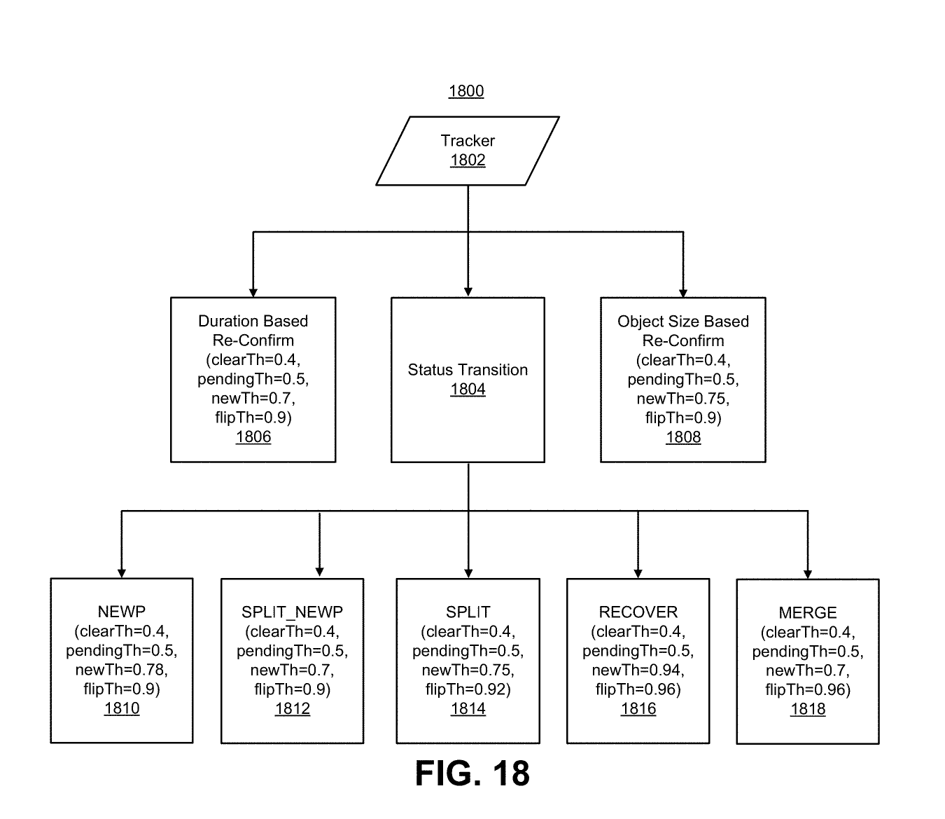

In addition to having multiple confidence intervals, the way in which the confidence intervals are separated may be set differently for different invocation conditions shown in FIG. 9. For example, there can be different sets of thresholds for different state transitions and for different re-confirmation conditions (duration based and object size based). One illustrative example is shown by the process 1800 illustrated in the flowchart of FIG. 18. The process 1800 can be performed to adaptively set the confidence thresholds for different confidence intervals based on the different invocation conditions. The tracker 1802 associated with the selected classification request is first obtained. The confidence level settings may then be applied based on the invocation condition that is detected, such as a status transition 1804, a duration based re-confirmation 1806, or a size based re-confirmation 1808. For example, the most common setting (with clearTh=0.4, pendingTh=0.5, newTh=0.7, and flipTh=0.9) can be given to the duration based re-confirmation 1806 so that it is relatively less sensitive. The SPLIT NEWP status transition 1812 can be given the same setting as the duration based re-confirmation 1806 (with clearTh=0.4, pendingTh=0.5, newTh=0.7, and flipTh=0.9).

For other cases, different sensitivities (due to different interval settings) are provided, so that some challenging situations will require higher confidence levels (C) to have the class type T applied. For example, the newTh and the flipTh can be made higher in some cases. The object size based re-confirmation 1808 and the NEWP status transition 1810 can be given similar settings as the duration based re-confirmation 1806, but with a higher newTh, thus increasing the confidence level C required to have the class type T applied to the tracker. For example, the setting for the object size based re-confirmation 1808 can be set to clearTh=0.4, pendingTh=0.5, newTh=0.75, and flipTh=0.9. The setting for the NEWP status transition 1810 can be set to clearTh=0.4, pendingTh=0.5, newTh=0.78, and flipTh=0.9. The SPLIT status transition 1814 can also be given a similar setting as the duration based re-confirmation 1806, but with a higher newTh and a higher flipTh. For example, the setting for the SPLIT status transition 1814 can be set to clearTh=0.4, pendingTh=0.5, newTh=0.75, and flipTh=0.92.

For even more challenging cases, the newTh and the flipTh can be made even higher in some cases. Such challenging cases include the RECOVER status transition 1816 and the MERGE status transition 1818, in which case the newTh and the flipTh can be made higher. For example, the setting for the RECOVER status transition 1816 can be set to clearTh=0.4, pendingTh=0.5, newTh=0.94, and flipTh=0.96. Accordingly, in such an example, the threshold for applying the class type T to the tracker is quite high (requiring a confidence level C of at least 0.94. The setting for the MERGE status transition 1818 can be set to clearTh=0.4, pendingTh=0.5, newTh=0.7, and flipTh=0.96.

As previously described, various neural network-based detectors can be used by the classification system 716. Illustrative examples of neural networks that can be used include a convolutional neural network (CNN), an autoencoder, a deep belief net (DBN), a Recurrent Neural Networks (RNN), or any other suitable neural network.

FIG. 19 is an illustrative example of a deep learning neural network 1900 that can be used by the classification system 716. An input layer 1920 includes input data. In one illustrative example, the input layer 1920 can include data representing the pixels of an input video frame. The neural network 1900 includes multiple hidden layers 1922a, 1922b, through 1922n. The hidden layers 1922a, 1922b, through 1922n include “n” number of hidden layers, where “n” is an integer greater than or equal to one. The number of hidden layers can be made to include as many layers as needed for the given application. The neural network 1900 further includes an output layer 1924 that provides an output resulting from the processing performed by the hidden layers 1922a, 1922b, through 1922n. In one illustrative example, the output layer 1924 can provide a classification for an object in an input video frame. The classification can include a class identifying the type of object (e.g., a person, a dog, a cat, or other object).

The neural network 1900 is a multi-layer neural network of interconnected nodes. Each node can represent a piece of information. Information associated with the nodes is shared among the different layers and each layer retains information as information is processed. In some cases, the neural network 1900 can include a feed-forward network, in which case there are no feedback connections where outputs of the network are fed back into itself. In some cases, the neural network 1900 can include a recurrent neural network, which can have loops that allow information to be carried across nodes while reading in input.

Information can be exchanged between nodes through node-to-node interconnections between the various layers. Nodes of the input layer 1920 can activate a set of nodes in the first hidden layer 1922a. For example, as shown, each of the input nodes of the input layer 1920 is connected to each of the nodes of the first hidden layer 1922a. The nodes of the hidden layer 1922 can transform the information of each input node by applying activation functions to the input node information. The information derived from the transformation can then be passed to and can activate the nodes of the next hidden layer 1922b, which can perform their own designated functions. Example functions include convolutional, up-sampling, data transformation, and/or any other suitable functions. The output of the hidden layer 1922b can then activate nodes of the next hidden layer, and so on. The output of the last hidden layer 1922n can activate one or more nodes of the output layer 1924, at which an output is provided. In some cases, while nodes (e.g., node 1926) in the neural network 1900 are shown as having multiple output lines, a node has a single output and all lines shown as being output from a node represent the same output value.

In some cases, each node or interconnection between nodes can have a weight that is a set of parameters derived from the training of the neural network 1900. Once the neural network 1900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1900 to be adaptive to inputs and able to learn as more and more data is processed.

The neural network 1900 is pre-trained to process the features from the data in the input layer 1920 using the different hidden layers 1922a, 1922b, through 1922n in order to provide the output through the output layer 1924. In an example in which the neural network 1900 is used to identify objects in images, the neural network 1900 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 1900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1900 is trained well enough so that the weights of the layers are accurately tuned.

For the example of identifying objects in images, the forward pass can include passing a training image through the neural network 1900. The weights are initially randomized before the neural network 1900 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 1900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as Σₜₒₜₐₗ=Σ½(target−output)², which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1900 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 1900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1900 can include any other deep network other than a CNN, such as an autoencoder, a deep belief nets (DBNs), a Recurrent Neural Networks (RNNs), among others.

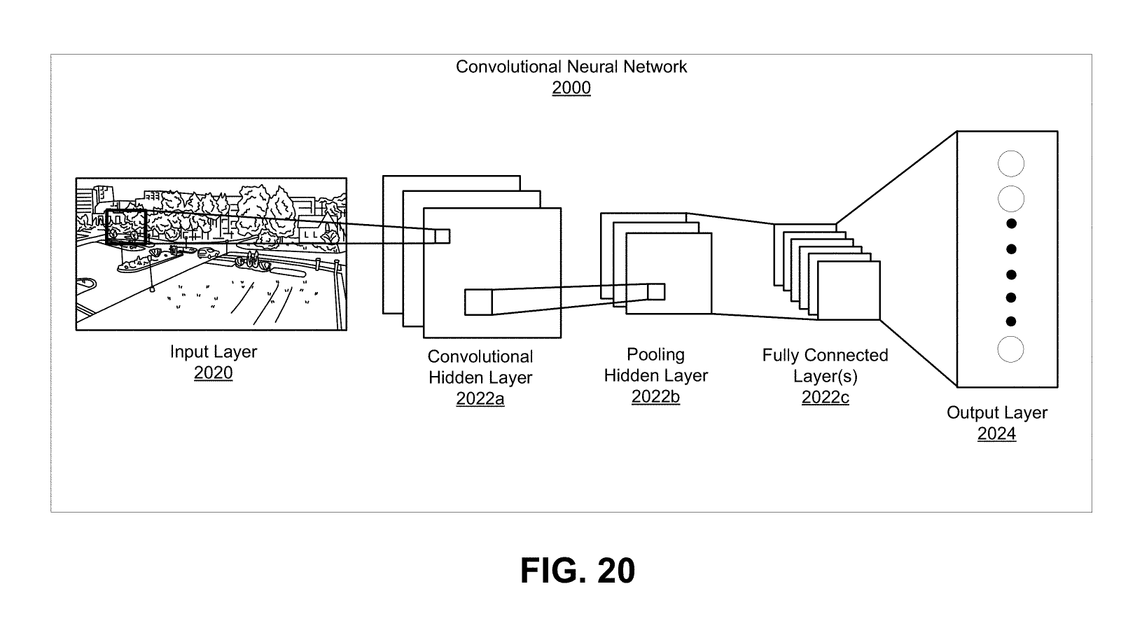

FIG. 20 is an illustrative example of a convolutional neural network 2000 (CNN 2000). The input layer 2020 of the CNN 2000 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 2022a, an optional non-linear activation layer, a pooling hidden layer 2022b, and fully connected hidden layers 2022c to get an output at the output layer 2024. While only one of each hidden layer is shown in FIG. 20, one of ordinary skill will appreciate that multiple convolutional hidden layers, non-linear layers, pooling hidden layers, and/or fully connected layers can be included in the CNN 2000. As previously described, the output can indicate a single class of an object or can include a probability of classes that best describe the object in the image.

The first layer of the CNN 2000 is the convolutional hidden layer 2022a. The convolutional hidden layer 2022a analyzes the image data of the input layer 2020. Each node of the convolutional hidden layer 2022a is connected to a region of nodes (pixels) of the input image called a receptive field. The convolutional hidden layer 2022a can be considered as one or more filters (each filter corresponding to a different activation or feature map), with each convolutional iteration of a filter being a node or neuron of the convolutional hidden layer 2022a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 2022a. Each connection between a node and a receptive field for that node learns a weight and, in some cases, an overall bias such that each node learns to analyze its particular local receptive field in the input image. Each node of the hidden layer 2022a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 2022a is due to each node of the convolutional layer being applied to its corresponding receptive field. For example, a filter of the convolutional hidden layer 2022a can begin in the top-left corner of the input image array and can convolve around the input image. As noted above, each convolutional iteration of the filter can be considered a node or neuron of the convolutional hidden layer 2022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 2022a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 2022a.

The mapping from the input layer to the convolutional hidden layer 2022a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 2022a can include several activation maps in order to identify multiple features in an image. The example shown in FIG. 20 includes three activation maps. Using three activation maps, the convolutional hidden layer 2022a can detect three different kinds of features, with each feature being detectable across the entire image.

In some examples, a non-linear hidden layer can be applied after the convolutional hidden layer 2022a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the network 2000 without affecting the receptive fields of the convolutional hidden layer 2022a.

The pooling hidden layer 2022b can be applied after the convolutional hidden layer 2022a (and after the non-linear hidden layer when used). The pooling hidden layer 2022b is used to simplify the information in the output from the convolutional hidden layer 2022a. For example, the pooling hidden layer 2022b can take each activation map output from the convolutional hidden layer 2022a and generates a condensed activation map (or feature map) using a pooling function. Max-pooling is one example of a function performed by a pooling hidden layer. Other forms of pooling functions be used by the pooling hidden layer 2022a, such as average pooling, L2-norm pooling, or other suitable pooling functions. A pooling function (e.g., a max-pooling filter, an L2-norm filter, or other suitable pooling filter) is applied to each activation map included in the convolutional hidden layer 2022a. In the example shown in FIG. 20, three pooling filters are used for the three activation maps in the convolutional hidden layer 2022a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 2022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 2022a having a dimension of 24×24 nodes, the output from the pooling hidden layer 2022b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 2000.

The final layer of connections in the network is a fully-connected layer that connects every node from the pooling hidden layer 2022b to every one of the output nodes in the output layer 2024. Using the example above, the input layer includes 28×28 nodes encoding the pixel intensities of the input image, the convolutional hidden layer 2022a includes 3×24×24 hidden feature nodes based on application of a 5×5 local receptive field (for the filters) to three activation maps, and the pooling hidden layer 2022b includes a layer of 3×12×12 hidden feature nodes based on application of max-pooling filter to 2×2 regions across each of the three feature maps. Extending this example, the output layer 2024 can include ten output nodes. In such an example, every node of the 3×12×12 pooling hidden layer 2022b is connected to every node of the output layer 2024.

The fully connected layer 2022c can obtain the output of the previous pooling hidden layer 2022b (which should represent the activation maps of high-level features) and determines the features that most correlate to a particular class. For example, the fully connected layer 2022c layer can determine the high-level features that most strongly correlate to a particular class, and can include weights (nodes) for the high-level features. A product can be computed between the weights of the fully connected layer 2022c and the pooling hidden layer 2022b to obtain probabilities for the different classes. For example, if the CNN 2000 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 2024 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

The classification system 716 can use any suitable neural network based detector. One example includes a Cifar-10 neural network based detector. FIG. 21 is a diagram illustrating an example of the Cifar-10 neural network 2100. In some cases, the Cifar-10 neural network can be trained to classify persons and cars only. As shown, the Cifar-10 neural network 2100 includes various convolutional layers (Conv1 layer 2102, Conv2/Relu2 layer 2108, and Conv3/Relu3 layer 2114), numerous pooling layers (Pool1/Relu1 layer 2104, Pool2 layer 2110, and Pool3 layer 2116), and rectified linear unit layers mixed therein. Normalization layers Norm1 2106 and Norm2 2112 are also provided. A final layer is the ip1 layer 2118.

Another deep learning-based detector that can be used by the classification system 716 to detect or classify objects in images includes the SSD detector, which is a fast single-shot object detector that can be applied for multiple object categories or classes. The SSD model uses multi-scale convolutional bounding box outputs attached to multiple feature maps at the top of the neural network. Such a representation allows the SSD to efficiently model diverse box shapes. FIG. 22A includes an image and FIG. 22B and FIG. 22C include diagrams illustrating how an SSD detector (with the VGG deep network base model) operates. For example, SSD matches objects with default boxes of different aspect ratios (shown as dashed rectangles in FIG. 22B and FIG. 22C). Each element of the feature map has a number of default boxes associated with it. Any default box with an intersection-over-union with a ground truth box over a threshold (e.g., 0.4, 0.5, 0.6, or other suitable threshold) is considered a match for the object. For example, two of the 8×8 boxes (shown in blue in FIG. 22B) are matched with the cat, and one of the 4×4 boxes (shown in red in FIG. 22C) is matched with the dog. SSD has multiple features maps, with each feature map being responsible for a different scale of objects, allowing it to identify objects across a large range of scales. For example, the boxes in the 8×8 feature map of FIG. 22B are smaller than the boxes in the 4×4 feature map of FIG. 22C. In one illustrative example, an SSD detector can have six feature maps in total.

For each default box in each cell, the SSD neural network outputs a probability vector of length c, where c is the number of classes, representing the probabilities of the box containing an object of each class. In some cases, a background class is included that indicates that there is no object in the box. The SSD network also outputs (for each default box in each cell) an offset vector with four entries containing the predicted offsets required to make the default box match the underlying object's bounding box. The vectors are given in the format (cx, cy, w, h), with cx indicating the center x, cy indicating the center y, w indicating the width offsets, and h indicating height offsets. The vectors are only meaningful if there actually is an object contained in the default box. For the image shown in FIG. 22A, all probability labels would indicate the background class with the exception of the three matched boxes (two for the cat, one for the dog).

Another deep learning-based detector that can be used by the classification system 716 to detect or classify objects in images includes the You only look once (YOLO) detector, which is an alternative to the SSD object detection system. FIG. 23A includes an image and FIG. 23B and FIG. 23C include diagrams illustrating how the YOLO detector operates. The YOLO detector can apply a single neural network to a full image. As shown, the YOLO network divides the image into regions and predicts bounding boxes and probabilities for each region. These bounding boxes are weighted by the predicted probabilities. For example, as shown in FIG. 23A, the YOLO detector divides up the image into a grid of 13-by-13 cells. Each of the cells is responsible for predicting five bounding boxes. A confidence score is provided that indicates how certain it is that the predicted bounding box actually encloses an object. This score does not include a classification of the object that might be in the box, but indicates if the shape of the box is suitable. The predicted bounding boxes are shown in FIG. 23B. The boxes with higher confidence scores have thicker borders.

Each cell also predicts a class for each bounding box. For example, a probability distribution over all the possible classes is provided. Any number of classes can be detected, such as a bicycle, a dog, a cat, a person, a car, or other suitable object class. The confidence score for a bounding box and the class prediction are combined into a final score that indicates the probability that that bounding box contains a specific type of object. For example, the yellow box with thick borders on the left side of the image in FIG. 23B is 85% sure it contains the object class “dog.” There are 169 grid cells (13×13) and each cell predicts 5 bounding boxes, resulting in 2345 bounding boxes in total. Many of the bounding boxes will have very low scores, in which case only the boxes with a final score above a threshold (e.g., above a 30% probability, 40% probability, 50% probability, or other suitable threshold) are kept. FIG. 23C shows an image with the final predicted bounding boxes and classes, including a dog, a bicycle, and a car. As shown, from the 2345 total bounding boxes that were generated, only the three bounding boxes shown in FIG. 23C were kept because they had the best final scores.

Using the above-described object detection, tracking, and classification techniques, a video analytics system can seamlessly incorporate object classification without sacrificing accuracy and speed. The memory-efficient object classification techniques described above enable the feature of object classification in video analytics. The techniques described herein enable the object classification feature of in a video analytics system, and allows high performance to be deployed in a device with low power consumption (e.g., a mobile device, a camera device, a head-mounted display (HMD), a heads-up display (HUD), or other suitable device).

Subjective and objective results will now be described to demonstrate the high level performance of the video analytics system 700. Simulations were conducted on 53 video clips, where 34 VIRAT video clips are associated with a professional security scenario, and 19 video clips are associated with a home security scenario. Both scenarios range from easy to difficult video clips. In the following, both objective results and subjective results are provided to demonstrate the good performance by the video analytics system 700. The objective results are measured using the recall rate and false positive rate in “VAM” report, as shown in Table 1 below.

TABLE 1
Results for all video clips average measurement

| | Recall | False positive |
|---|---|---|
| Method | rate (%) | rate (%) |
| Anchor | 96.22 | 7.65 |
| Proposed | 97.55 | 6.80 |

The subject results of the above-referenced video clips are shown in FIG. 24-FIG. 38B, which include video frames illustrating several subjective examples showing results of the video analytics with classification techniques described herein.

FIG. 24 is a video frame of an environment with a person. As shown, a large single object associated with tracker 47 is detected as a person.

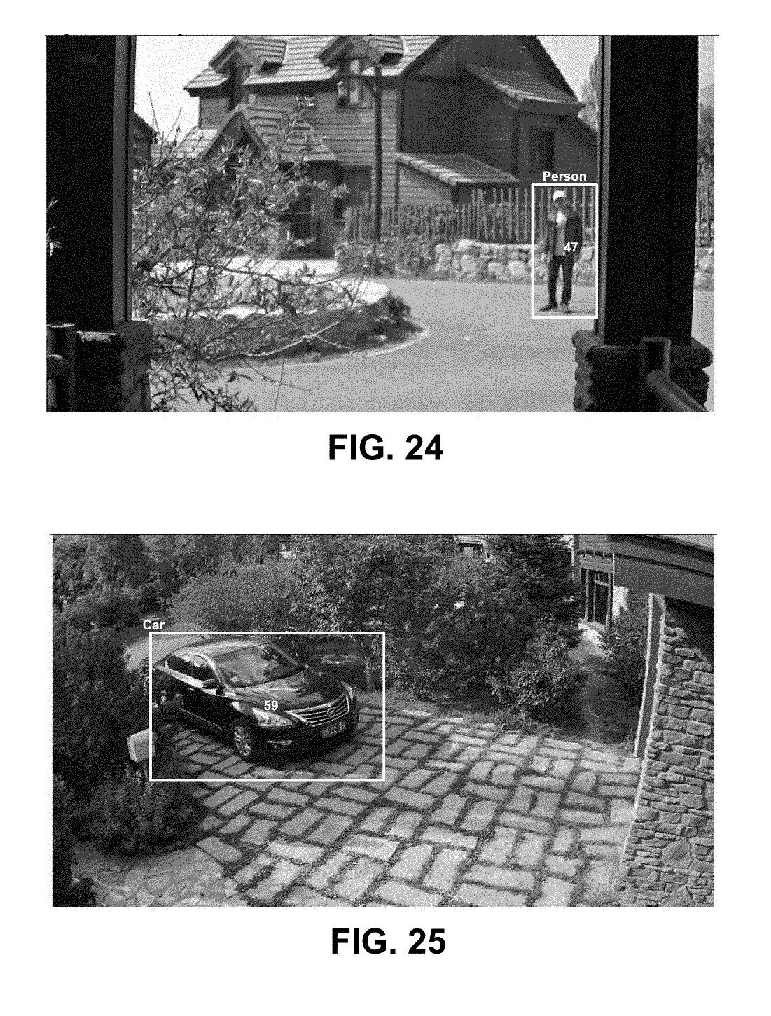

FIG. 25 is another video frame of an environment. As shown, a large single object associated with tracker 59 is detected as car.

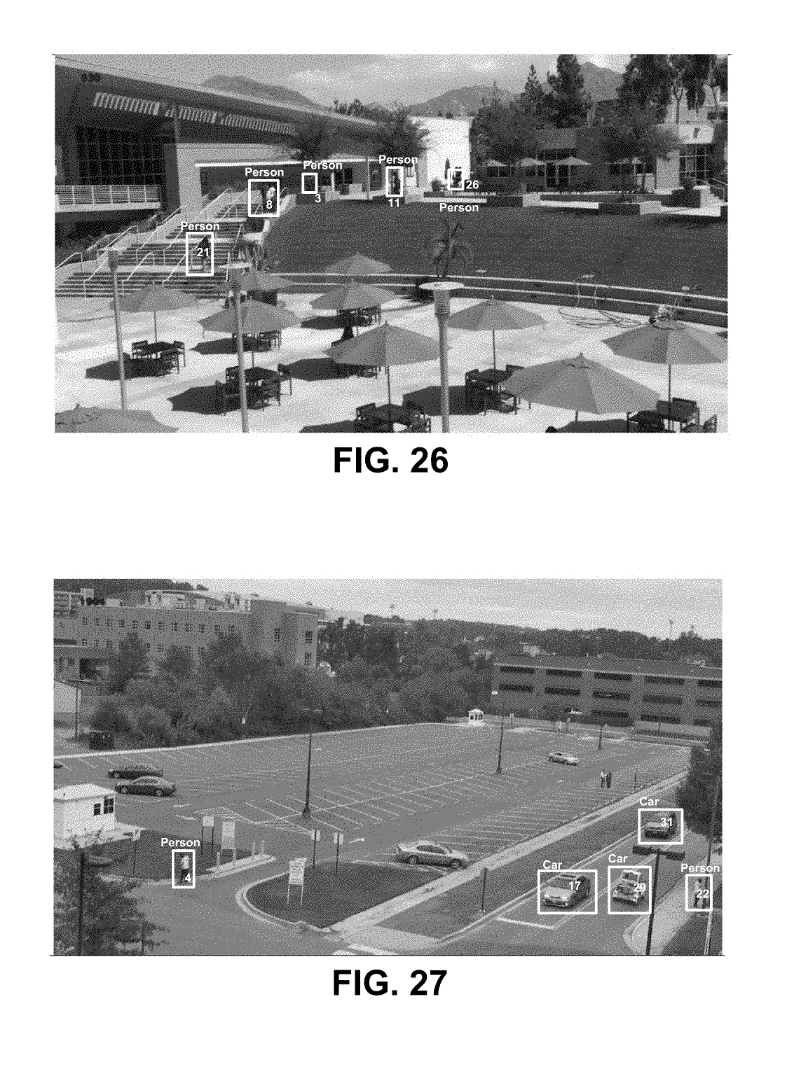

FIG. 26 is another video frame of an environment. As shown, a crowd of objects are detected as persons.

FIG. 27 is another video frame of an environment. As shown, a crowd of objects are detected as cars on the bottom right of the video frame.

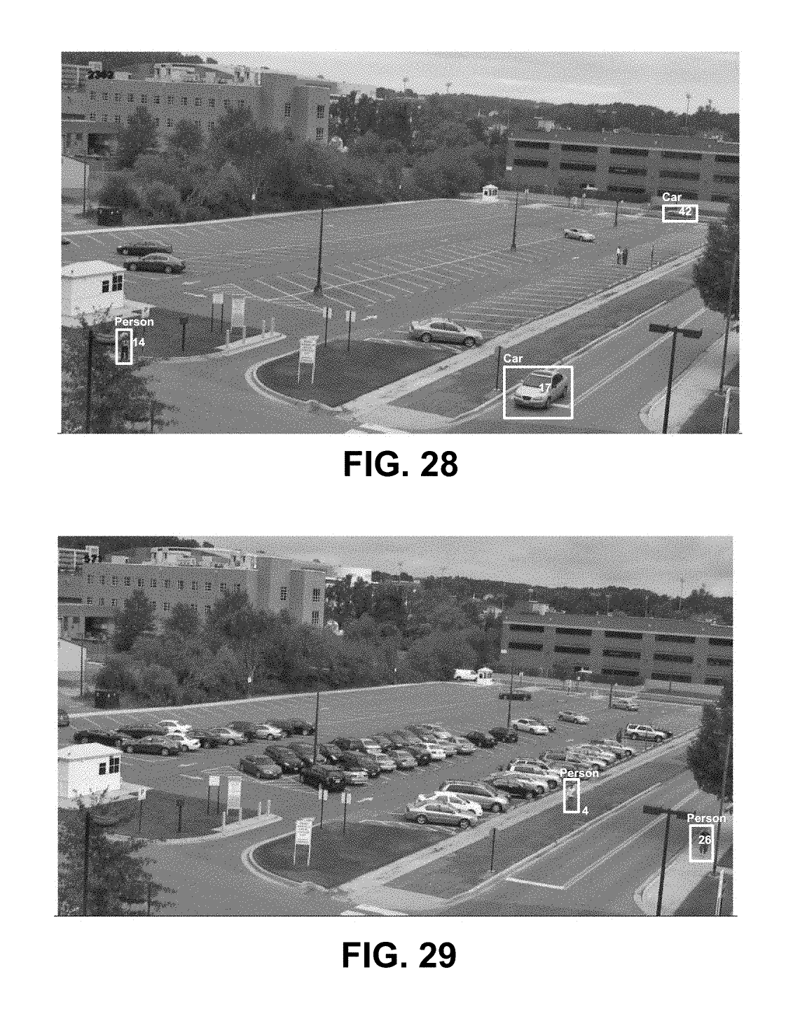

FIG. 28 is another video frame of an environment. As shown, a very small car at a far distance from the camera is detected.

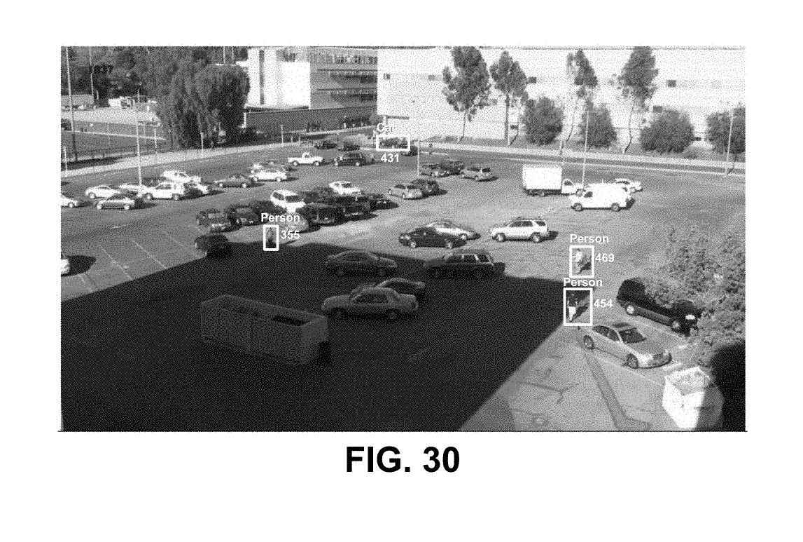

FIG. 29 is another video frame of an environment. As shown, two very small people are detected.

FIG. 30 is another video frame of an environment. As shown, very small people and cars are detected.

Other video frames are now shown to demonstrate the subjective classification results, where the images on the left side demonstrate results of the anchor method, and the images on the right side demonstrate the results of using the techniques desribed herein.

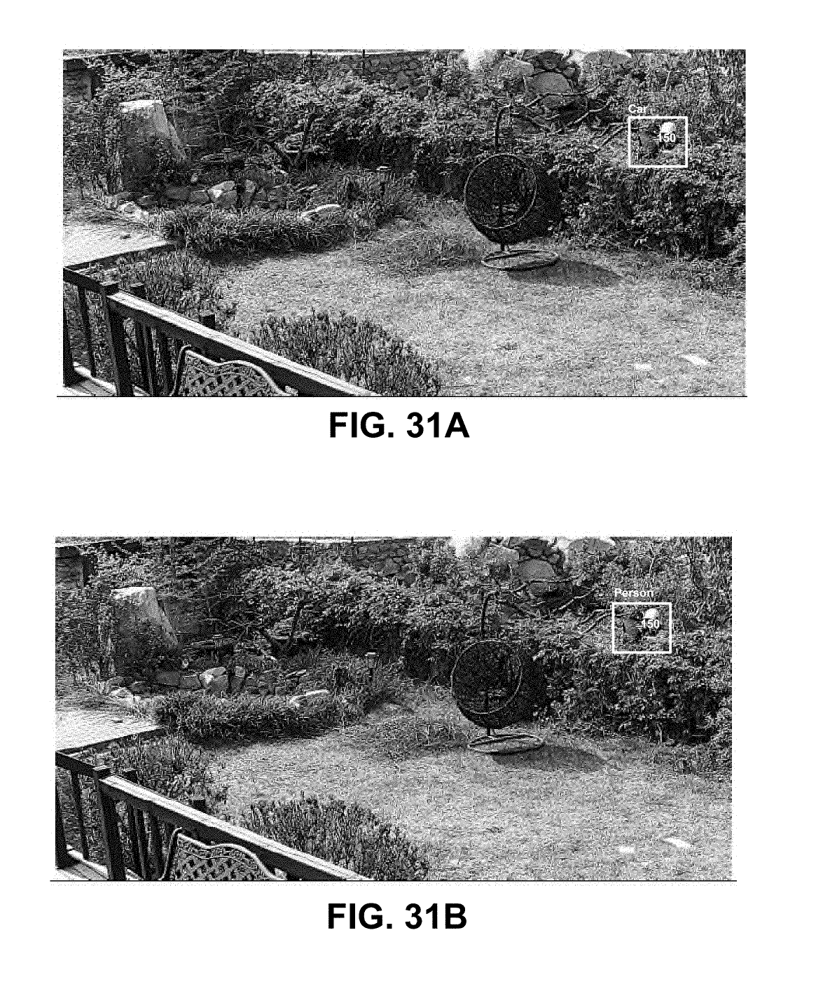

FIG. 31A and FIG. 31B are video frames of an environment. As shown, partial appeared tracker 150 was classified as a person using the techniques described herein (as shown in FIG. 31B), but was detected as car using the anchor method (as shown in FIG. 31A).

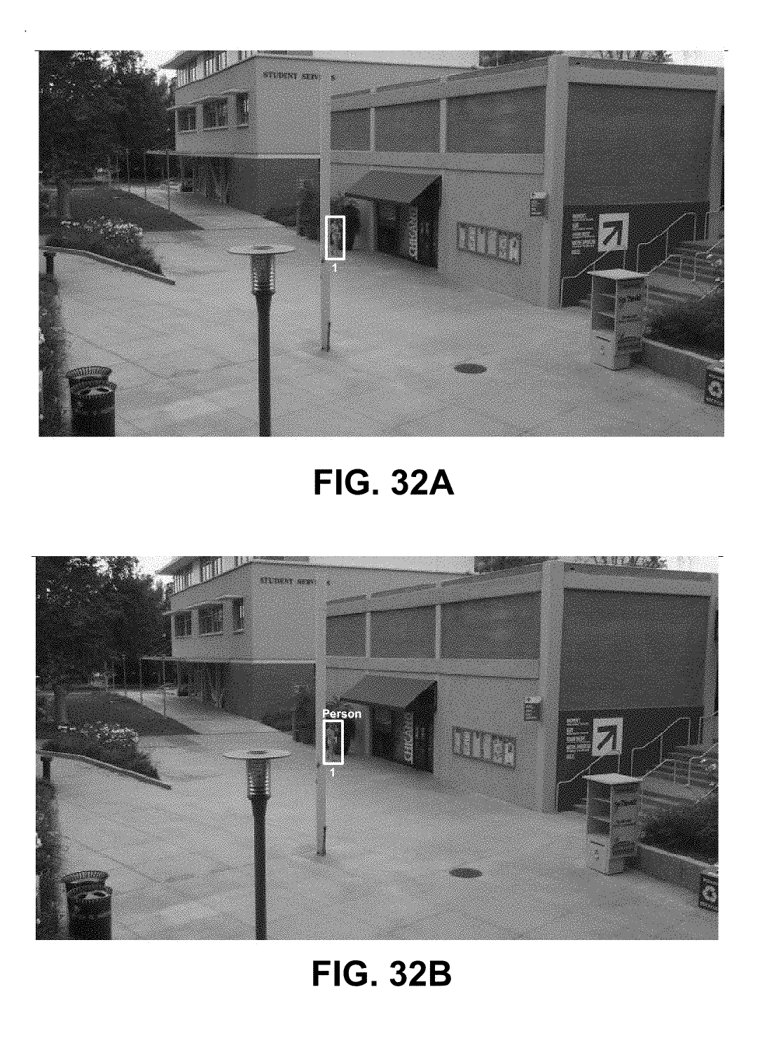

FIG. 32A and FIG. 32B are video frames of an environment. As shown, the tracker 1 was classified as person using the techniques described herein (as shown in FIG. 32B), but was not classified at all using the anchor method (as shown in FIG. 32A).

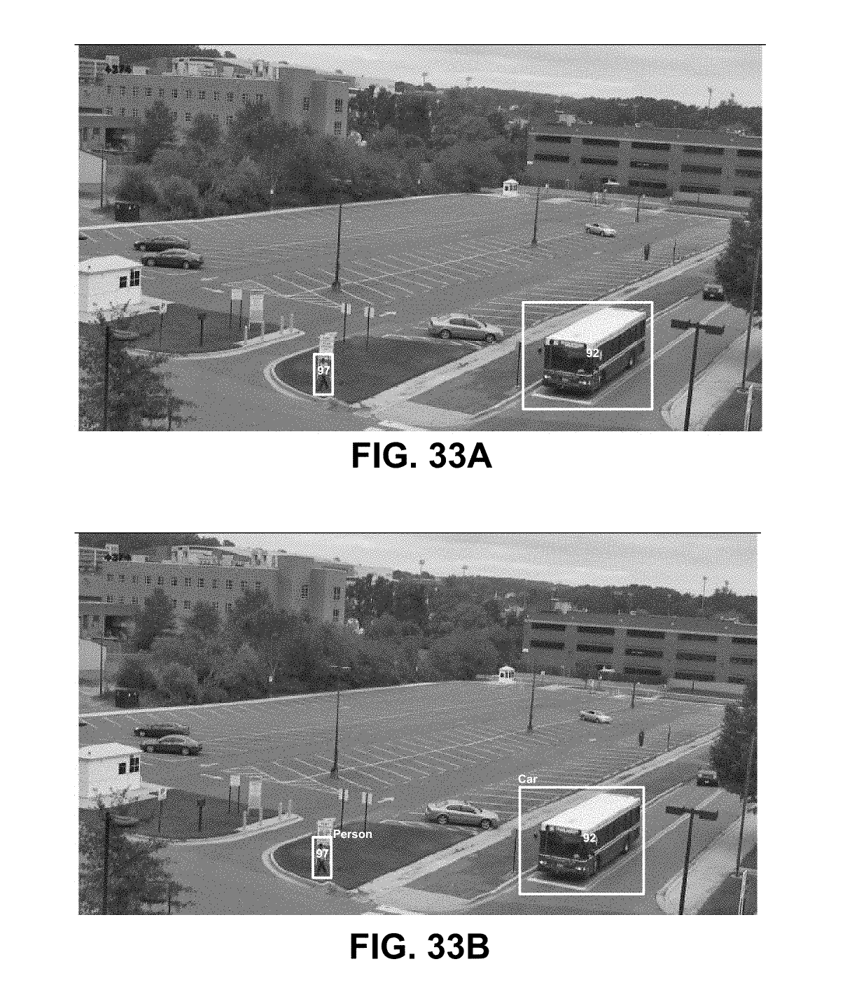

FIG. 33A and FIG. 33B are video frames of an environment. As shown, the tracker 92 with a noisy background was classified as car using the techniques described herein (as shown in FIG. 33B), but was not classified at all using the anchor method (as shown in FIG. 33A).

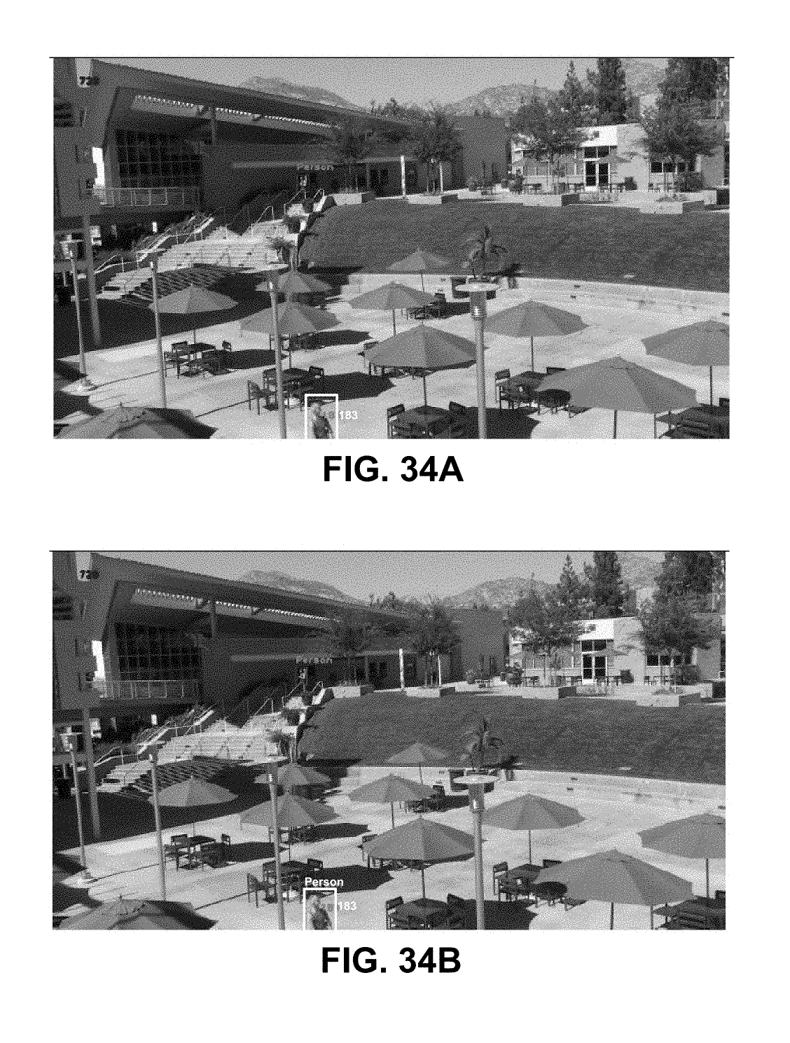

FIG. 34A and FIG. 34B are video frames of an environment. As shown, a partial appeared back side of the tracker 183 was classified as a person using the techniques described herein (as shown in FIG. 34B), but was detected as car using the anchor method (as shown in FIG. 34A).

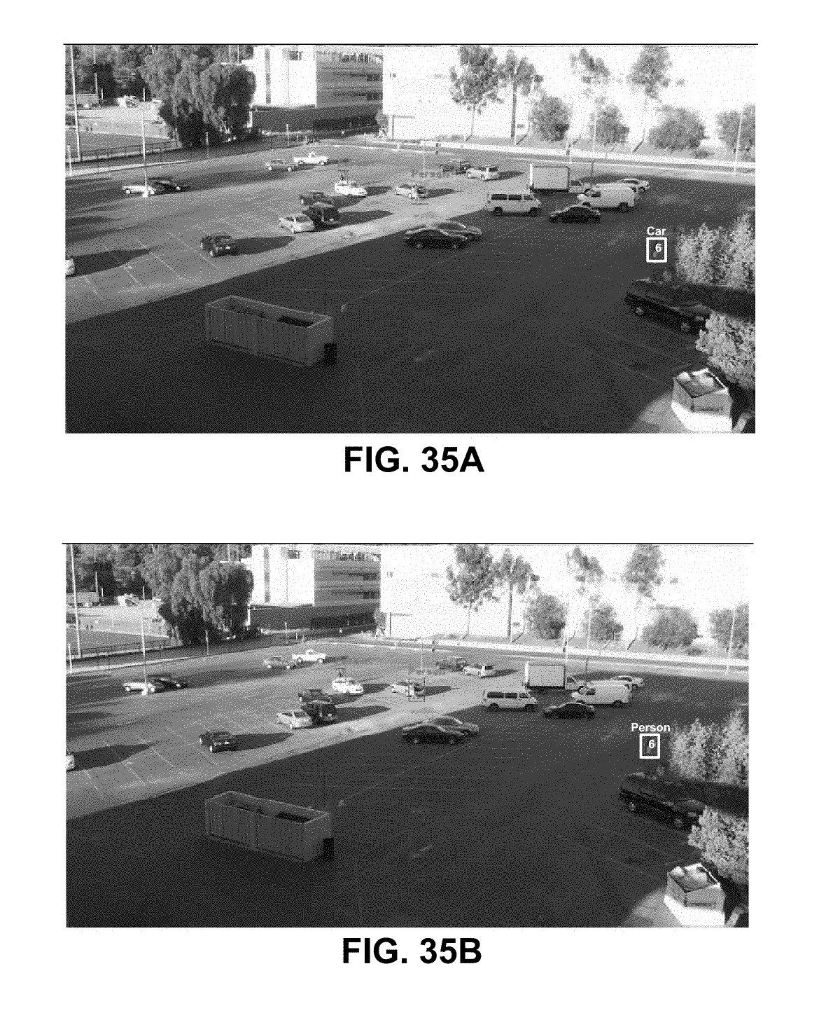

FIG. 35A and FIG. 35B are video frames of an environment. As shown, a small and dark tracker 6 was classified as a person using the techniques described herein (as shown in FIG. 35B), but was detected as car using the anchor method (as shown in FIG. 35A).

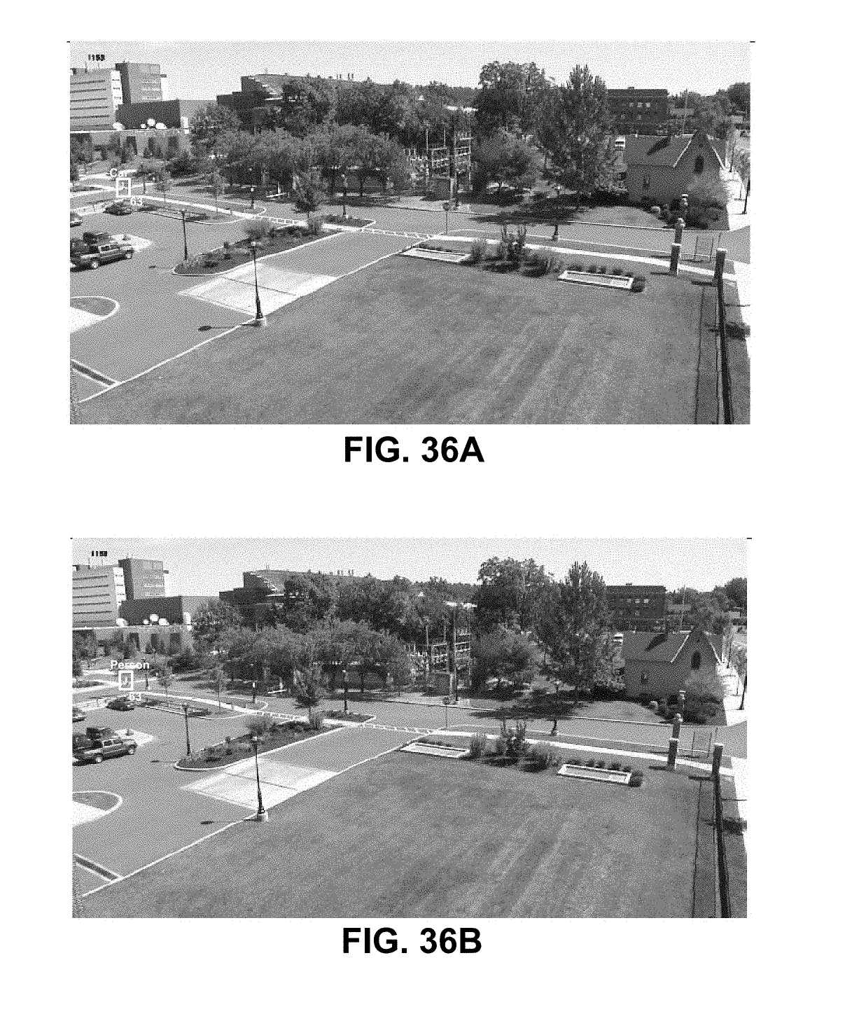

FIG. 36A and FIG. 36B are video frames of an environment. As shown, a small tracker 63 was classified as person using the techniques described herein (as shown in FIG. 36B), but was detected as car using the anchor method (as shown in FIG. 36A).

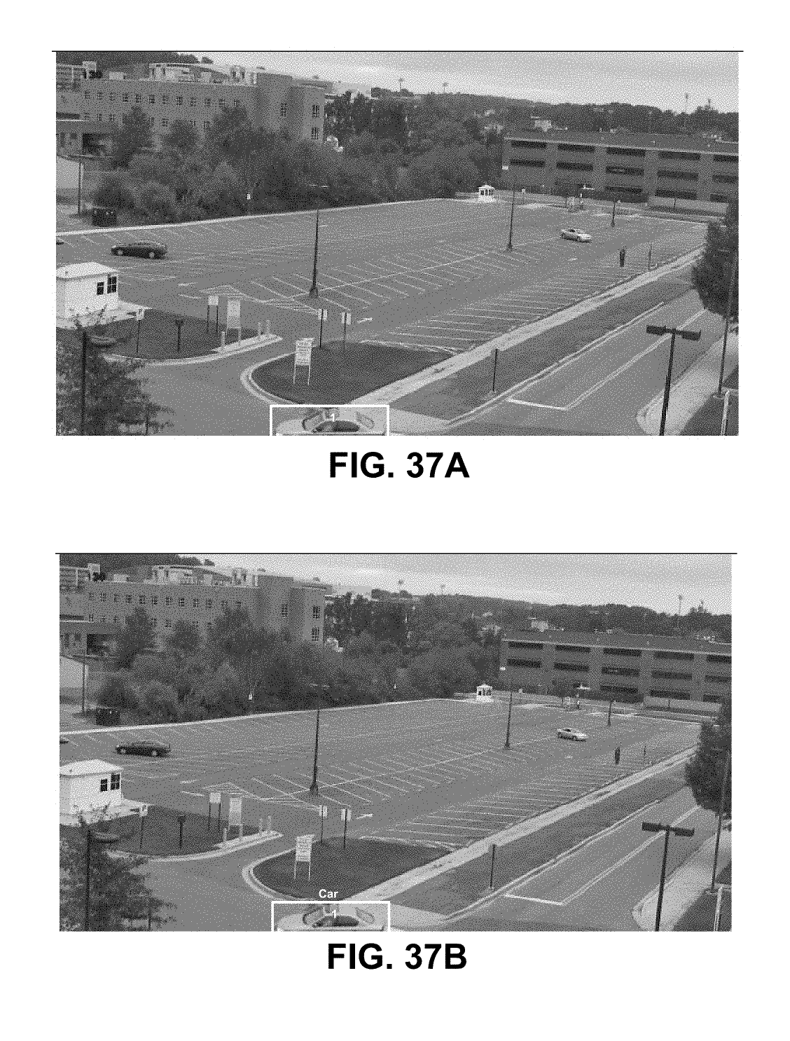

FIG. 37A and FIG. 37B are video frames of an environment. As shown, tracker 1 was classified as car using the techniques described herein (as shown in FIG. 37B), but was not classified at all using the anchor method (as shown in FIG. 37A).

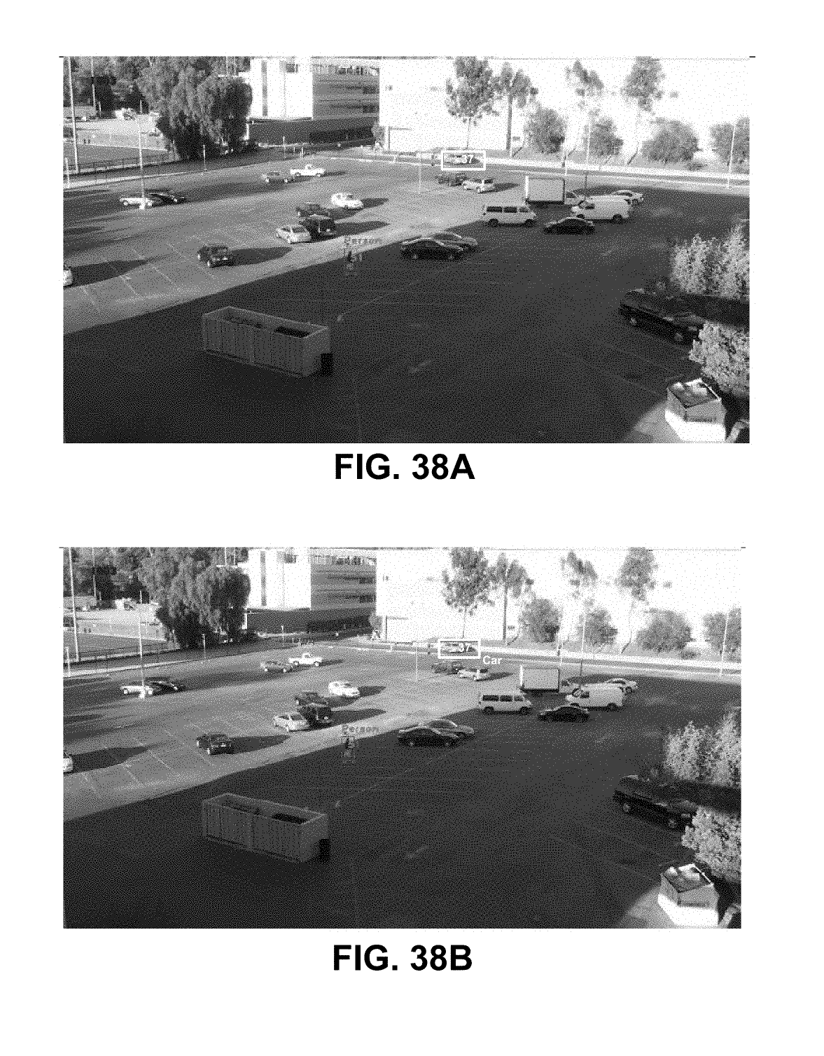

FIG. 38A and FIG. 38B are video frames of an environment. As shown, small tracker 37 was classified as car using the techniques described herein (as shown in FIG. 37B), but was not classified at all using the anchor method (as shown in FIG. 37A).

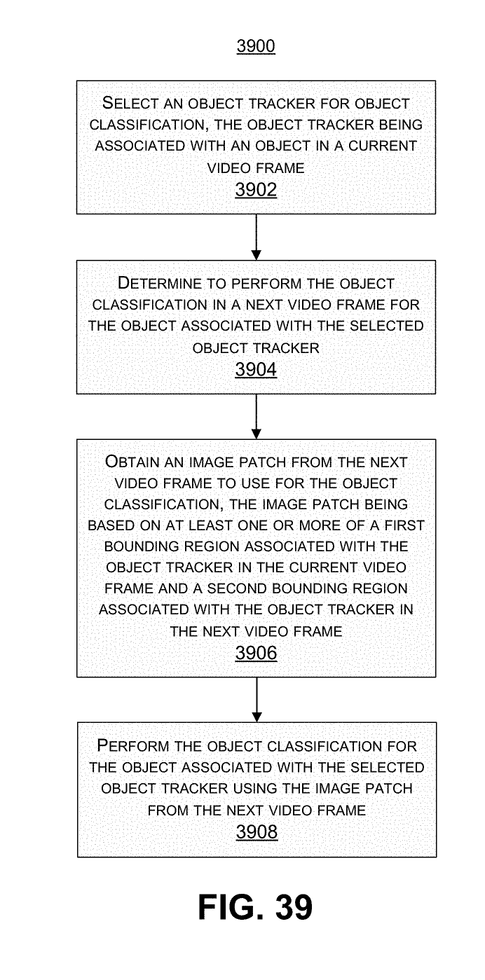

FIG. 39 is a flowchart illustrating an example of a process 3900 of classifying objects in one or more video frames using the techniques described herein. At block 3902, the process 3900 includes selecting an object tracker for object classification. The object tracker can be associated with an object in a current video frame. In one illustrative example, a blob detected using blob detection can be associated with the object tracker, in which case the blob represents at least a portion of an object captured in the current video frame.

At block 3904, the process 3900 includes determining to perform the object classification in a next video frame for the object associated with the selected object tracker. For example, instead of performing object classification for the object in the current video frame, the process 3900 can determine to perform object classification for the object tin the next video frame.

At block 3906, the process 3900 includes obtaining an image patch from the next video frame to use for the object classification. The image patch is based on at least one or more of a first bounding region associated with the object tracker in the current video frame and a second bounding region associated with the object tracker in the next video frame. For example, the image patch can be based on the first bounding region, can be based on the second bounding region, or can be based on both the first bounding region and the second bounding regions.

In some examples, obtaining the image patch from the next video frame includes cropping the image patch from the next video frame. In some cases, the next video frame is removed from a memory in response to obtaining the image patch from the next video frame. For example, the next video frame can be removed from the memory in response to cropping of the image patch from the next video frame.

In some examples, the process 3900 includes determining a reference image patch from the next video frame to use for generating the image patch. For example, determining the reference image patch can include determining a location within the next video frame that corresponds to the location of the first bounding region (associated with the object tracker) in the current video frame. In some cases, the determined location can be a bounding region within the next video frame with the same location as the location of the first bounding region in the current video frame. For instance, the determined location can be a bounding region located at a predicted location (as described above with respect to FIG. 13A-FIG. 13E) in the next video frame. As noted above, the predicted location of an object tracker in the next video frame includes a location in the current frame of the blob with which the object tracker was associated (and thus the actual location of the tracker bounding box in the current frame). In one illustrative example, if the center point of the first bounding region in the current video frame is at an (x, y) location of (15, 20), the determined location can correspond to a bounding region with a center point at an (x, y) location of (15, 20) within the next video frame. The reference image patch can be generated from the next video frame by obtaining image data within a region of the next video frame, where a point (e.g., a center point, a top-left corner point, a top-right corner point, a bottom-right corner point, a bottom-left corner point, and/or other point) of the reference image patch can be aligned with a point (e.g., a center point, a top-left corner point, a top-right corner point, a bottom-right corner point, a bottom-left corner point, and/or other point) associated with the determined location within the next video frame. In one illustrative example, a center point (and/or other point) of the reference image patch can be aligned with a center point (and/or other point) of a bounding region at the determined location within the next video frame.

In some examples, the region of the next video frame includes a pre-determined size. In some case, the pre-determined size includes a size used by the object classification (e.g., the W×W size described above). In some cases, the pre-determined size includes a size used by the object classification scaled by a pre-determined amount (e.g., the W′×W′ size described above).

In some examples, determining the reference image patch can include determining a location within the next video frame that corresponds to a location of the first bounding region in the current video frame. In some cases, the determined location can be a bounding region within the next video frame with the same location as the location of the first bounding region in the current video frame. For instance, the determined location can be a bounding region located at a predicted location (as described above with respect to FIG. 13A-FIG. 13E) in the next video frame. As noted above, the predicted location of an object tracker in the next video frame includes a location in the current frame of the blob with which the object tracker was associated (and thus the actual location of the tracker bounding box in the current frame). In one illustrative example, if the center point of the first bounding region in the current video frame is at an (x, y) location of (10, 18), the determined location can correspond to a bounding region with a center point at an (x, y) location of (10, 18) within the next video frame. An initial image patch can be generated from the next video frame by obtaining image data within a region of the next video frame, where a point (e.g., a center point, a top-left corner point, a top-right corner point, a bottom-right corner point, a bottom-left corner point, and/or other point) of the region of the next video frame can be aligned with a point (e.g., a center point, a top-left corner point, a top-right corner point, a bottom-right corner point, a bottom-left corner point, and/or other point) associated with the determined location within the next video frame. In one illustrative example, a center point (and/or other point) of the region of the next video frame can be aligned with a center point (and/or other point) of a bounding region at the determined location within the next video frame.

A size of the initial image patch can be based on a size of the first bounding region. In some cases, the initial image patch can be used as the reference image patch. In other cases, the reference image patch can be generated by scaling a size of the initial image patch by a pre-determined amount.

In some cases, the process 3900 can further include determining a location within the reference image patch of the second bounding region associated with the object tracker in the next video frame. The image patch from the next video frame to use for the object classification can then be generated by obtaining image data within a region of the reference image patch, where a point (e.g., a center point, a top-left corner point, a top-right corner point, a bottom-right corner point, a bottom-left corner point, and/or other point) of the image patch can be aligned with a point (e.g., a center point, a top-left corner point, a top-right corner point, a bottom-right corner point, a bottom-left corner point, and/or other point) of the second bounding region located within the reference image patch. In one illustrative example, a center of the image patch can be aligned with a center of the second bounding region located within the reference image patch.

In some cases, the region of the reference image patch includes a pre-determined size. For example, the pre-determined size can include a size used by the object classification (e.g., the W×W size described above).

In some examples, the process 3900 includes determining whether to perform the object classification for one or more object trackers in the next video frame based on a comparison between one or more bounding regions associated with the one or more object trackers in the current video frame and one or more bounding regions associated with the one or more object trackers in the next video frame.

In some cases, the process 3900 includes determining an amount of overlap between at least one bounding region associated with at least one object tracker in the current video frame and at least one bounding region associated with the at least one object tracker in the next video frame is less than an overlap threshold. The process 3900 can include determining not to perform the object classification in the next video frame for at least one object associated with the at least one object tracker based on the amount of overlap being less than the overlap threshold. The process 3900 can determine to perform the object classification in the next video frame for at least one object associated with the at least one object tracker based on the amount of overlap not being less than (or being greater than) the overlap threshold. For example, the process 3900 can determine the amount of overlap between a bounding region associated with an object tracker in the current video frame and a bounding region associated with an object tracker in the next video frame is greater than an overlap threshold, and can determine to perform the object classification in the next video frame for an object associated with the object tracker based on the amount of overlap being greater than the overlap threshold.

In some examples, the process 3900 includes determining a size of at least one bounding region associated with at least one object tracker in the current video frame is less than a threshold percentage of a size of at least one bounding region associated with the at least one object tracker in the next video frame. The process 3900 can include determining not to perform the object classification in the next video frame for at least one object associated with the at least one object tracker based on the size of the at least one bounding region associated with at least one object tracker in the current video frame being less than the threshold percentage of the size of the at least one bounding region associated with the at least one object tracker in the next video frame. The process 3900 can determine to perform the object classification in the next video frame for at least one object associated with the at least one object tracker based on the size of the at least one bounding region associated with at least one object tracker in the current video frame not being less than (or being greater than) the threshold percentage of the size of the at least one bounding region associated with the at least one object tracker in the next video frame. For example, the process 3900 can determine the size of a bounding region associated with an object tracker in the current video frame is greater than a threshold percentage of the size of a bounding region associated with an object tracker in the next video frame, and can determine to perform the object classification in the next video frame for an object associated with the object tracker based on the size of the bounding region associated with the object tracker in the current video frame being greater than the threshold percentage of the size of the bounding region associated with the object tracker in the next video frame.

In some examples, object detection and object tracking are performed on a low resolution version of the current video frame to generate the object tracker, and the object classification is performed on a high resolution version of the next video frame. For example, in some examples, the process 3900 can include detecting, using the low resolution version of the current video frame, a plurality of blobs for the current video frame. The blob includes pixels of at least a portion of one or more objects in the current video frame. The process 3900 can further include obtaining a plurality of object trackers maintained for the current video frame, and associating, using the low resolution version of the current video frame, the plurality of blobs with the plurality of object trackers maintained for the current video frame. In such examples, performing the object classification for the object associated with the selected object tracker can include performing the object classification for a blob associated with the object tracker using the high resolution version of the next video frame.

In some examples, the process 3900 includes obtaining a plurality of object trackers maintained for the current video frame. For example, the object trackers can include the object (or blob) trackers that the video analytics system 700 uses to track objects (or blobs) in a sequence of video frames. The object trackers can include various states (e.g., new, normal, split, split-new, merge, lost, among others). In such examples, the process 3900 can further include obtaining a plurality of classification requests associated with a subset of object trackers from the plurality of object trackers. The plurality of classification requests can be generated based on one or more characteristics associated with the subset of object trackers. In such examples, the object tracker can be selected for object classification from the subset of object trackers based on the obtained plurality of classification requests.

In some examples, the one or more characteristics associated with an object tracker from the subset of object trackers can include a state change of the object tracker from a first state to a second state. In such examples, a classification request can be generated for the object tracker when a state of the object tracker is changed from the first state to the second state in the current video frame.

In some examples, the one or more characteristics associated with an object tracker from the subset of object trackers include an idle duration of the object tracker. The idle duration indicates a number of frames between the current video frame and a last video frame at which a classification request was generated for the object tracker. In such examples, a classification request can be generated for the object tracker when the idle duration is greater than an idle duration threshold.

In some examples, the one or more characteristics associated with an object tracker from the subset of object trackers include a size comparison of the object tracker. In such aspects, generating a classification request for the object tracker can include determining the size comparison of the object tracker by comparing a size of the object tracker in the current video frame to a size of the object tracker in a last video frame at which object classification was performed for the object tracker. In such examples, a classification request can be generated for the object tracker when the size comparison is greater than a size comparison threshold.

At block 3908, the process 3900 includes performing the object classification for the object associated with the selected object tracker using the image patch from the next video frame. In some examples, the object classification can be performed using a trained classification network.

In some examples, the process 3900 may be performed by a computing device or an apparatus, such as the video analytics system 700. In one illustrative example, the process 3900 can be performed by the video analytics system 700 shown in FIG. 7. In some cases, the computing device or apparatus may include a processor, microprocessor, microcomputer, or other component of a device that is configured to carry out the steps of process 3900. In some examples, the computing device or apparatus may include a camera configured to capture video data (e.g., a video sequence) including video frames. For example, the computing device may include a camera device (e.g., an IP camera or other type of camera device) that may include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Process 3900 is illustrated as a logical flow diagram, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 3900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The video analytics operations discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described examples may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method of classifying objects in one or more video frames, the method comprising:
selecting an object tracker for object classification, the object tracker being associated with an object in a current video frame;
determining to perform the object classification in a next video frame for the object associated with the selected object tracker;
obtaining an image patch from the next video frame to use for the object classification, the image patch being based on at least one or more of a first bounding region associated with the object tracker in the current video frame and a second bounding region associated with the object tracker in the next video frame; and
performing the object classification for the object associated with the selected object tracker using the image patch from the next video frame.

2. The method of claim 1, wherein obtaining the image patch from the next video frame includes cropping the image patch from the next video frame, and wherein the next video frame is removed from a memory in response to cropping of the image patch.

3. The method of claim 1, further comprising determining a reference image patch from the next video frame to use for generating the image patch, wherein determining the reference image patch includes:
determining a location within the next video frame, the determined location corresponding to a location of the first bounding region in the current video frame; and
generating the reference image patch from the next video frame by obtaining image data within a region of the next video frame, a point of the reference image patch being aligned with a point associated with the determined location within the next video frame.

4. The method of claim 3, wherein the region of the next video frame includes a pre-determined size, the pre-determined size including a size used by the object classification.

5. The method of claim 3, wherein the region of the next video frame includes a pre-determined size, the pre-determined size including a size used by the object classification scaled by a pre-determined amount.

6. The method of claim 1, further comprising determining a reference image patch from the next video frame to use for generating the image patch, wherein determining the reference image patch includes:
determining a location within the next video frame, the determined location corresponding to a location of the first bounding region in the current video frame;
generating an initial image patch from the next video frame by obtaining image data within a region of the next video frame, a point of the region of the next video frame being aligned with a point associated with the determined location within the next video frame, wherein a size of the initial image patch is based on a size of the first bounding region; and
generating the reference image patch by scaling a size of the initial image patch by a pre-determined amount.

7. The method of claim 6, further comprising:
determining a location within the reference image patch of the second bounding region associated with the object tracker in the next video frame; and
generating the image patch from the next video frame to use for the object classification by obtaining image data within a region of the reference image patch, a point of the image patch being aligned with a point of the second bounding region located within the reference image patch.

8. The method of claim 7, wherein the region of the reference image patch includes a pre-determined size, the pre-determined size including a size used by the object classification.

9. The method of any one of claim 1, further comprising determining whether to perform the object classification for one or more object trackers in the next video frame based on a comparison between one or more bounding regions associated with the one or more object trackers in the current video frame and one or more bounding regions associated with the one or more object trackers in the next video frame.

10. The method of claim 9, further comprising:
determining an amount of overlap between at least one bounding region associated with at least one object tracker in the current video frame and at least one bounding region associated with the at least one object tracker in the next video frame is greater than an overlap threshold; and
determining to perform the object classification in the next video frame for at least one object associated with the at least one object tracker based on the amount of overlap being greater than the overlap threshold.

11. The method of claim 9, further comprising:
determining a size of at least one bounding region associated with at least one object tracker in the current video frame is greater than a threshold percentage of a size of at least one bounding region associated with the at least one object tracker in the next video frame; and
determining to perform the object classification in the next video frame for at least one object associated with the at least one object tracker based on the size of the at least one bounding region associated with at least one object tracker in the current video frame being greater than the threshold percentage of the size of the at least one bounding region associated with the at least one object tracker in the next video frame.

12. The method of any one of claim 1, wherein object detection and object tracking are performed on a low resolution version of the current video frame to generate the object tracker, and wherein the object classification is performed on a high resolution version of the next video frame.

13. The method of claim 12, further comprising:
detecting, using the low resolution version of the current video frame, a plurality of blobs for the current video frame, wherein a blob includes pixels of at least a portion of one or more objects in the current video frame;
obtaining a plurality of object trackers maintained for the current video frame; and
associating, using the low resolution version of the current video frame, the plurality of blobs with the plurality of object trackers maintained for the current video frame;
wherein performing the object classification for the object associated with the selected object tracker includes performing the object classification for a blob associated with the object tracker using the high resolution version of the next video frame.

14. The method of any one of claim 1, further comprising:
obtaining a plurality of object trackers maintained for the current video frame; and
obtaining a plurality of classification requests associated with a subset of object trackers from the plurality of object trackers, the plurality of classification requests being generated based on one or more characteristics associated with the subset of object trackers;
wherein the object tracker is selected for object classification from the subset of object trackers based on the obtained plurality of classification requests.

15. The method of claim 14, wherein the one or more characteristics associated with an object tracker from the subset of object trackers include a state change of the object tracker from a first state to a second state, and wherein a classification request is generated for the object tracker when a state of the object tracker is changed from the first state to the second state in the current video frame.

16. The method of claim 14, wherein the one or more characteristics associated with an object tracker from the subset of object trackers include an idle duration of the object tracker, the idle duration indicating a number of frames between the current video frame and a last video frame at which a classification request was generated for the object tracker, and wherein a classification request is generated for the object tracker when the idle duration is greater than an idle duration threshold.

17. The method of claim 14, wherein the one or more characteristics associated with an object tracker from the subset of object trackers include a size comparison of the object tracker, and wherein generating a classification request for the object tracker includes:
determining the size comparison of the object tracker by comparing a size of the object tracker in the current video frame to a size of the object tracker in a last video frame at which object classification was performed for the object tracker; and
wherein a classification request is generated for the object tracker when the size comparison is greater than a size comparison threshold.

18. The method of any one of claim 1, wherein the object classification is performed using a trained classification network.

19. An apparatus for classifying objects in one or more video frames, comprising:
a memory configured to store the one or more video frames; and
a processor configured to:
select an object tracker for object classification, the object tracker being associated with an object in a current video frame;
determine to perform the object classification in a next video frame for the object associated with the selected object tracker;
obtain an image patch from the next video frame to use for the object classification, the image patch being based on at least one or more of a first bounding region associated with the object tracker in the current video frame and a second bounding region associated with the object tracker in the next video frame; and
perform the object classification for the object associated with the selected object tracker using the image patch from the next video frame.

20. The apparatus of claim 19, wherein obtaining the image patch from the next video frame includes cropping the image patch from the next video frame, and wherein the next video frame is removed from a memory in response to cropping of the image patch.

21. The apparatus of claim 19, wherein the processor is further configured to determine a reference image patch from the next video frame to use for generating the image patch, wherein determining the reference image patch includes:
determining a location within the next video frame, the determined location corresponding to a location of the first bounding region in the current video frame; and
generating the reference image patch from the next video frame by obtaining image data within a region of the next video frame, a point of the reference image patch being aligned with a point associated with the determined location within the next video frame.

22. The apparatus of claim 21, wherein the region of the next video frame includes a pre-determined size, the pre-determined size including a size used by the object classification.

23. The apparatus of claim 21, wherein the region of the next video frame includes a pre-determined size, the pre-determined size including a size used by the object classification scaled by a pre-determined amount.

24. The apparatus of claim 19, wherein the processor is further configured to determine a reference image patch from the next video frame to use for generating the image patch, wherein determining the reference image patch includes:
determining a location within the next video frame, the determined location corresponding to a location of the first bounding region in the current video frame;
generating an initial image patch from the next video frame by obtaining image data within a region of the next video frame, a point of the region of the next video frame being aligned with a point associated with the determined location within the next video frame, wherein a size of the initial image patch is based on a size of the first bounding region; and
generating the reference image patch by scaling a size of the initial image patch by a pre-determined amount.

25. The apparatus of claim 24, wherein the processor is further configured to:
determine a location within the reference image patch of the second bounding region associated with the object tracker in the next video frame; and
generate the image patch from the next video frame to use for the object classification by obtaining image data within a region of the reference image patch, a point of the image patch being aligned with a point of the second bounding region located within the reference image patch.

26. The apparatus of claim 19, wherein the processor is further configured to determine whether to perform the object classification for one or more object trackers in the next video frame based on a comparison between one or more bounding regions associated with the one or more object trackers in the current video frame and one or more bounding regions associated with the one or more object trackers in the next video frame.

27. The apparatus of claim 19, wherein object detection and object tracking are performed on a low resolution version of the current video frame to generate the object tracker, and wherein the object classification is performed on a high resolution version of the next video frame.

28. The apparatus of claim 19, further comprising a camera for capturing the one or more video frames.

29. The apparatus of claim 19, further comprising a display for displaying video data.

30. A non-transitory computer-readable medium having stored thereon instructions that, when executed by one or more processors, cause the one or more processor to:
select an object tracker for object classification, the object tracker being associated with an object in a current video frame;
determine to perform the object classification in a next video frame for the object associated with the selected object tracker;
obtain an image patch from the next video frame to use for the object classification, the image patch being based on at least one or more of a first bounding region associated with the object tracker in the current video frame and a second bounding region associated with the object tracker in the next video frame; and
perform the object classification for the object associated with the selected object tracker using the image patch from the next video frame.
